(19) United States
(12) Patent Application Publication
(10) Pub. No.: US 2006/0265249 A1
(43) Pub. Date: Nov. 23, 2006

(54) Method, system, and computer-readable medium for providing a patient electronic medical record with an improved timeline

(76) Inventors: Howard Follis, Springfield, MO (US); Shannon McMurtrey, Willard, MO (US); Debra Joan Marti, Monett, MO (US); Joshua Steven Marble, Ozark, MO (US); Wesley Glen Trantham, Springfield, MO (US); Timothy Crell Franklin, Springfield, MO (US)

Correspondence Address: THOMPSON COBURN, LLP, ONE US BANK PLAZA, SUITE 3500, ST LOUIS, MO, 63101, US

(21) Appl. No.: 11/131,958

(22) Filed: May 18, 2005

(51) Int. Cl. G06F 19/00; G06F 17/00

(52) U.S. Cl. 705/3; 715/503

(57) ABSTRACT

A computer-readable medium for displaying and providing access to a stored patient electronic medical record (EMR), the computer-readable medium comprising a code segment executable by a processor for providing a user interface screen for display to a user, the user interface screen comprising a graphically-displayed timeline, the timeline comprising a first axis for time and a second axis that is substantially perpendicular to the first axis, the second axis being divided into a plurality of sections in parallel with each other, each section corresponding to a different type of patient information, each section comprising a display of patient data corresponding to that section's type of patient information, wherein the displayed patient data in each section is located on the timeline at a position such that the patient data is chronologically-ordered. The displayed timeline can be used as an access point for retrieving a wealth of information about the patient. Also disclosed herein are corresponding methods and systems for displaying and providing access to electronic patient medical records.

### FIELD OF THE INVENTION

The present invention relates to the field of electronic medical records (EMRs) for patient care in connection with physicians' medical practices.

### BACKGROUND AND SUMMARY OF THE INVENTION

A variety of software packages are known in the art that endeavor to provide physicians and other health care providers with user-friendly EMRs for patient care. These EMRs are designed to provide physicians with quick access to stored patient information.

One of the features that many existing EMR systems provide is a feature that displays patient data records in a chronological fashion to thereby allow a physician or health care provider to get a feel for when and what has occurred with the patient over time. For example, U.S. patent application publications 2003/0028402 and 2003/0191671, filed by Ulrich et al. (the entire disclosures of both of which are incorporated herein by reference), disclose a patient EMR system wherein a timeline displays a list of chronologically-ordered files that correspond to a patient's medical data records (see FIG. 6 of publications 2003/0028402 and 2003/0191671). With this timeline, the user has the ability to control whether the files are listed in “newest first” or “oldest first” chronological order. The user can also control the number of days encompassed by the timeline from the present day and backward by a user-defined number of days.

Furthermore, with the Ulrich system, the user has the ability to control the types of patient medical data records that are displayed on the list by providing appropriate user input in a separately displayed table that lists the available types of medical records that are eligible for display on the timeline. That is, by selecting the information types “appointments”, “encounters”, and “prescriptions” from the list on the left hand side of FIG. 6 of the Ulrich publications, the Ulrich timeline is updated to chronologically list all stored medical records of those information types for the patient.

However, the inventors herein feel that timelines such as those disclosed in the Ulrich publications fail to fully meet a health care providers' needs in connection with patient EMRs. For example, while the Ulrich timeline discloses chronologically-ordered medical data records, this chronological order is not visually graphed on a time axis scale that allows a quick glance to reveal how much time passed between each medical data record. Furthermore, the Ulrich timeline does not provide a clear demarcation between medical data records of different information types. The Ulrich timeline similarly fails to clearly demarcate the temporal spacing between medical data records of the same information type. As shown in FIG. 6 of the Ulrich publications, “appointment” medical data records, “encounters” medical data records, and “prescriptions” medical data records are all interleaved with each other on the timeline, with the spacing between successive medical data records that are around a month apart being the same as the spacing between successive medical data records that are only a day apart (or the same day).

Further still, the Ulrich timeline is not space efficient, in that it conveys relatively little information, with medical data records for the past 90 days effectively filling up around half of the timeline's available space.

Based on these and other shortcomings, the inventors herein feel that there is a need in the art for patient EMRs with an improved timeline feature. Toward that end, according to one aspect of the present invention, the inventors herein disclose a computer-readable medium for displaying and providing access to a stored patient electronic medical record (EMR), the computer-readable medium comprising a code segment executable by a processor for providing a user interface screen for display to a user, the user interface screen comprising a graphically-displayed timeline, the timeline comprising a first axis for time and a second axis that is substantially perpendicular to the first axis, the second axis being divided into a plurality of sections in parallel with each other, each section corresponding to a different type of patient information, each section comprising a display of patient data corresponding to that section's type of patient information, wherein the displayed patient data in each section is located on the timeline at a position such that the patient data is chronologically-ordered. It should be noted an actual line or series of points, hashmarks and the like corresponding to a timeline axis need not be displayed on the timeline.

Through the interface screens described herein, the user can preferably (a) control what patient data is added to the timeline, (b) control what time period is covered by the timeline, and (c) access detailed patient information from items that are displayed on the timeline.

According to another aspect of the present invention, also disclosed herein is a method for displaying a patient electronic medical record (EMR), the method comprising: (1) graphically displaying a timeline, the timeline comprising a first axis for time and a second axis perpendicular to the first axis, the second axis comprising a plurality of sections, each section being associated with a different type of patient data; and (2) displaying a plurality of patient data items on the timeline, the patient data items comprising data from a patient's EMR, each item having an associated date and an associated patient data type; and wherein the data item displaying step comprises: (1) along the first axis, chronologically placing each item at a position within the timeline in accordance with that item's associated date, and (2) along the second axis, placing each item within the second axis section that corresponds to that item's associated patient data type.

According to yet another aspect of the present invention, also disclosed herein is a patient electronic medical record (EMR) system, the system comprising: (a) a database in which patient data comprising a plurality of patient EMRs are stored; and (b) a server in communication with the database and with at least one user device via a network such that the at least one user device can access a software program executed by the server, the software program being configured to provide a user interface screen for display on the at least one user device, the user interface screen comprising a graphically-displayed timeline, the timeline comprising a first axis for time and a second axis that is substantially perpendicular to the first axis, the second axis being divided into a plurality of sections in parallel with each other, each section corresponding to a different type of patient information, each section comprising a display of patient data corresponding to that section's type of patient information, wherein the displayed patient data in each section is located on the timeline at a position such that the patient data is chronologically-ordered.

These and other features of the invention will be in part apparent and in part pointed out to those of ordinary skill in the art upon a review of the teachings herein. The below described preferred embodiment is meant to be illustrative of the invention and not limiting. Instead the invention is intended to be limited only by the claims and their legal equivalents.

### BRIEF DESCRIPTION OF THE DRAWINGS

FIG. 1 depicts a block diagram overview of a preferred embodiment for a system employing the present invention;

FIG. 2 depicts an exemplary user interface screen that includes a timeline in accordance with a preferred embodiment of the present invention;

FIG. 3 depicts an exemplary user interface screen, including a timeline whose window of time coverage has been adjusted;

FIGS. 4-9 illustrate exemplary user interface screens having an exploded view of various timeline sections;

FIGS. 10 and 11 illustrate exemplary user interface screens for controlling what allergies are displayed with the patient's EMR;

FIGS. 12-15 illustrate exemplary user interface screens for controlling what medication information is stored with the patient's EMR;

FIGS. 16-19 illustrate exemplary user interface screens for controlling what past surgical history information is stored with the patient's EMR;

FIGS. 20-23 illustrate exemplary user interface screens for controlling what past medical history information is stored with the patient's EMR;

FIGS. 24 and 25 illustrate exemplary user interface screens for controlling what family history information is stored with the patient's EMR;

FIG. 26 illustrates an exemplary user interface screen for controlling what social history information is stored with the patient's EMR;

FIGS. 27-61 illustrate exemplary user interface screens for creating office visit (OV) notes for inclusion in a patient's EMR;

FIGS. 62-66 illustrate exemplary user interface screens for viewing the EMR documents in a non-timeline manner;

FIGS. 67-76 illustrate exemplary user interface screens for chart management in connection with a patient's EMR;

FIGS. 77 and 78 illustrate exemplary user interface screens for editing the demographic information stored in a patient's EMR;

FIGS. 79(a) and (b) illustrate exemplary user interface screens for viewing OV note documents;

FIG. 80 illustrates an exemplary user interface screen that shows the additional details for a patient's RADN procedure;

FIG. 81 illustrates an exemplary user interface screen that shows the additional details for a patient's medical imaging report;

FIG. 82 illustrates an exemplary user interface screen that shows the additional details for a patient's urinalysis lab results; and

FIG. 83 depicts a flowchart illustrating how patient data can be added to a patient's EMR.

### DETAILED DESCRIPTION OF THE PREFERRED EMBODIMENT

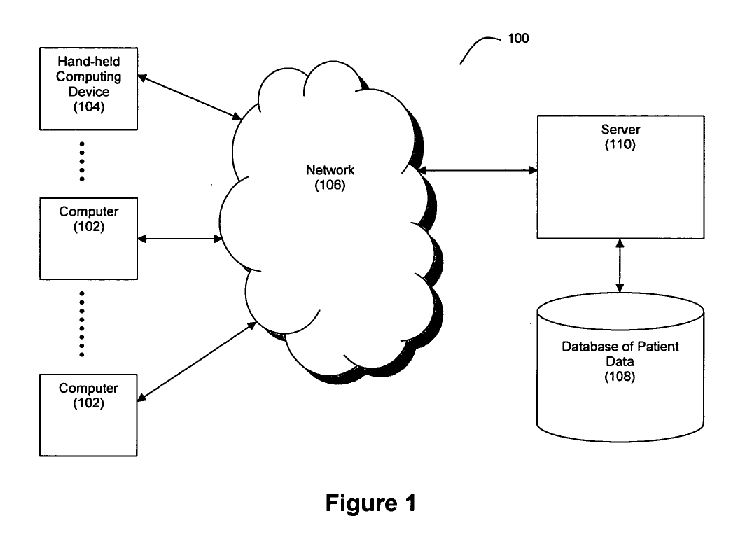

FIG. 1 depicts a block diagram overview of a preferred embodiment for a system 100 employing the present invention. One or more computers 102 (e.g., desktop PCs, laptops, or other standard office or business computer work stations) and hand-held computing devices 104 (e.g., PDAs, tablets, or other mobile computing devices that have graphic display capabilities) are in communication with one or more servers 110 via a network 106. Network 106 may be any type of network for data communications between computing devices, including but not limited to an office intranet, the Internet, a LAN, WAN, wireless network, satellite network, leased telephone/data lines, etc. It is also worth noting that computers 102 and hand-held computing devices 104 may include one or more peripheral devices through which data can be received, such as document scanners, digital cameras, etc.

Server 110 preferably executes a software program to provide users of the computers 102 and hand-held computing devices 104 with access to patient data stored in database 108. This software program preferably creates a plurality of user-interactive pages or screens that are displayed on computers 102 and hand-held computing devices 104. These pages allow users to create, view, and add to a patient's EMR. Among the features of this EMR software is an improved timeline for displaying patient data. The preferred users for this software include physicians, nurses, and other health care providers.

Server 110 can be a commodity PC configured as a server and having 512 MB or more of RAM, a 2 GHz or faster processor, and 50 MB or more of storage. However, it should be noted that more powerful or less powerful hardware for server 110 can be used in the practice of the present invention, as would be understood by those having ordinary skill in the art. The EMR software executed by server 110 can be coded in Visual Basic.Net, although as would be understood by those of ordinary skill in the art, other programming languages could be used. Database 108, which may comprise one or more databases, is preferably an open source relational database such as MySQL. However, it should be noted that other types of databases can readily be used in the practice of the present invention. While the system 100 of FIG. 1 has been shown in the context of a networked system, it is also worth noting that the EMR software of the present invention can also be implemented on a stand-alone computer, as would be understood by those having ordinary skill in the art. It is also worth noting that in an embodiment as a hosted network system, the server can include software that restricts access to the patient data in database 108 to only users with appropriate authorization, as would be understood by those having ordinary skill in the art.

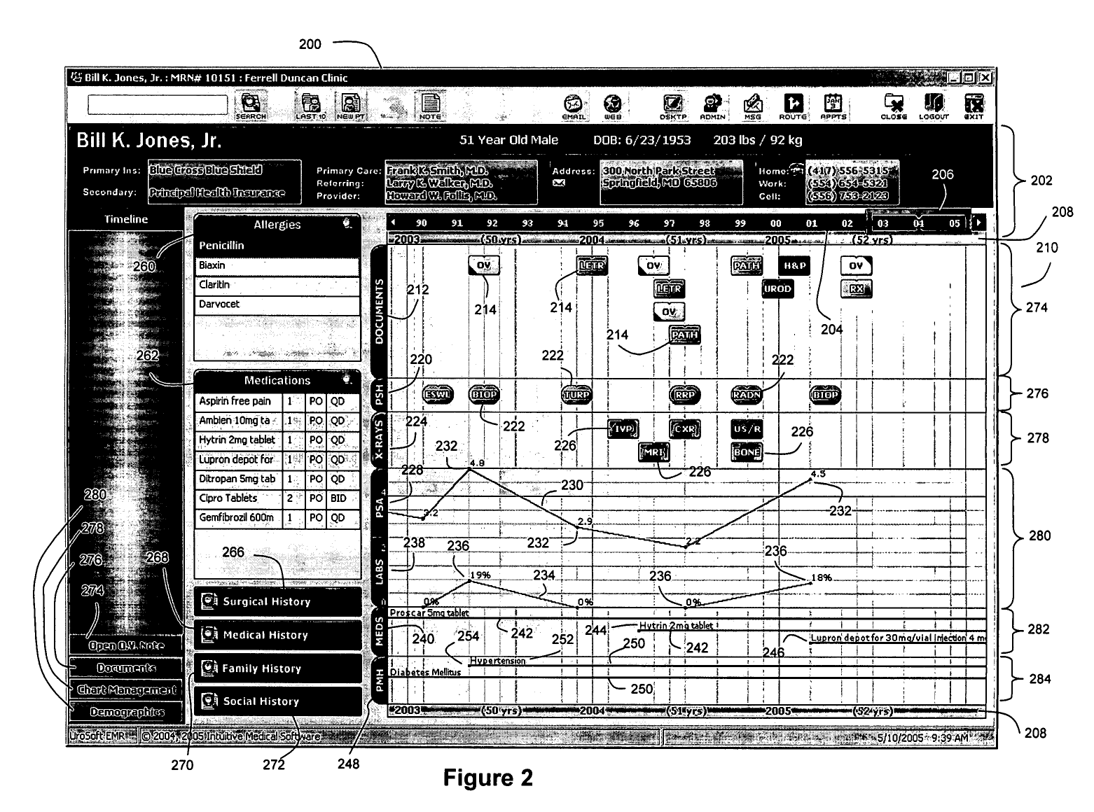

FIG. 2 depicts an exemplary user interface screen 200 that includes a timeline 210 in accordance with a preferred embodiment of the present invention. Section 202 of screen 200 preferably includes pertinent biographical data about the subject patient such as name, age, date of birth, weight, address, contact telephone numbers, patient insurance information, and a list of primary care, referring, and provider physicians. Additional sections of screen 200 include an allergies section 260 that lists drugs to which the patient is known to be allergic and a medications section 262 that lists the drugs the patient is believed to be currently taking. As will be explained in greater detail below, both sections 260 and 262 are user-selectable to display additional screens that are configured to interact with the user to obtain additional allergy or medication information about the patient.

Additional features of screen 200 that allow the user to add information to the patient's EMR are provided by buttons 266, 268, 270, and 272, which navigate the user to screens that are configured to receive data from the user in connection with the patient's surgical history, medical history, family history, and social history respectively. Yet additional features of screen 200 that allow the user to add information to the patient's EMR are provided by (1) “Open O.V. Note” button 274, which upon user selection navigates the user to one or more screens through which the user can create notes about a patient's office visit, (2) “Documents” button 276, which upon user selection navigates the user to one or more screens through which the user can manage documents in the patient's EMR, (3) “Chart Management” button 278, which upon user selection navigates the user to one or more screens through which the user can add documents and other medical data to the patient's EMR, and (4) “Demographics” button 280, which upon user selection navigates the user to one or more screens through which the user can add or edit the patient's demographic information.

An important feature of screen 200 is timeline 210. Along one axis of the timeline 210, preferably the horizontal or x-axis—although this need not be the case, is a time scale 204. This scale 204 is preferably a uniform linear time scale, with the space between time X and time X+1 being the same as the space between time X+2 and time X+3. It is also preferred that the units of time expressed on scale 204 be in terms of years, as in 2005, 2004, 2003, etc. However, it should be noted that a monthly or daily scale as well as some other type of scale (such as patient age) could also be used in the practice of the present invention.

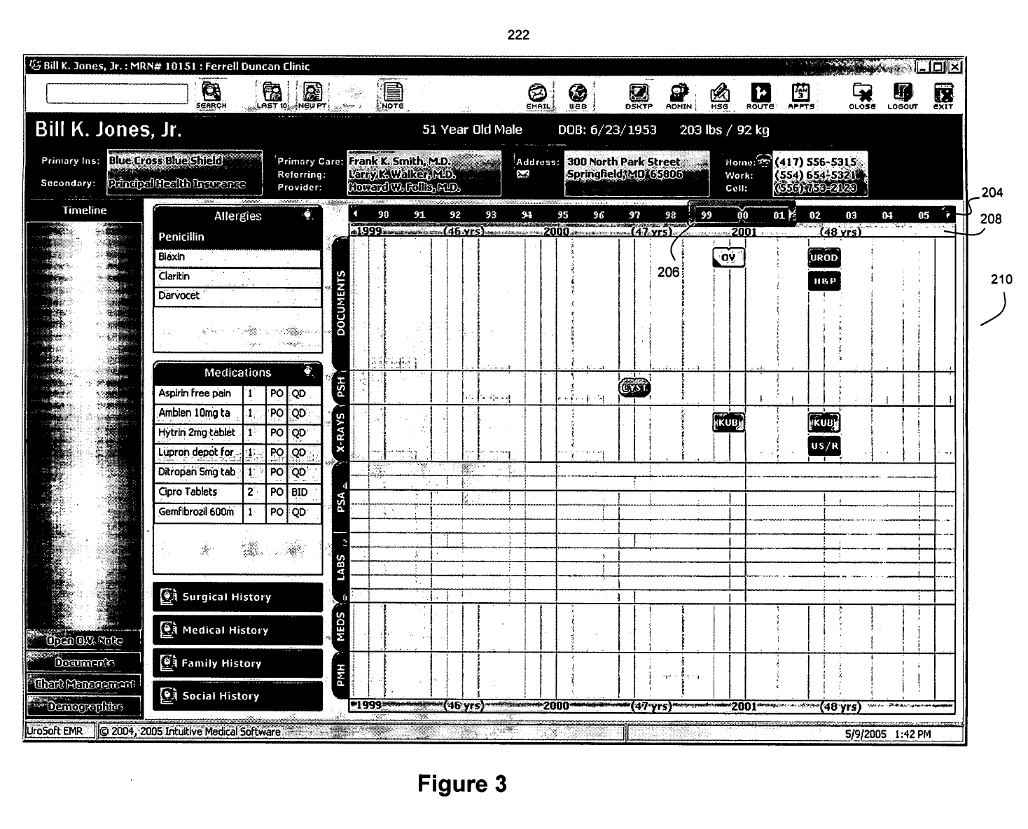

Because the patient's EMR may extend many years into the past, it will often be the case that it is impractical to display the patient's full EMR on the timeline 210. For this reason, timeline 210 preferably only displays a duration-limited portion of the patient's EMR, wherein the duration that is covered by the displayed timeline 210 is defined by the duration window scroller tool 206. As shown in FIG. 2, the duration window scroller tool 206 covers the window of time from 2003 through 2005. Accordingly, only the patient's EMR data for the years 2003-2005 is displayed in timeline 210, as shown by scale 208, which is also a linear scale that is preferably broken down by month and year. It is preferred that scale 208 also display the patient's ages that correspond with the duration defined by tool 206. As shown by FIG. 3, user adjustment of duration window scroller tool 206 to cover the years 1999-2001 is effective to change the window of time encompassed by timeline 210 to encompass only 1999-2001.

While the duration window scroller tool 206 of FIG. 2 is shown to define a fixed duration of time (three years), it is worth noting that the duration need not be fixed at three years (other durations may be used). Furthermore, the duration need not be fixed at all as the scroller tool 206 can also be configured to define a user-adjustable duration.

Along the other axis of the timeline 210, preferably the horizontal or y-axis—although this need not be the case, are a plurality of sections, each section being associated with a different type of patient information. Section 274 along the y-axis of timeline 210 is a documents section. Section 276 along the y-axis of timeline 210 is a past surgical history section. Section 278 along the y-axis of timeline 210 is a medical imaging document section. Section 280 along the y-axis of timeline 210 is a PSA/labs section, wherein the user can toggle between whether section 280 displays PSA data or labs data. Section 282 along the y-axis of timeline 210 is a medications section, and section 284 along the y-axis of timeline 210 is a past medical history section. Each section of the y-axis preferably extends perpendicularly from the y-axis (along the time axis) in parallel with the other sections. Each section displays only patient data that is of the type of patient information to which that section corresponds. Thus, imaging section 278 displays data items relating to medical images for the patient that are stored in the patient's EMR. Similarly, medications section 282 displays data items relating to the medications that the patient has taken (or is currently taking).

The data in each y-axis section is displayed chronologically along the time axis. For example, an X-ray image obtained in March 2004 is displayed on the timeline 210 at a location along the time axis that corresponds to March 2004 and along the y-axis within imaging section 278. Similarly, an office visit (OV) note that was generated in response to a patient visit to the physician's office in May 2005 will be displayed on the timeline 210 at a location along the time axis that corresponds to May 2005 and along the y-axis within the documents section 274.

It is preferred that the linear time scale along the time axis be the same for each section along the y-axis. Furthermore, while the preferred embodiment shows the particular section types in a particular order, it is worth noting that practitioners of the present invention may choose different arrangements of sections along the y-axis, including but not limited to additional sections corresponding to additional or different types of patient information, fewer sections, differently ordered sections, etc. The exact choice of sections, choice of information types corresponding to the sections, and order of sections along the y-axis is expected to be primarily dictated by the nature of the user's medical practice. While the preferred embodiment disclosed herein focuses on a patient EMR and timeline for a urology practice, the needs of other specialty or practice areas will likely be different.

Populating the timeline 210 within each section are preferably a plurality of data items that are user-selectable to display additional, more detailed information about that data item. This additional information can be presented in a new screen, a pop-up window superimposed over screen 200, or an open section of screen 200, as would be understood by those having ordinary skill in the art.

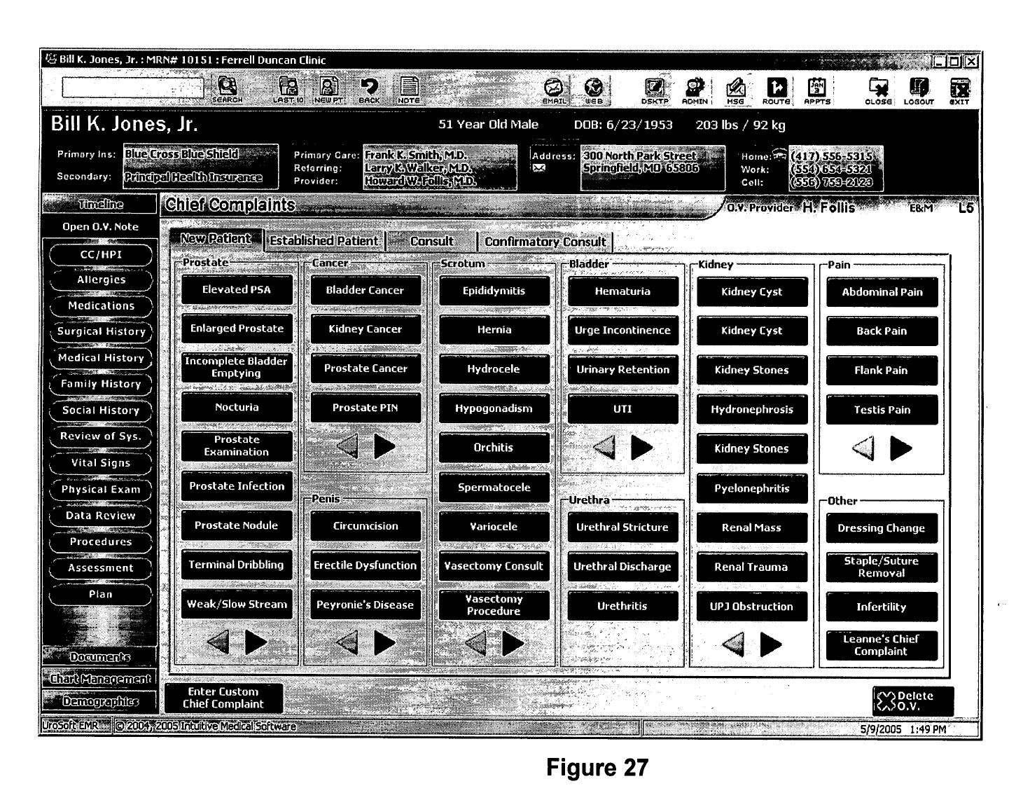

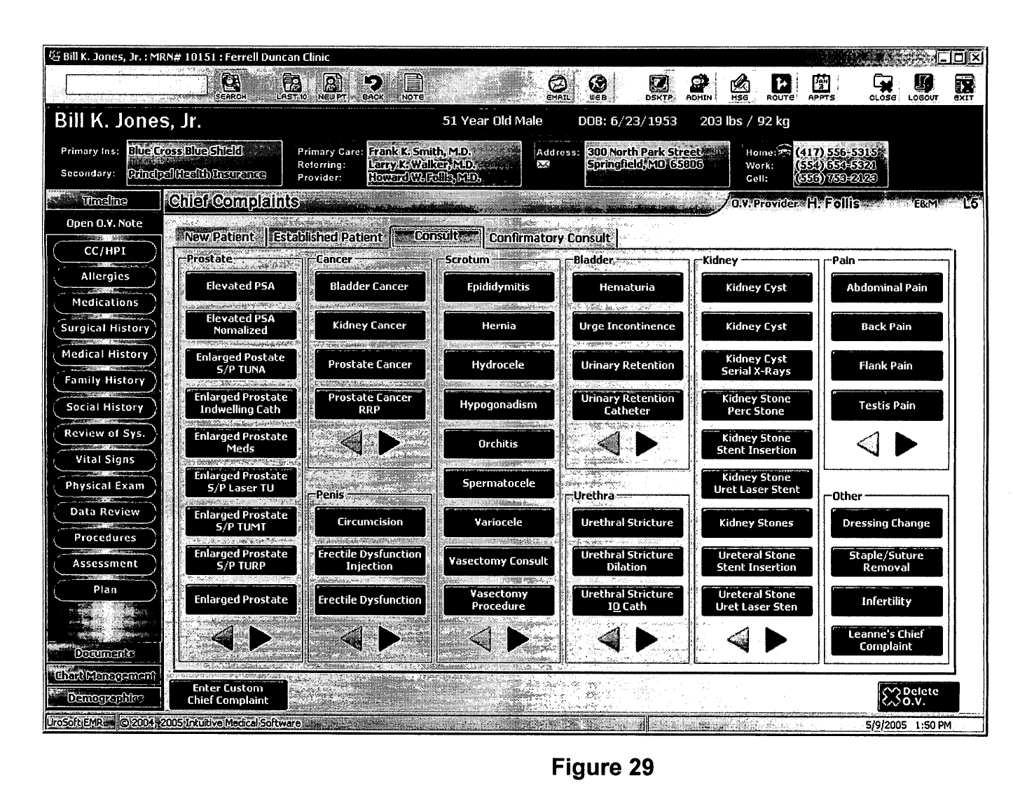

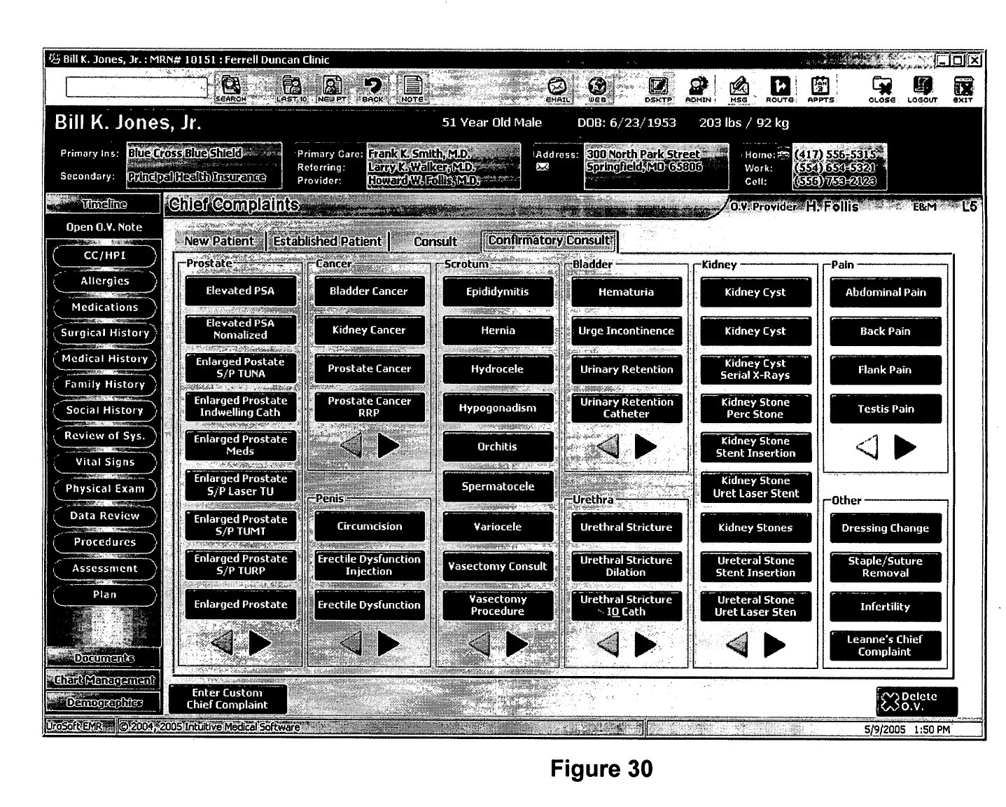

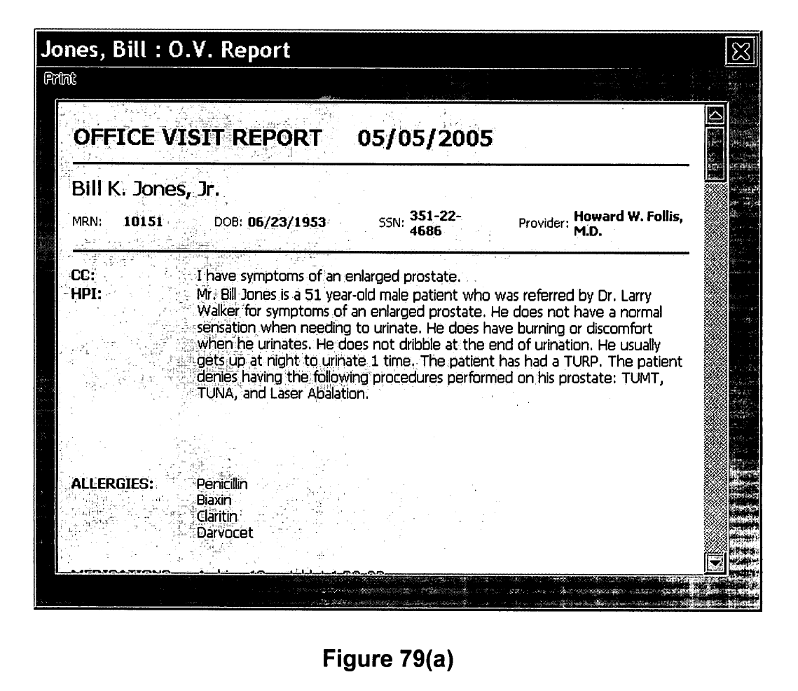

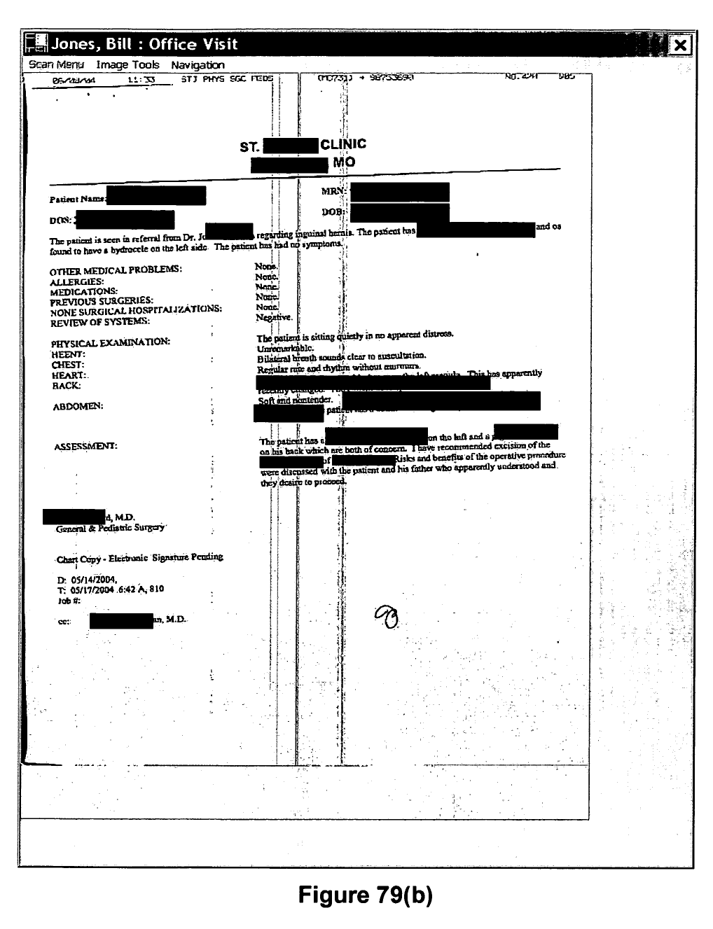

Documents section 274 includes chronologically-ordered document items 214 that are user-selectable to display the full document referenced by item 214. Each document item 214 preferably comprises a graphical icon that includes a display that summarizes the type of document referenced thereby. Accordingly, if the user wishes to view the full details of a patient's OV note for a given date, the user can select the OV icon 214 displayed on the timeline in section 274 for that date. FIG. 79(a) depicts an exemplary screen that shows the details of an OV note document, wherein the OV note document was generated through data input via the screens of FIGS. 27-61. FIG. 79(b) depicts an exemplary screen that shows the details on an OV note document that was scanned into the system. If the user wishes to view the full details of a patient's urodynamics (UROD) procedure generated on a particular date, the user can select the UROD icon 214 displayed on the timeline in section 274 for that date.

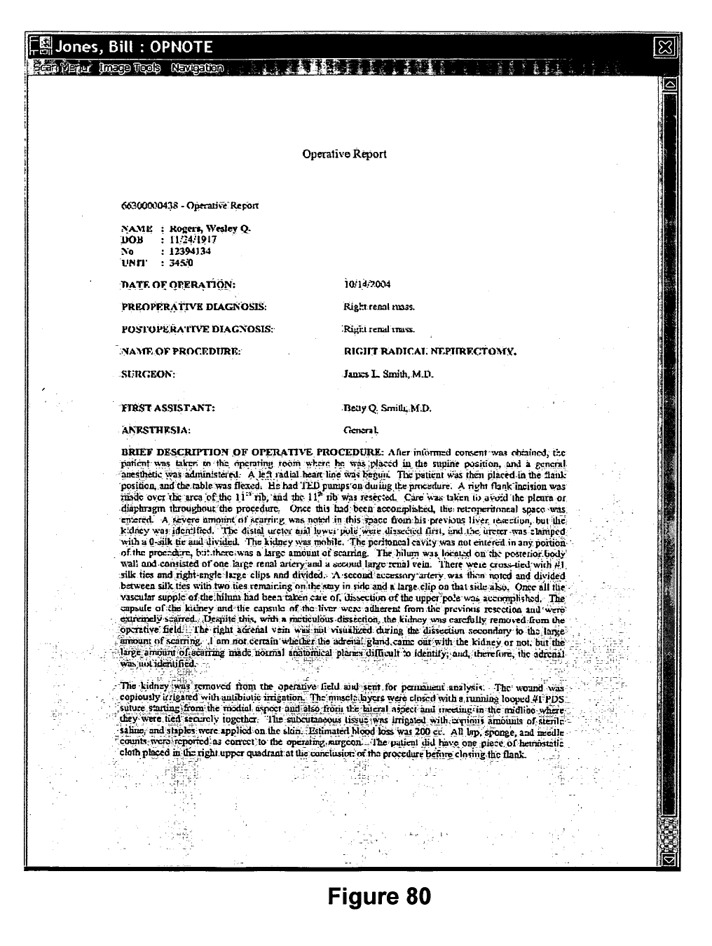

Past surgical history (PSH) section 276 includes chronologically-ordered PSH items 222 that are user-selectable to display additional information about an instance in the patient's PSH. Each PSH item 222 preferably comprises a graphical icon that includes a display that summarizes the type of surgical procedure that is the subject of the PSH instance. Thus, if the user wishes to view additional details about a patient's biopsy procedure from a particular date, then the user can select the BIOP icon 222 displayed on the timeline in section 276 for that date. FIG. 80 depicts an exemplary screen that shows the additional details for a patient's radiation procedure that could be displayed upon selection of a RADN icon 222 within timeline 210.

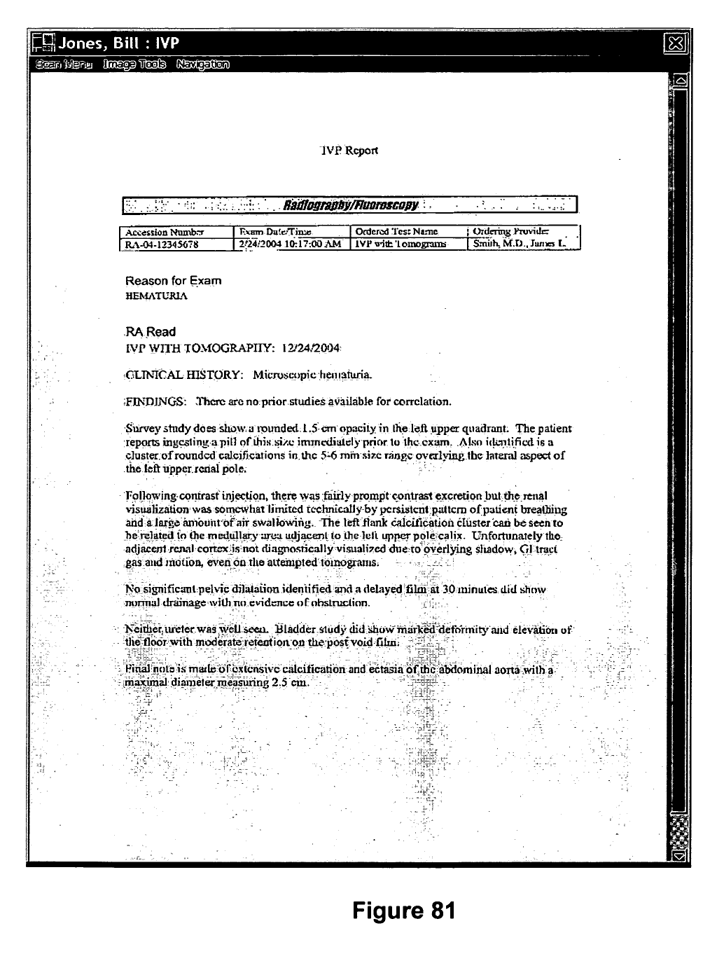

Imaging section 278 includes chronologically-ordered imaging items 226 that are user-selectable to display a copy of a particular medical image report in the patient's EMR. It should be noted that the system can also be configured to display the actual medical image corresponding to the report if desired by a practitioner of the present invention. Each imaging item 226 preferably comprises a graphical icon that includes a display that summarizes the type of medical image that is the subject of the imaging item. Thus, if the user wishes to view a patient's MR image report produced on a particular date, then the user can select the MRI icon 226 displayed on the timeline in section 278 for that date. FIG. 81 illustrates an exemplary user interface screen that shows the report that could be displayed upon user selection of an IVP icon 226 within timeline 210.

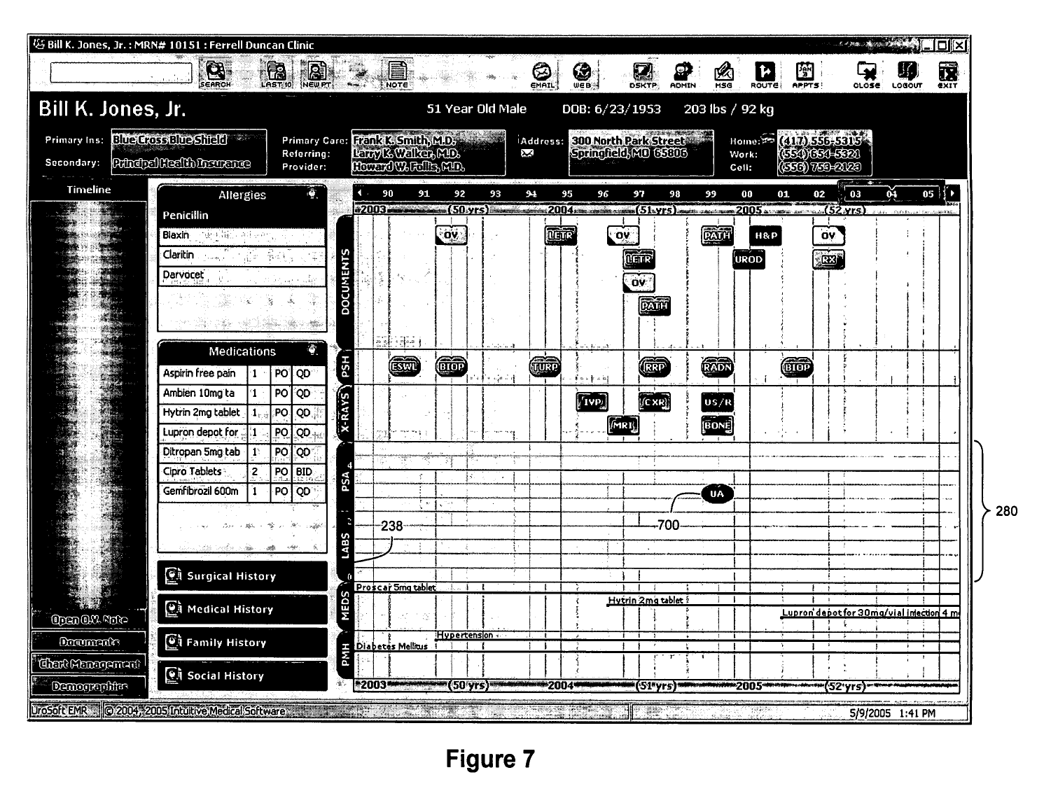

PSA/labs section 280 is preferably configured to allow the user to toggle between a PSA display and a labs display via user-selectable tabs 228 (to display PSA data in section 280) and 238 (to display labs data in section 280). FIG. 2 shows section 280 when the PSA display is active. FIG. 7 shows section 280 when the labs display is active.

With reference to FIG. 2, section 280 discloses graphs 230 and 234 that detail successive prostate specific antigen (PSA) results for the patient. Graph 230 includes a plurality of points 232 that define PSA results expressed in ng/ml. Each point 232 is located at a point along the time axis that corresponds to when the PSA test leading to that result was taken. For ease of reading graph 230, lines interconnecting points 232 can be displayed. Graph 234 includes a plurality of points 236 that define the PSA results of points 232 expressed in percentages. Each point 236 is located at a point along the time axis that corresponds to when the PSA test leading to that result was taken. For ease of reading graph 234, lines interconnecting points 236 can be displayed. The vertical scale in section 280 is preferably configured with 10 segments, wherein the lower 8 segments possess a linear scale and correspond to PSA results in the normal range of 0-4 ng/ml, and wherein the upper 2 segments possess a nonlinear scale and correspond to PSA results over 4 ng/ml. Preferably, the lower 8 segments possess a different background color than the upper 2 segments to allow a user to easily comprehend the significance of the displayed PSA results. It should also be noted that graphs 230 and 234 (or at least the points thereon) can be designed to be user-selectable to display a report for the graphed PSA results.

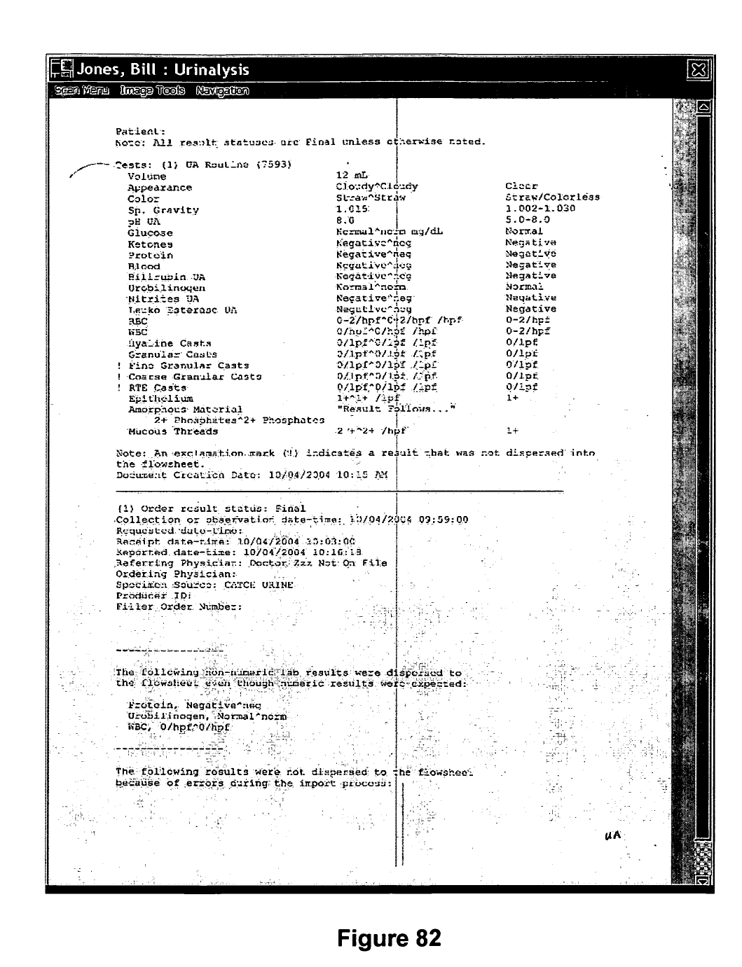

With reference to FIG. 7, section 280 discloses non-PSA laboratory results items 700 for the patient. Each laboratory results item 700 preferably comprises a graphical icon that includes a display that summarizes the type of laboratory result that is the subject of the item. Furthermore, each item 700 is user-selectable to display additional detailed information about the lab results that are the subject of the item. Thus, if the user wishes to view a patient's urinalysis (UA) lab results for a lab taken on a particular date, then the user can select the UA icon 700 displayed on the timeline in section 280 for that date. FIG. 82 depicts an exemplary screen that shows the additional details for a patient's UA results that could be displayed upon selection of a UA icon 700 within timeline 210

Returning to FIG. 2, medications section 282 includes chronologically-displayed graphs 242 depicting what medications the patient has been (or is currently) taking. Each graph 242 includes nearby text 244 that identifies the type of medication the patient was/is taking. Each graph 242 also includes a start point 242 located on the timeline in section 282 at a point along the time axis that corresponds to the date on which the patient began taking that medication. If a patient stopped taking a particular medication, then the corresponding graph 242 would also display a stop point, wherein the stop point is located on the timeline in section 282 at a point along the time axis that corresponds to the date on which the patient stopped taking that medication. In the event the start point or stop point for the patient's usage of a particular medication is outside the time duration covered by scale 208 as defined by scroller tool 206, the user can use scroller tool 206 to adjust scale 208 to ascertain the start and/or end date for the patient's usage of that medication. Furthermore, it should be noted that each graph 242 can be user-selectable to display additional information about the patient's usage of the medication corresponding to the selected graph.

Past medical history (PMH) section 284 includes chronologically-displayed graphs 250 depicting what medical conditions the patient has been (or is currently) experiencing. Each graph 250 includes nearby text 252 that identifies the type of medical condition the patient was/is experiencing. Each graph 250 also includes a start point 254 located on the timeline in section 284 at a point along the time axis that corresponds to the date on which the patient was first diagnosed with that medical condition or the date on which the patient reported first experiencing that medical condition, depending upon the desires of the user. If it is found that the patient is no longer experiencing that medical condition, then the corresponding graph 250 would also display a stop point, wherein the stop point is located on the timeline in section 284 at a point along the time axis that corresponds to the date on which the patient was found to no longer experience that condition (or the date that the patient reported that he/she was no longer experiencing that condition). In the event the start point or stop point for the patient's medical condition is outside the time duration covered by scale 208 as defined by scroller tool 206, the user can use scroller tool 206 to adjust scale 208 to ascertain the start and/or end date for the patient's medical condition. Furthermore, it should be noted that each graph 250 can be user-selectable to display additional information about the condition experienced by the patient that corresponds to the selected graph.

It is expected by the inventors herein that not all information that is stored in database 108 as part of the patient's EMR will be of interest to the user. For example, a urologist will have a heightened interest in portions of the patient's EMR that are related to the patient's urologic health. Patient EMR data that is not specifically related to the patient's urologic health will be of lesser interest to the urologist. As such, it is expected that a user who is a urologist would prefer that timeline 210 not be cluttered with data items that have lesser relevance to the patient's urologic health than other more urology-specific data items. As such, it is preferred that the patient timeline display less than all of the available data items from the patient's EMR in the y-axis sections of timeline 210. As explained in greater detail below, the EMR software code can be configured to appropriately classify user-entered patient data and documents such that the timeline 210 will display data items of interest to the user.

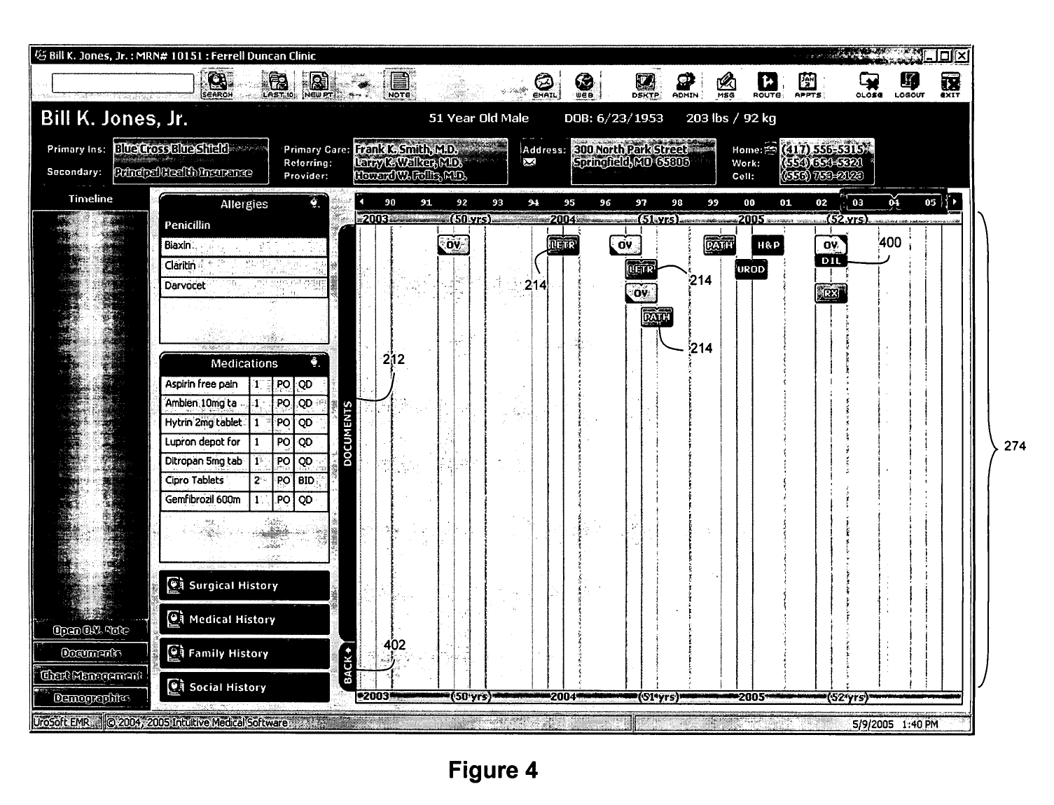

If a user wishes to view all of the data items within a particular section for the time period encompassed by scale 208 of the displayed timeline 210, then the user can select a tab or other portion of that section to cause an exploded view of that section to appear, wherein the exploded view includes a display of all of that section's data items within the time period encompassed by scale 208. For example, to see all of the document data items for the years 2003-2005, the user can select documents tab 212 on timeline 210 of FIG. 2. Upon selection of tab 212, an exploded documents view of timeline 210 will be displayed, as shown in FIG. 4. Exploded section 274 includes not only the document items 214 that were displayed on timeline 210 of FIG. 2 but also any additional document items 400 that fall within the time period encompassed by scale 208. As with items 212, items 400 are also user-selectable to display the full document associated therewith. User selection of “Back” tab 402 is effective to return the user to the main timeline 210 of FIG. 2.

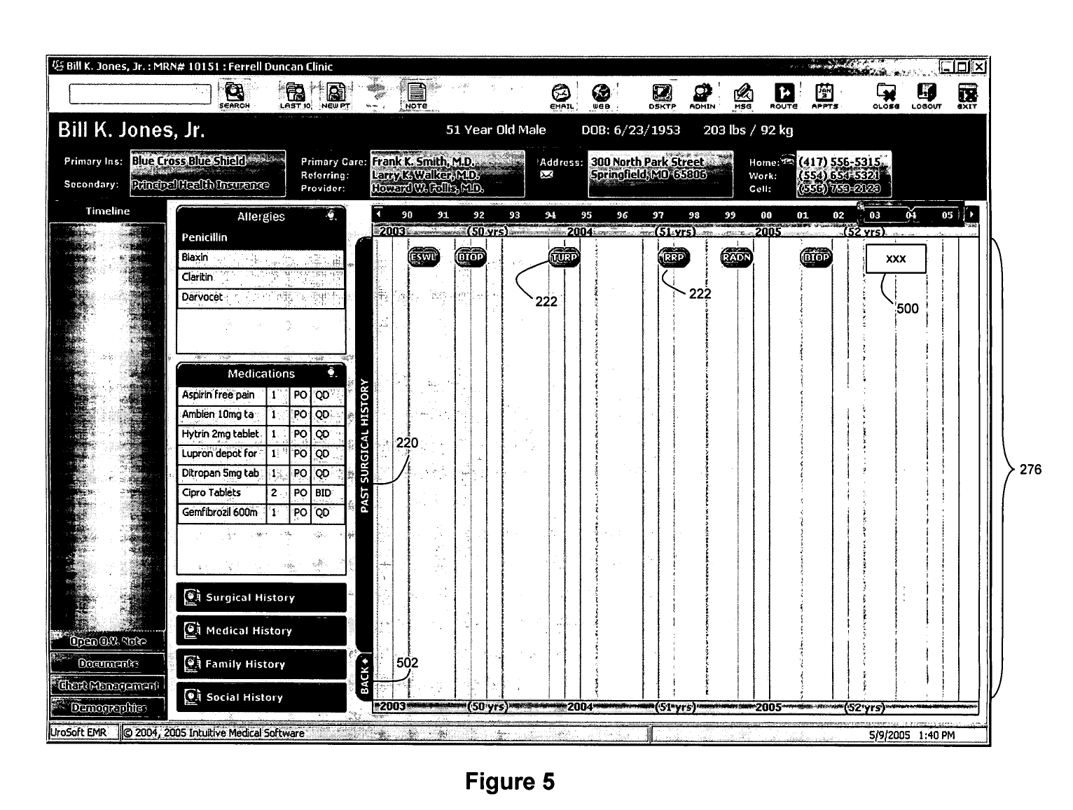

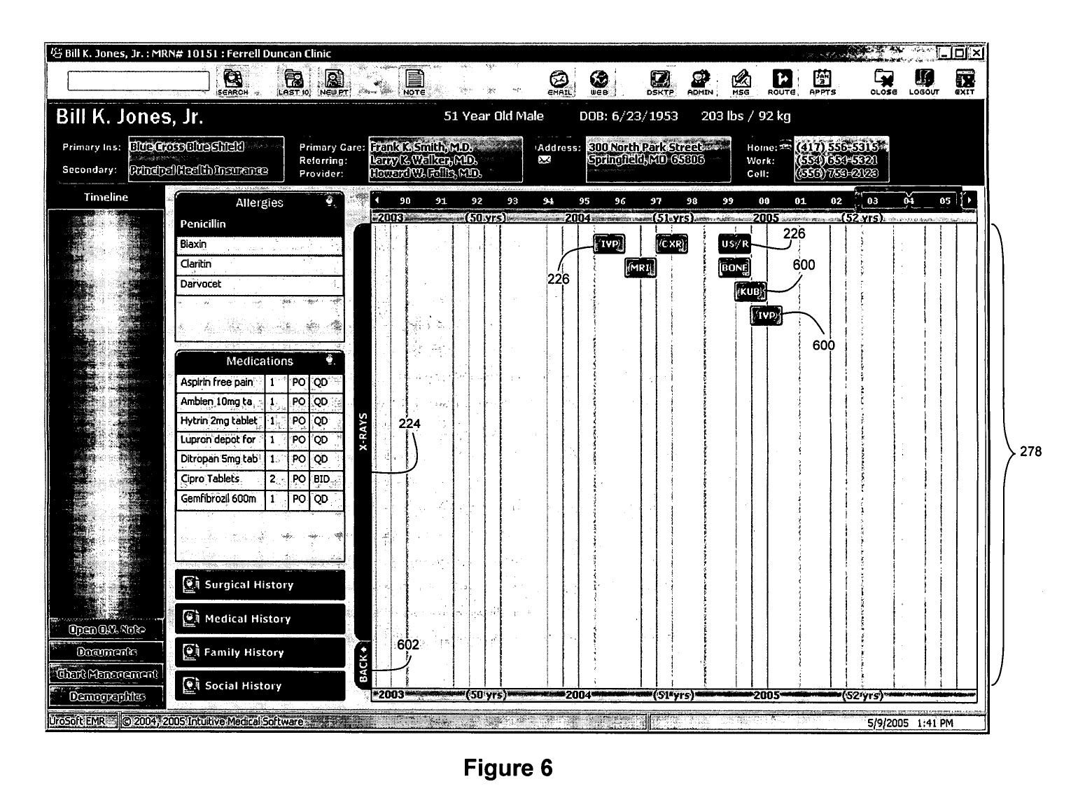

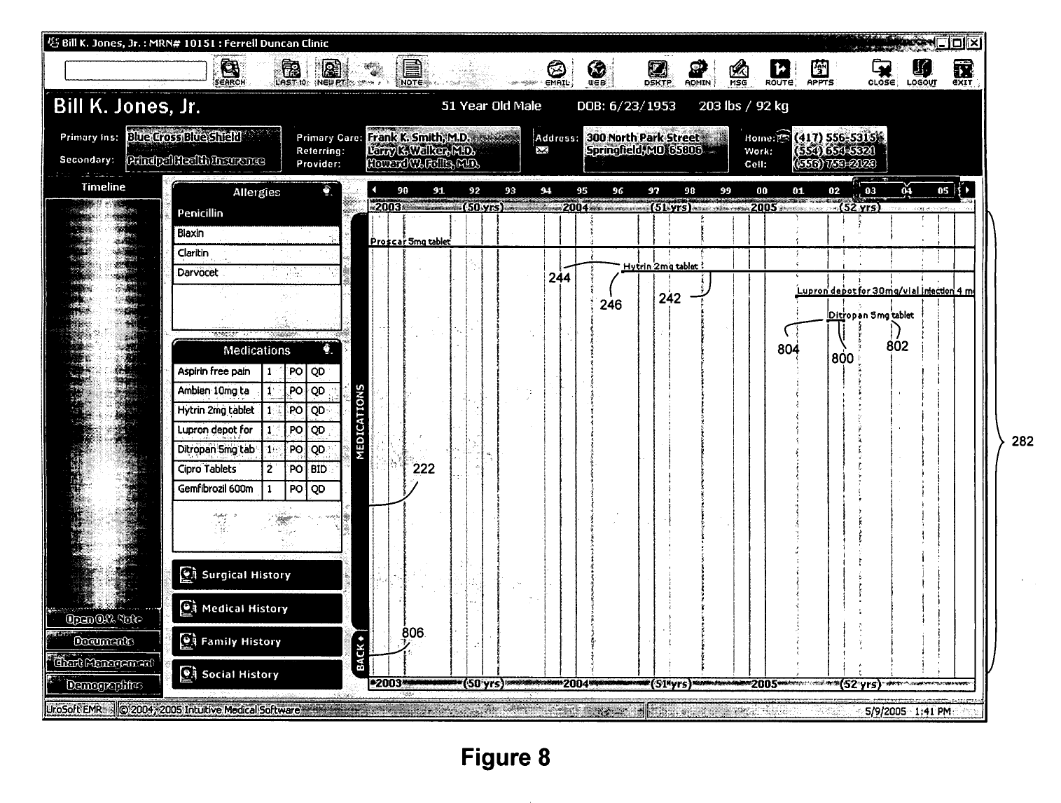

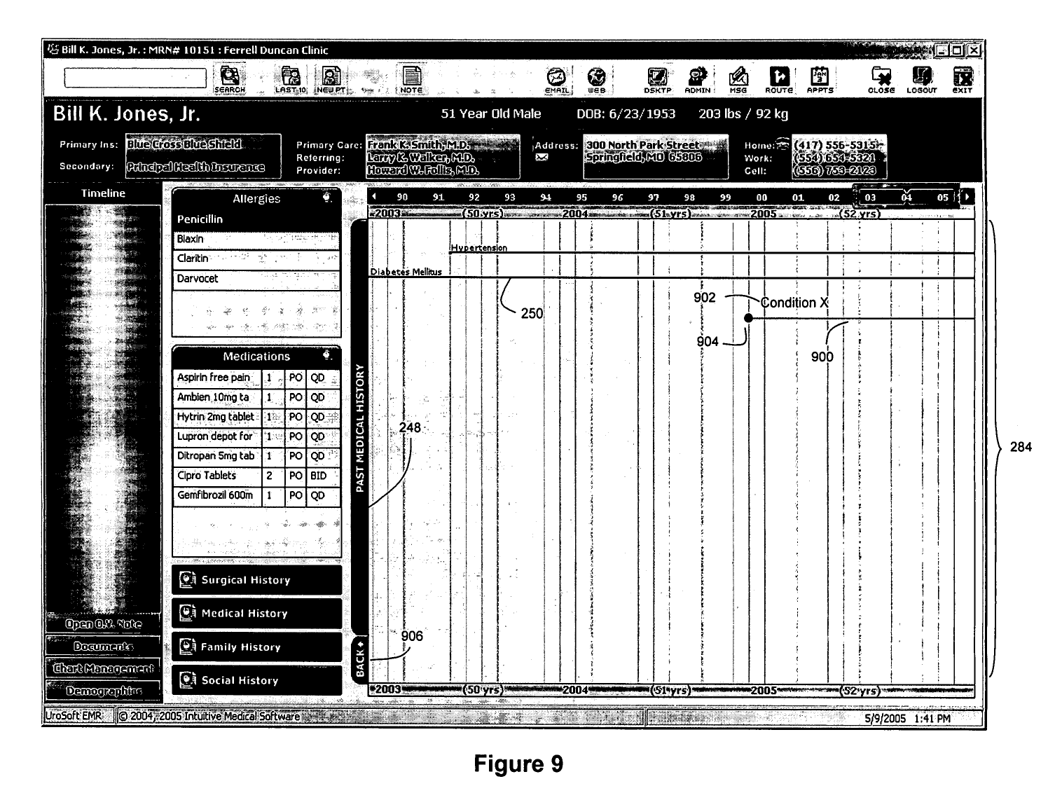

Similarly, user selection of the PSH tab 220 is effective to display the exploded view of PSH section 276, as shown in FIG. 5, wherein not only the PSH items 222 from FIG. 2 are shown but also additional PSH items 500 (which are user-selectable to display additional PSH information related to those items). User selection of “Back” tab 502 is effective to return the user to the main timeline 210 of FIG. 2. Also, user selection of the imaging tab 224 is effective to display the exploded view of imaging section 278, as shown in FIG. 6, wherein not only the imaging items 226 from FIG. 2 are shown but also additional imaging items 600 (which are user-selectable to display the medical images related to those items). User selection of “Back” tab 602 is effective to return the user to the main timeline 210 of FIG. 2. User selection of the medications tab 240 is effective to display the exploded view of medications section 282, as shown in FIG. 8, wherein not only the graphs 242 from FIG. 2 are shown but also additional graphs 800 (which include the start and end points 804 and textual information 802). User selection of “Back” tab 806 is effective to return the user to the main timeline 210 of FIG. 2. Lastly, user selection of the PMH tab 248 is effective to display the exploded view of PMH section 284, as shown in FIG. 9, wherein not only the graphs 250 from FIG. 2 are shown but also additional graphs 900 (which include the start and end points 904 and textual information 902). User selection of “Back” tab 906 is effective to return the user to the main timeline 210 of FIG. 2.

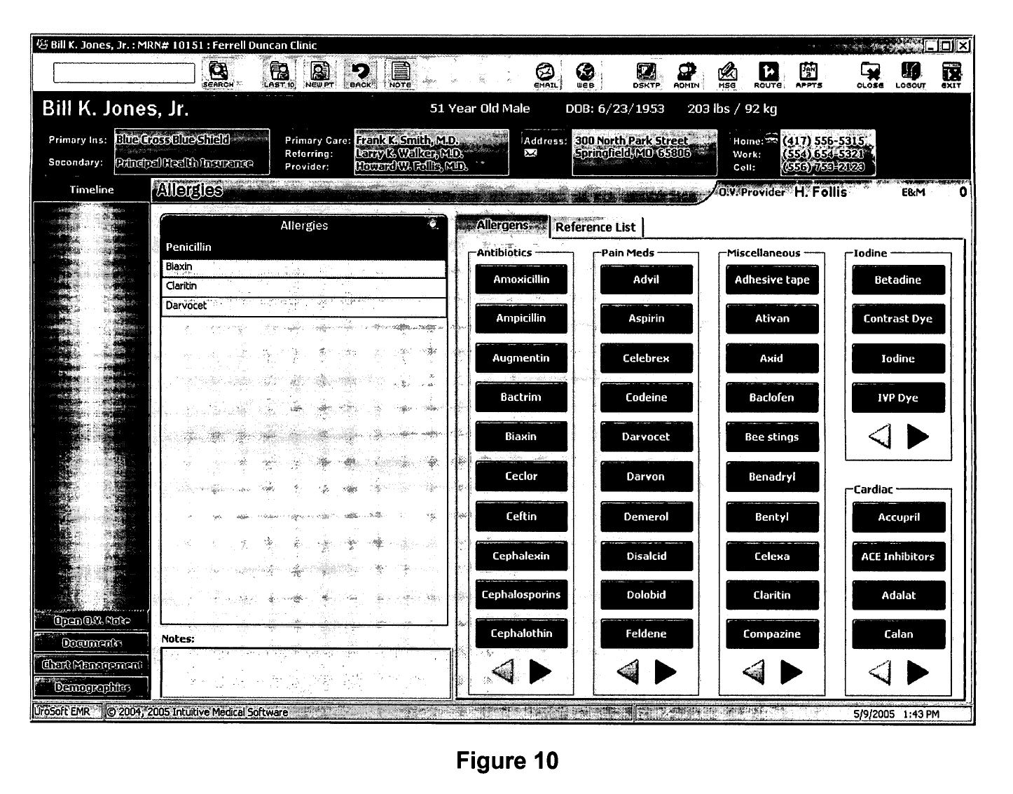

FIG. 10 illustrates an exemplary user interface screen that is displayed upon selection of the allergies table 260 of FIG. 2. Through the user interface of FIG. 10, the user can select which allergen from among a plurality of listed allergens should be added to the patient's allergy list. Preferably, the listed allergens can be broken down by allergen type, and if the number of allergens is sufficient to overflow from a single page view, forward and back arrows can be included to scroll through the list of allergens.

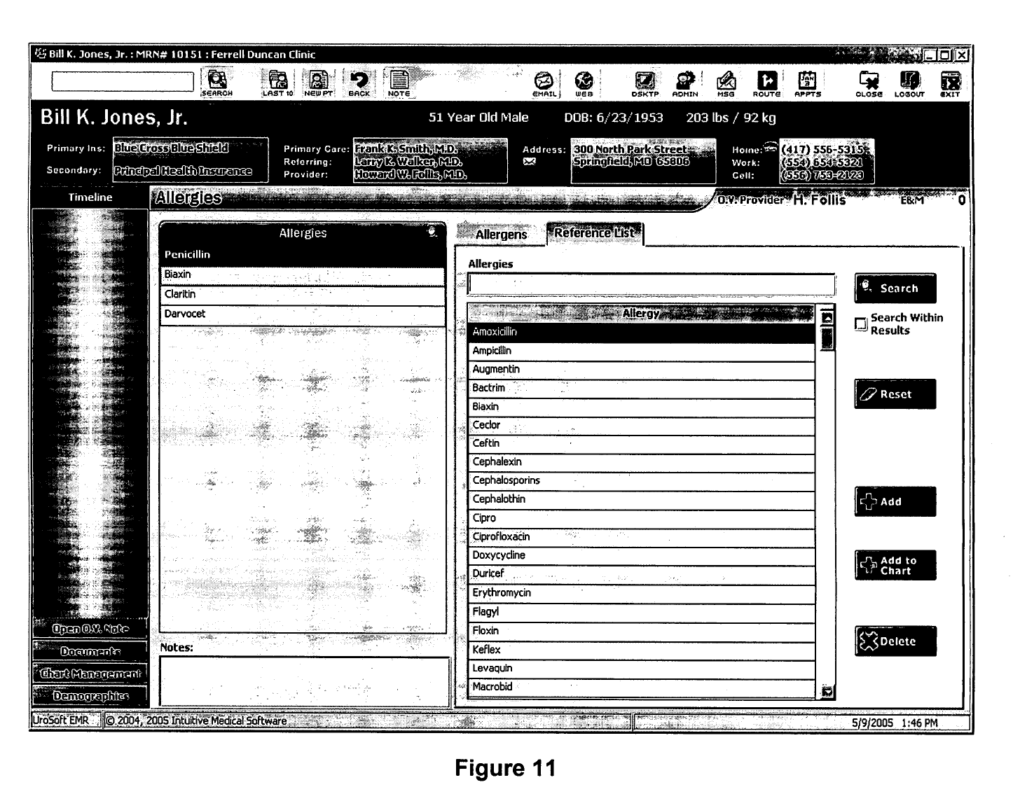

Preferably not all possible allergens are listed on the user interface of FIG. 10. The user may prefer to restrict this user interface to list only commonly-encountered allergens for ease of use. However, by following the reference list tab shown in FIG. 10, the user can cause the user interface screen of FIG. 11 to appear. From the user interface screen of FIG. 11, the user can control which allergens will be added and deleted from the list of allergens stored in database 108 (via the “Add” and “Delete” buttons). The user can also control which allergens will be added to the patient's allergy list (shown as the allergies table FIGS. 2, 10, and 11 via the “Add to Chart” button). Preferably, an allergen cannot be deleted from the database 108 if it is listed on any patient's EMR. From either the screens of either FIG. 10 or 11, the user can navigate back to the timeline screen 200 by selection of the timeline button in the upper left of FIGS. 10 and 11.

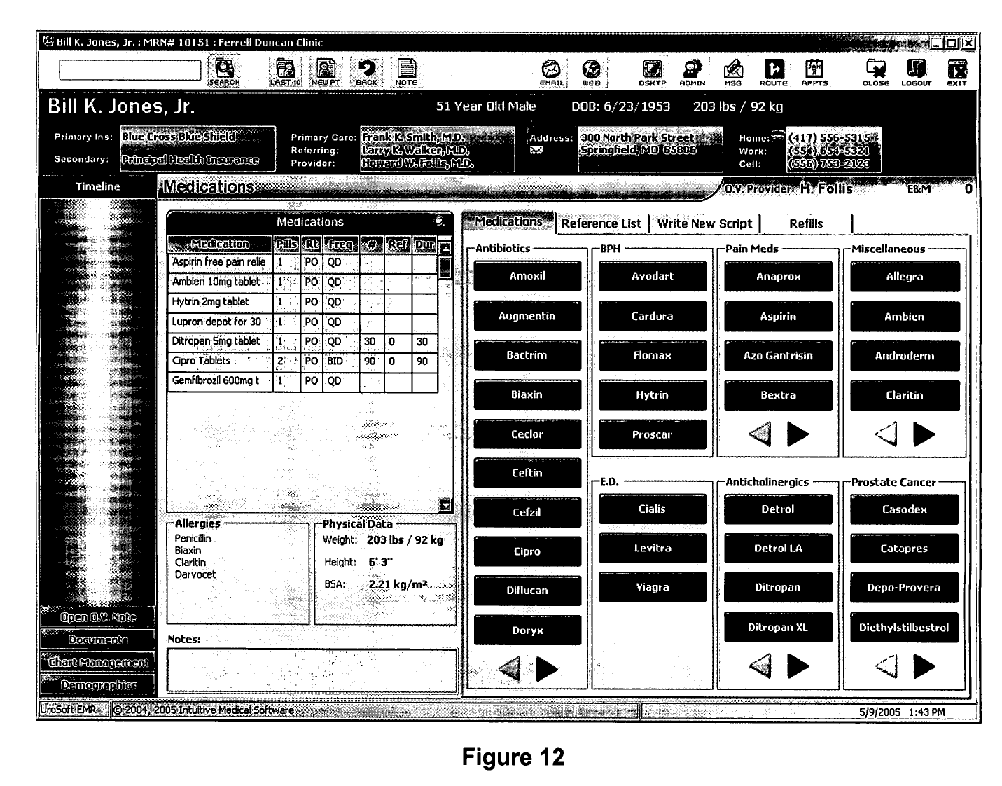

FIG. 12 illustrates an exemplary user interface screen that is displayed upon selection of the medications table 262 of FIG. 2. Through the user interface of FIG. 12, the user can update the patient's EMR to reflect any medications that the patient has started taking, continues to take, or has stopped taking. Preferably, the listed medications can be broken down by medication type, and if the number of medications is sufficient to overflow from a single page view, forward and back arrows can be included to scroll through the list of medications.

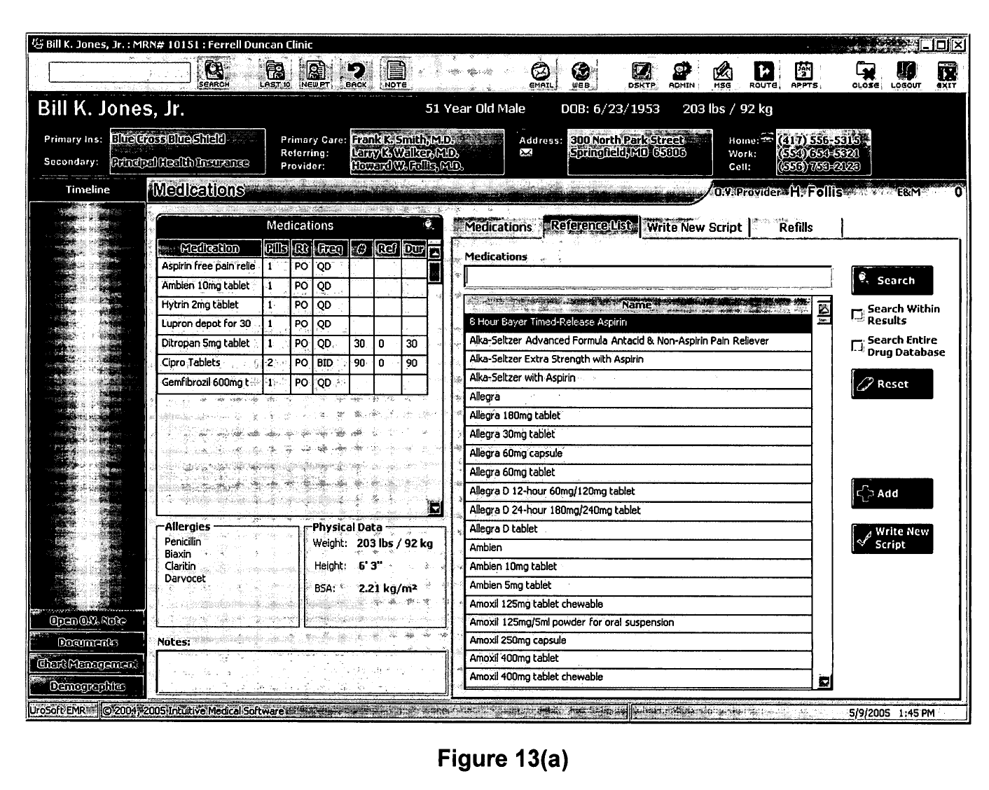

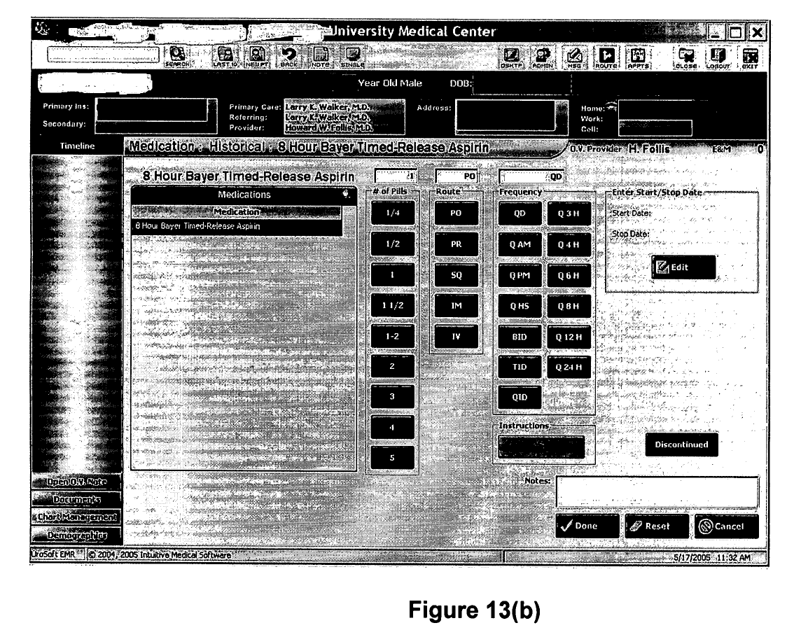

Preferably not all possible medications are listed on the user interface of FIG. 12. The user may prefer to restrict this user interface for ease of use to list only medications that are commonly prescribed as part of the physician's practice. However, by following the reference list tab shown in FIG. 12, the user can cause the user interface screen of FIG. 13(a) to appear. From the user interface screen of FIG. 13(a), the user can select a medication name and cause the user interface screen of FIG. 13(b) to appear. From the screen of FIG. 13(b), the user can select (1) the strength and amount of the medication (e.g., number of tablets, capsules, etc.) comprising a single dose, (2) the route of administration, and (3) the frequency of each dose. FIG. 13(b) thereby controls which medications will be listed on the patient's medication table shown in FIGS. 2, 12, etc.

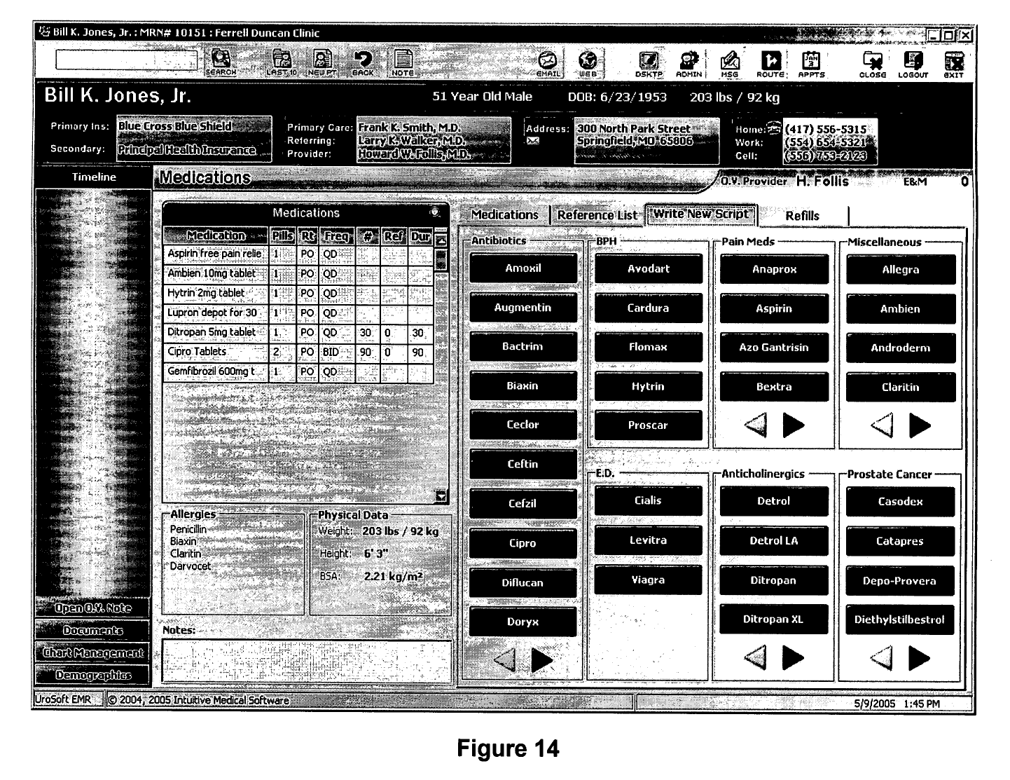

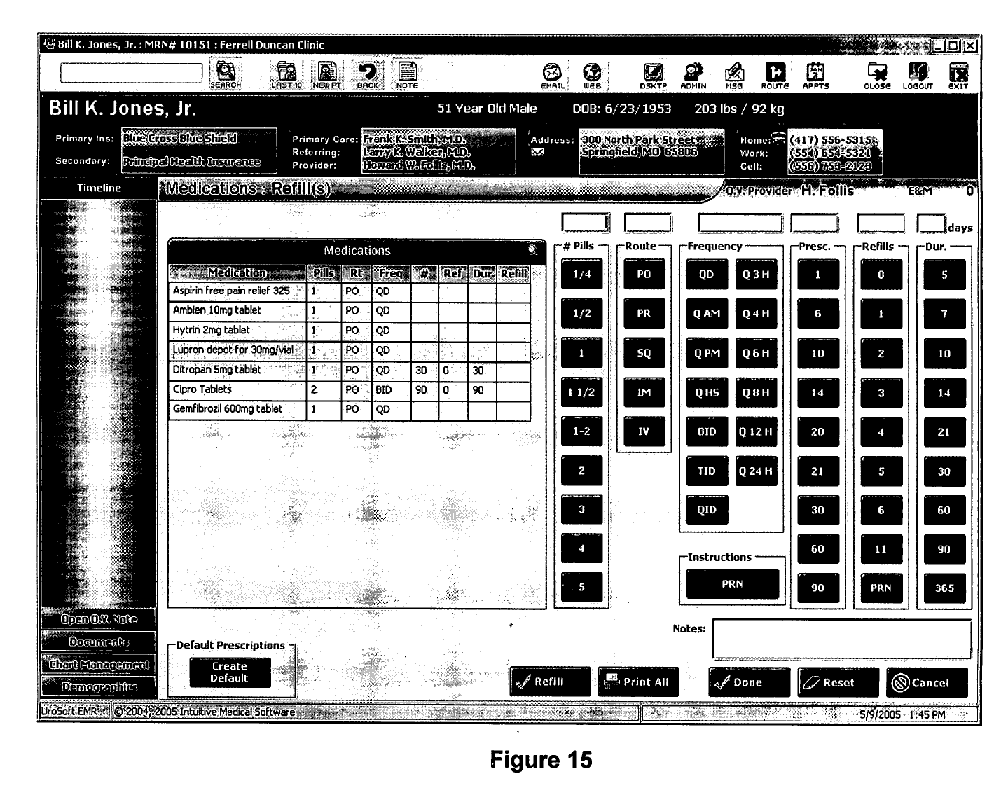

If the user wishes to write a new prescription for the patient, the user can follow the “Write New Script” tab to the user interface screen of FIG. 14, from which the user can create new prescriptions for the patient. If the user wishes to create a prescription refill for the patient, the user can follow the “Refills” tab to the user interface screen of FIG. 15, from which the user can create refills for the patient. Data added to the patient's EMR through the medication input screens of FIGS. 12-15 will be available for display on the timeline 210 of FIG. 2 if the pertinent medications are in the subset of medications deemed relevant to the user's practice area. Otherwise, that data is preferably only displayed on an exploded view of the medications section of the timeline. From any of the screens of FIGS. 12-15, the user can navigate back to the timeline screen 200 by selection of the timeline button in the upper left of those screens.

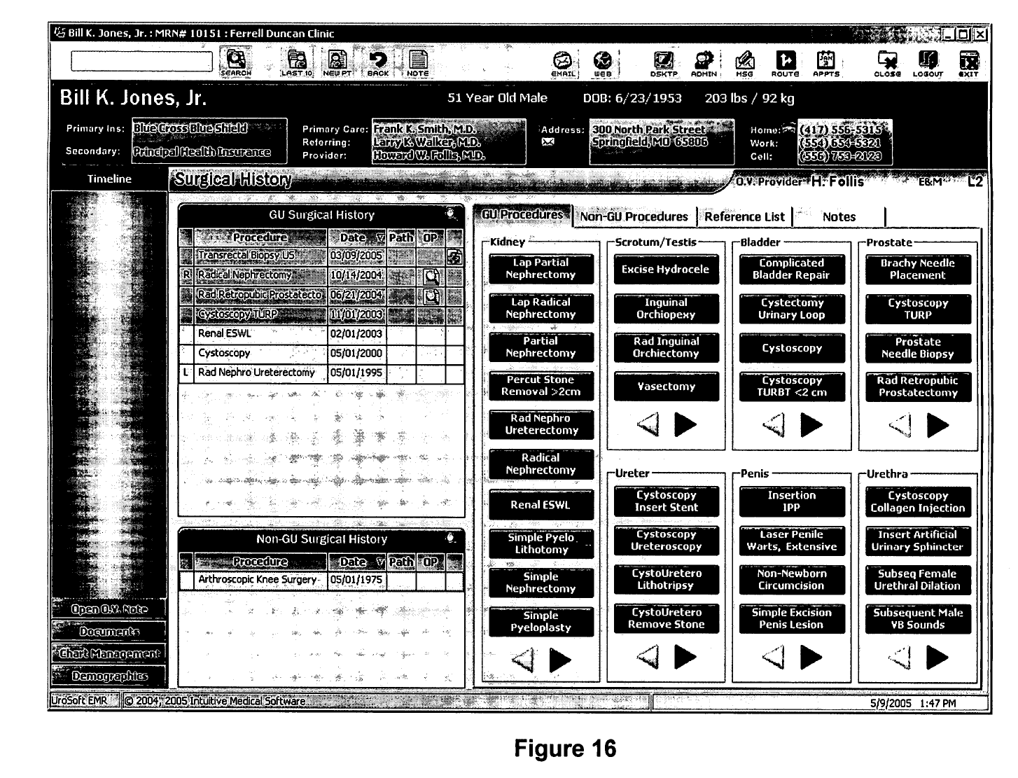

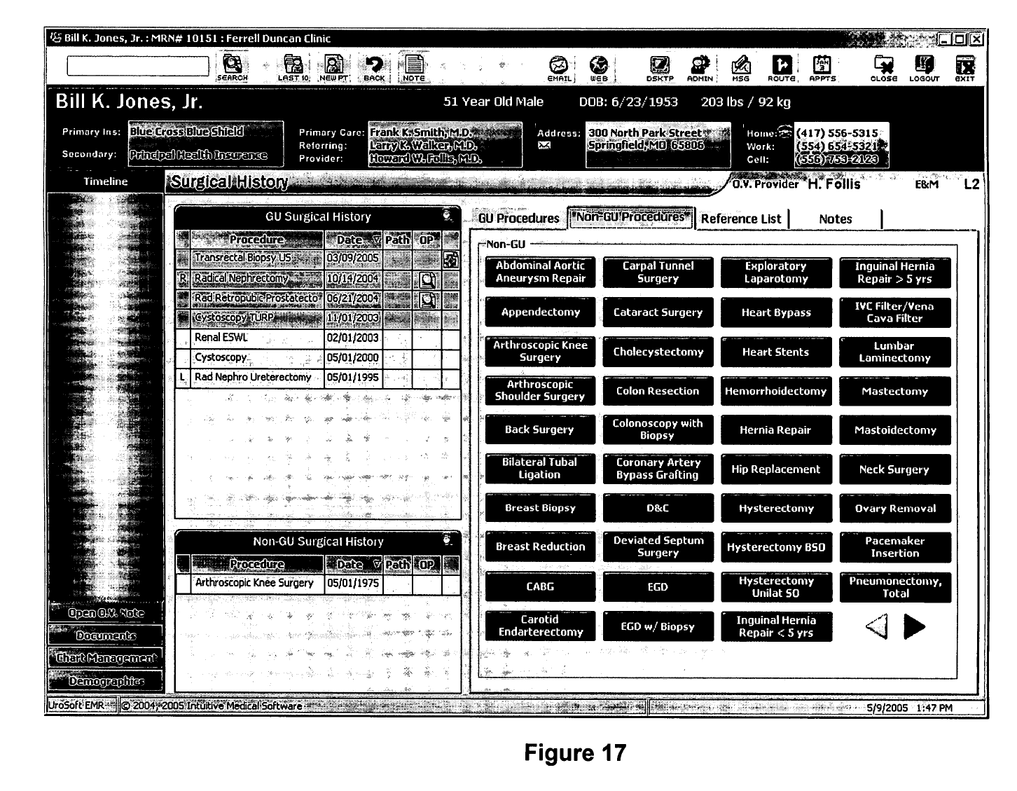

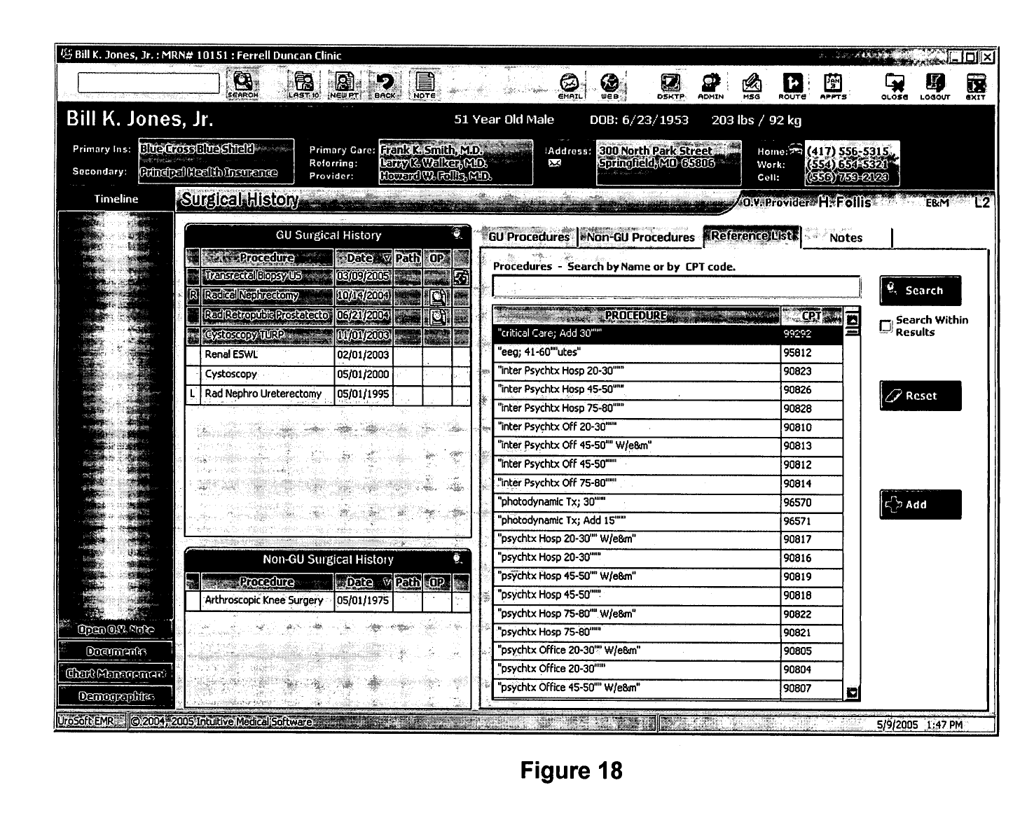

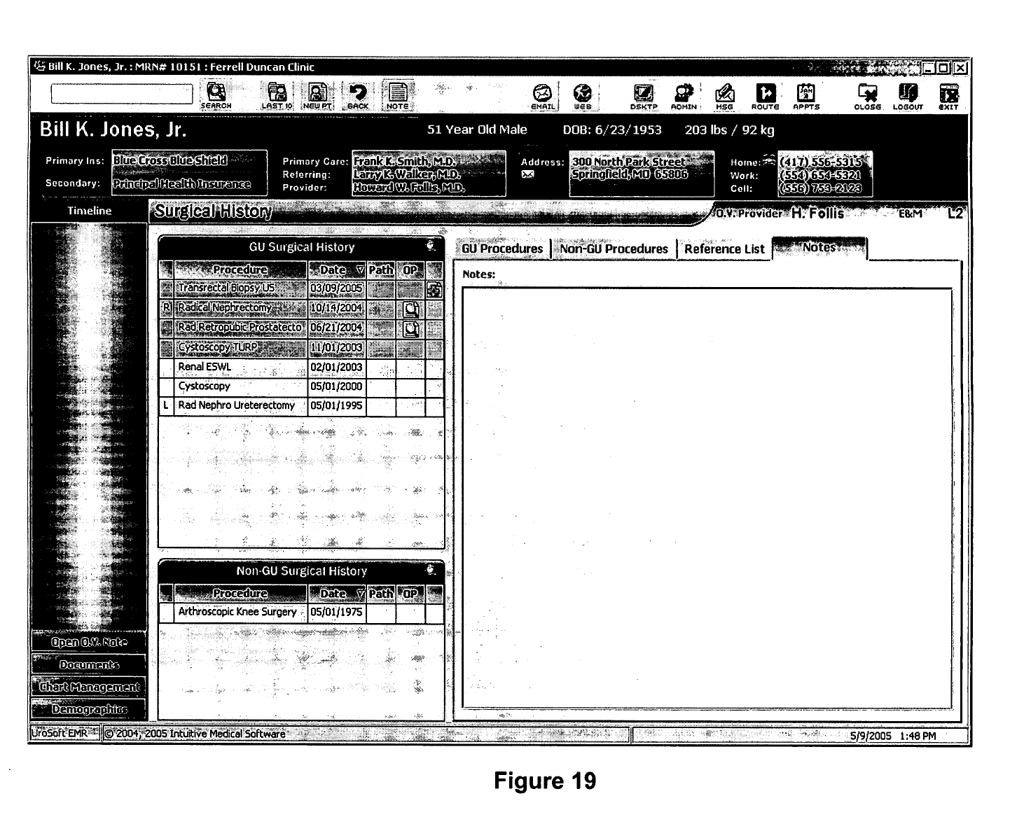

FIGS. 16-19 depict various exemplary user interface screens for controlling the PSH information that is stored with the patient's EMR (and ultimately displayed on timeline 210). These screens are reached upon user selection of the “Surgical History” button 266 shown in FIG. 2. The PSH screens preferably delineate between surgical procedures of specific relevance to the user's practice area (GU in this example) and procedures not of specific relevance to the user's practice area. Preferably tables for each type of PSH instances are displayed on these screens. To add PSH instances to the GU-specific table, the screen of FIG. 16 is used, which lists a plurality of possible GU procedures for selection to add to the GU-specific table. To add PSH items to the non-GU table of PSH, the screen of FIG. 17 is used, which lists a plurality of possible non-GU procedures for selection to add to the non-GU table of PSH. As discussed above, timeline 210 may be configured to display both GU and non-GU PSH if an exploded view of PSH section 276 is displayed. As shown in FIGS. 16 and 17, the user can navigate between these screens by appropriate selection of the “GU Procedures” and “Non-GU Procedures” tabs. The user interface screen of FIG. 18 is for adding PSH items to the patient's PSH portion of the EMR from a reference list of possible surgical procedures. If a selected PSH instance from the reference list has a predetermined relevance to the user's practice area, then the system software preferably operates to tag that PSH instance for display on the timeline 210 of FIG. 2. If a selected PSH instance from the reference list does not have a predetermined relevance to the user's practice area, then the system software preferably operates to tag that PSH instance for display only on an exploded view of the timeline's PSH section. Lastly, through the screen of FIG. 19, the user can add notes about the patient's PSH to the patient's EMR.

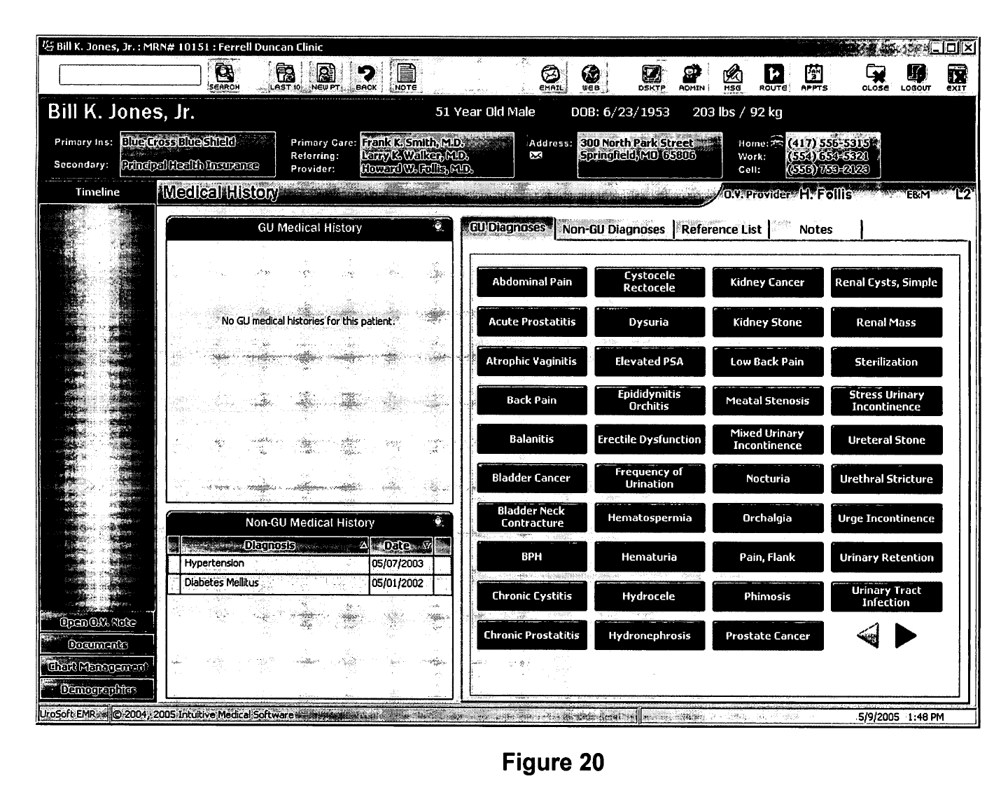

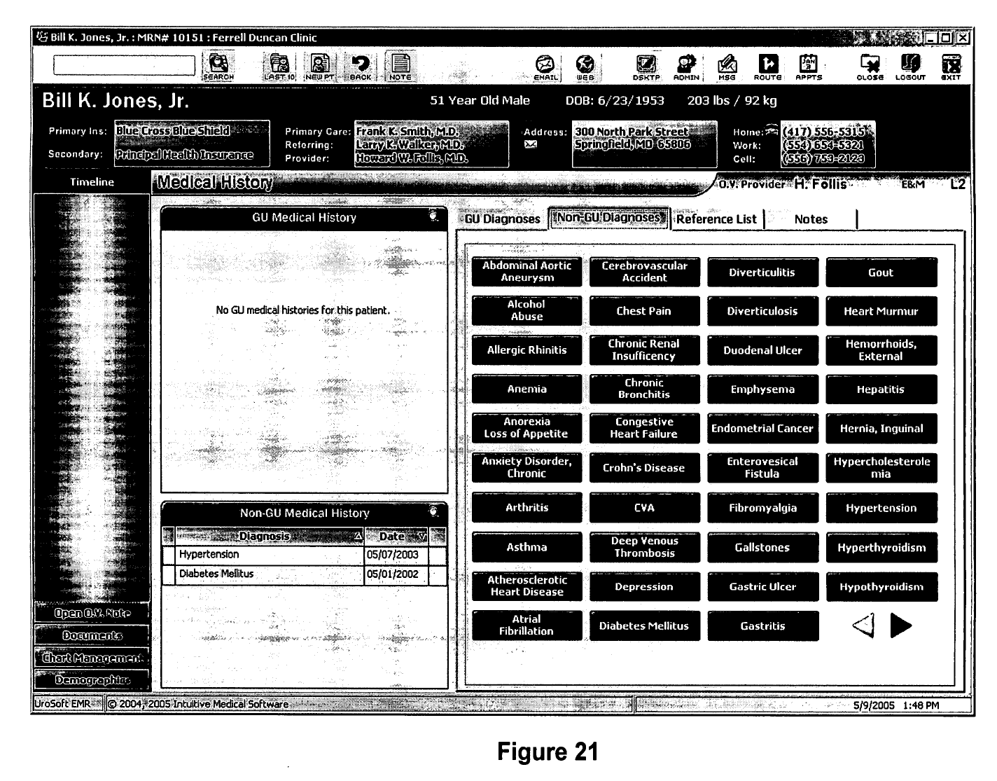

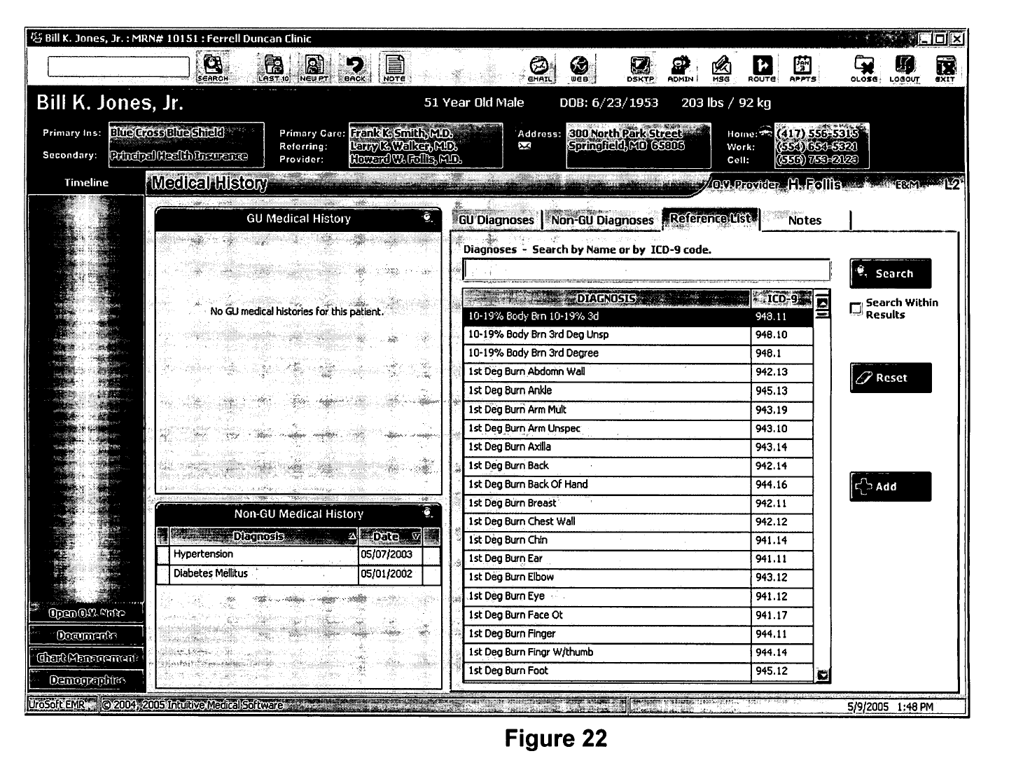

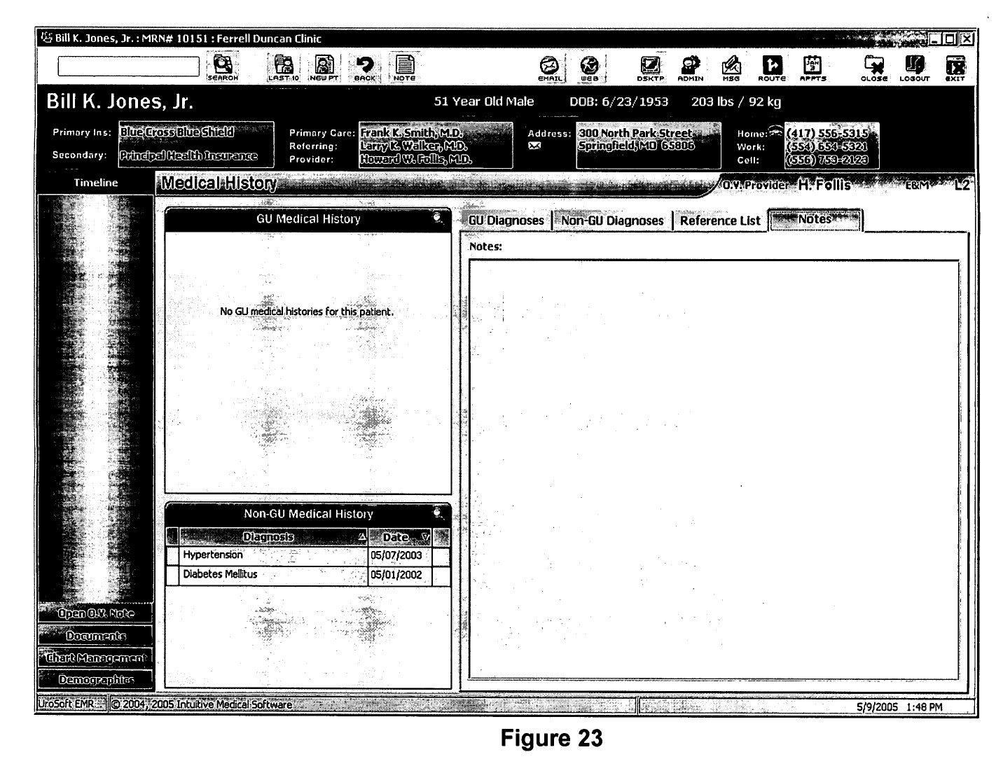

FIGS. 20-23 depict various exemplary user interface screens for controlling the past medical history (PMH) information that is stored with the patient's EMR (and ultimately displayed on timeline 210). These screens are reached upon user selection of the “Medical History” button 268 shown in FIG. 2. The PMH screens preferably delineate between medical conditions of specific relevance to the user's practice area (GU in this example) and medical conditions not of specific relevance to the user's practice area. Preferably tables for each type of PMH instances are displayed on these screens. To add PMH instances to the GU-specific table, the screen of FIG. 20 is used, which lists a plurality of possible GU diagnoses for selection to add to the GU-specific table. To add PMH items to the non-GU table of PMH, the screen of FIG. 21 is used, which lists a plurality of possible non-GU diagnoses for selection to add to the non-GU table of PMH. As discussed above, timeline 210 may be configured to display both GU and non-GU PMH if an exploded view of PMH section 284 is displayed. However, it is preferred that timeline 210 display all PMH items, whether GU or non-GU subject to available space on the timeline (wherein PMH instances that do not fit within section 284 of timeline 210 of FIG. 2 can be displayed in the exploded view of section 284 shown in FIG. 9. As shown in FIGS. 20 and 21, the user can navigate between these screens by appropriate selection of the “GU Diagnoses” and “Non-GU Diagnoses” tabs. The user interface screen of FIG. 22 is for adding PMH items to the patient's PMH portion of the EMR from a reference list of possible medical conditions. If a selected PMH instance from the reference list has a predetermined relevance to the user's practice area, then the system software preferably operates to tag that PMH instance for display on the timeline 210 of FIG. 2. If a selected PMH instance from the reference list does not have a predetermined relevance to the user's practice area, then the system software preferably operates to tag that PMH instance for display only on an exploded view of the timeline's PMH section. Lastly, through the screen of FIG. 23, the user can add notes about the patient's PMH to the patient's EMR.

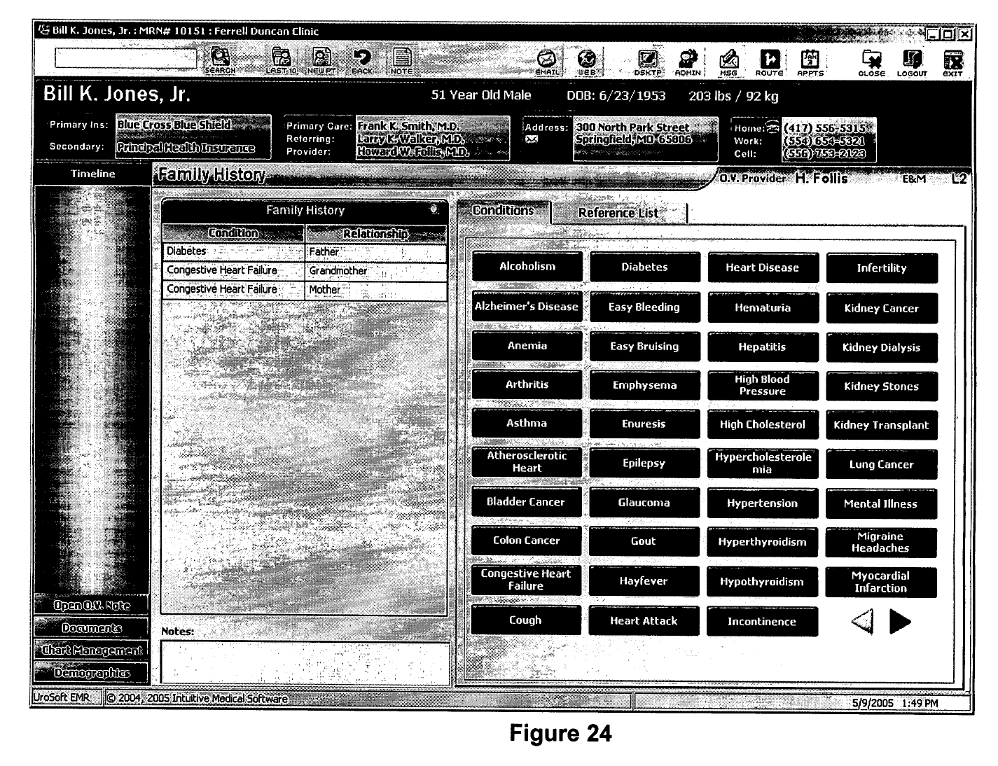

FIG. 24 illustrates an exemplary user interface screen that is displayed upon selection of the family history button 270 of FIG. 2. Through the user interface of FIG. 24, the user can select which conditions from among a plurality of listed conditions should be added to the family history portion of the patient's EMR (which are listed in the family history table shown in FIG. 24). Preferably, if the number of conditions to choose from is sufficient to overflow from a single page view, forward and back arrows can be included to scroll through the list of conditions.

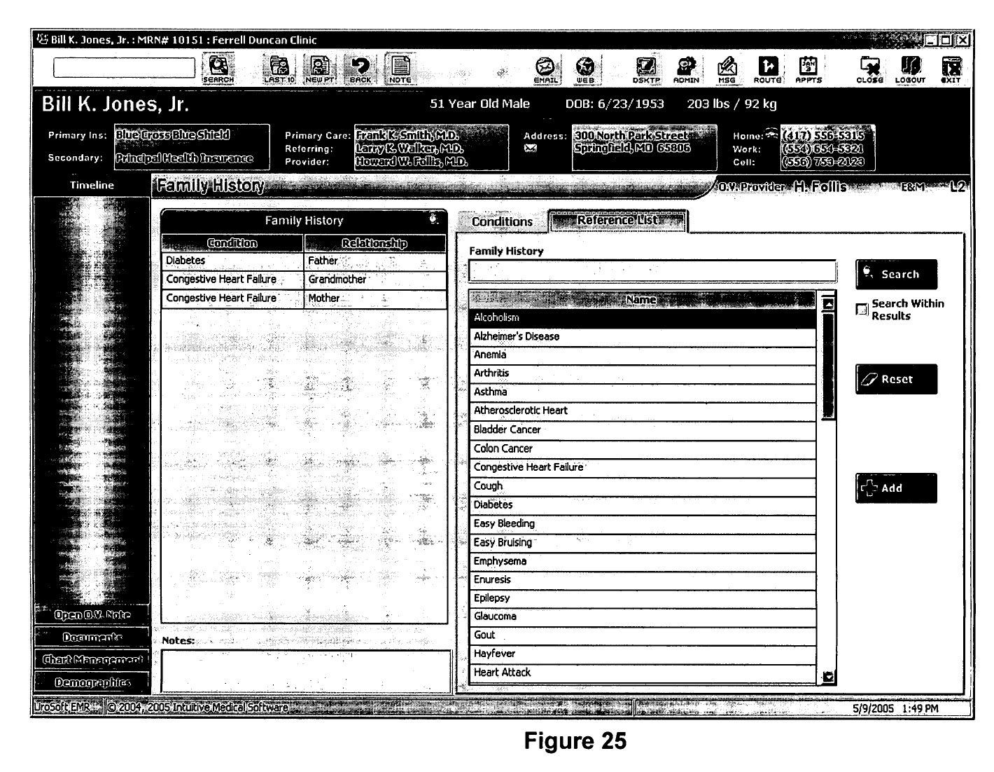

Preferably not all possible conditions are listed on the user interface of FIG. 24. The user may prefer to restrict the FIG. 24 user interface to list only commonly encountered conditions for that physician's practice for ease of use. However, by following the reference list tab shown in FIG. 24, the user can cause the user interface screen of FIG. 25 to appear. From this user interface screen, the user can select which conditions from a larger list of conditions should be added to the patient's family history table. FIG. 25 may include an “Add to Chart” button and a “Delete” button as described above in connection with FIG. 11 to provide the user with control over what is added to the patient's EMR with respect to family history.

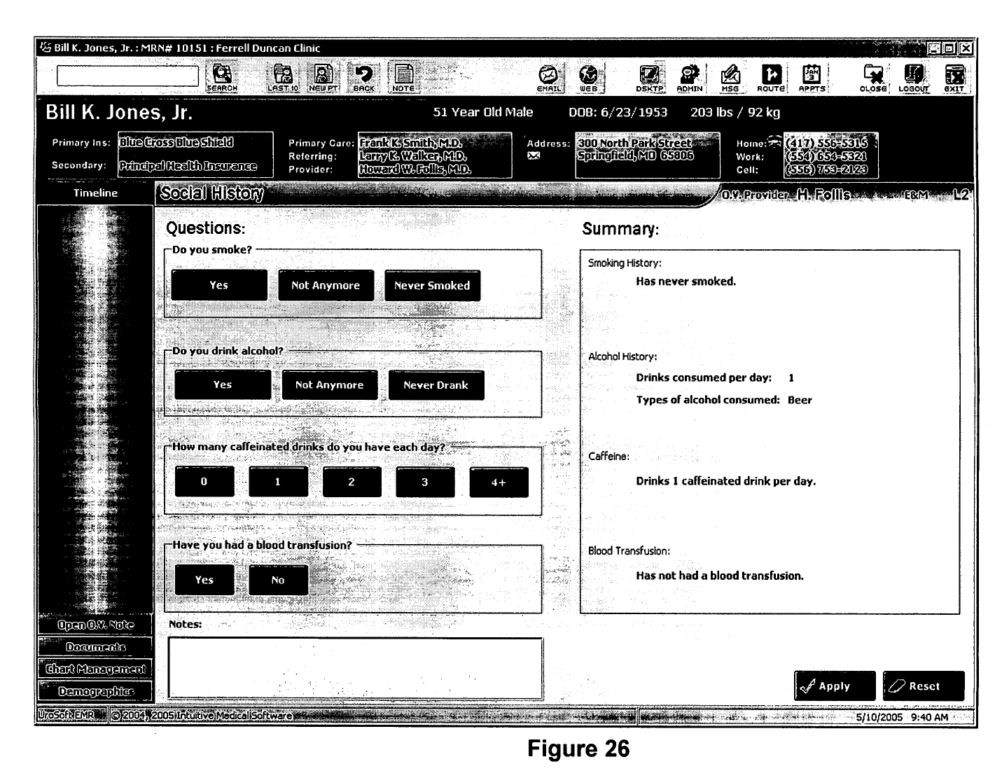

FIG. 26 illustrates an exemplary user interface screen that is displayed upon selection of the social history button 272 of FIG. 2. Through the user interface of FIG. 26, the user can fill out an electronic form related to the patient's social history that is to be stored as part of the patient's EMR.

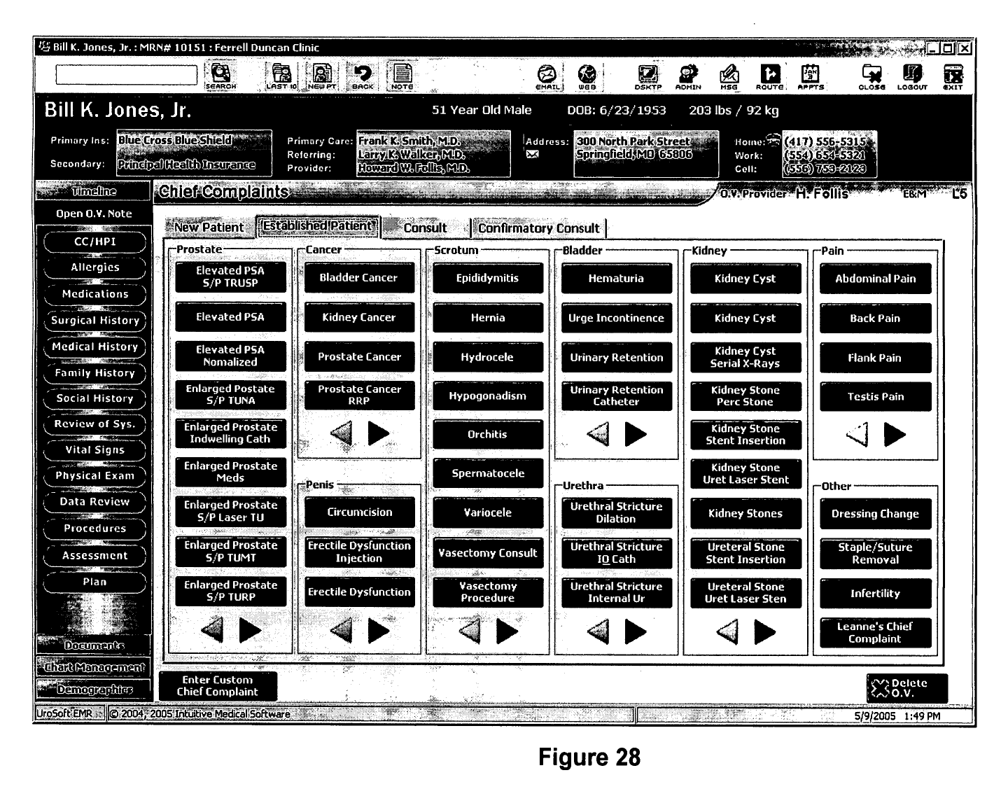

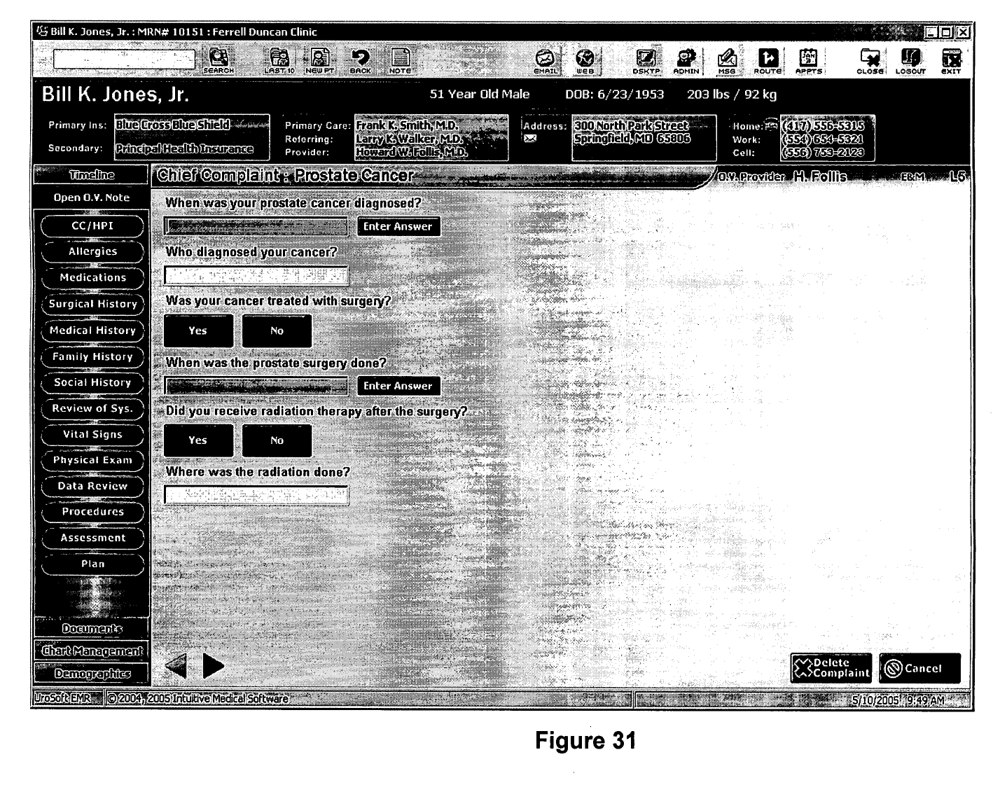

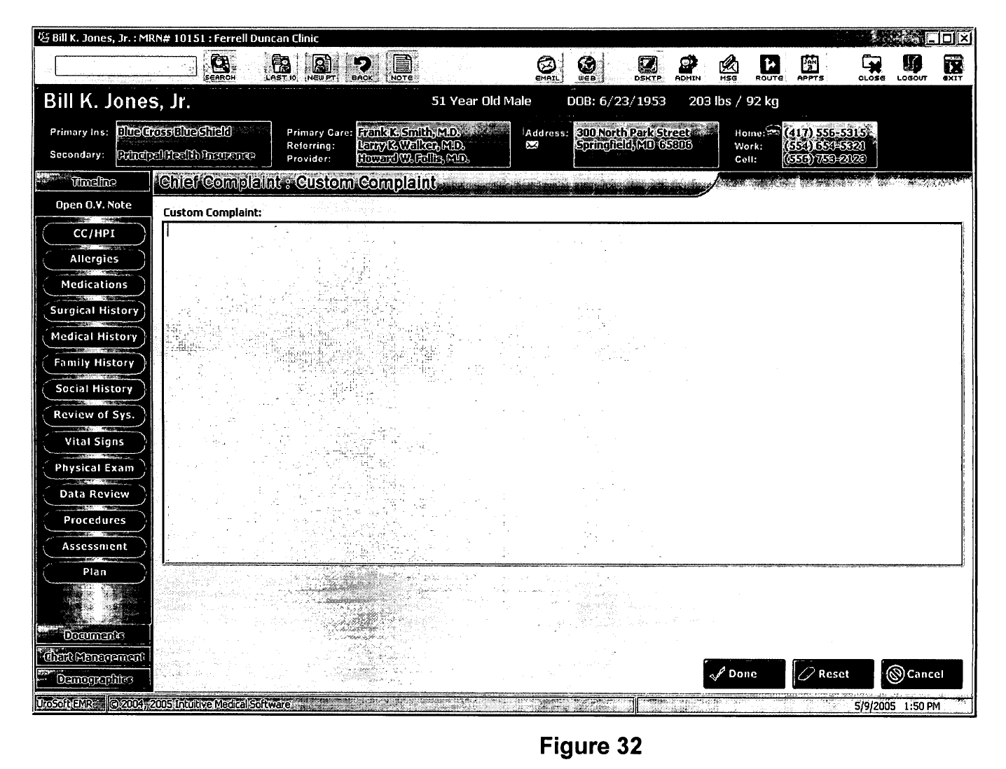

If the user wishes to create an office visit (OV) note describing the pertinent details of a patient's office visit, the user can select the “Open O.V. Note” button 274 shown in FIG. 2. Upon selection of button 274, the user is preferably navigated to the user interface screen shown in FIG. 27. Along the left hand side of the FIG. 27 screen is a list of selectable buttons for identifying the type of information to add to the OV note about the patient's visit (e.g., the CC/HPI button, Allergies button, Medications button, and so on down to the Plan button). FIGS. 27-32 depict preferred screens corresponding to the CC/HPI button within the Open OV Note section. FIG. 27 allows the user to select the chief complaint identified by a new patient from a list of possible chief complaints. FIGS. 28-30 depict similar screens for established patients, consults, and confirmatory consults respectively. FIG. 31 depicts an exemplary screen that would appear upon user selection of one of the chief complaint options from FIGS. 27-30 (the “prostate cancer” chief complaint in this example). The screen of FIG. 31 allows the user to enter additional information about the “History of the Present Illness” (or HPI) characterizing the patient's chief complaint. If the patient's chief complaint is not present on the list of possible chief complaints, then the user can select the “Enter Custom Chief Complaint” button shown on FIGS. 27-30 to call up the screen of FIG. 32. FIG. 32 is configured to allow the user to enter a customized notes describing the patient's chief complaint.

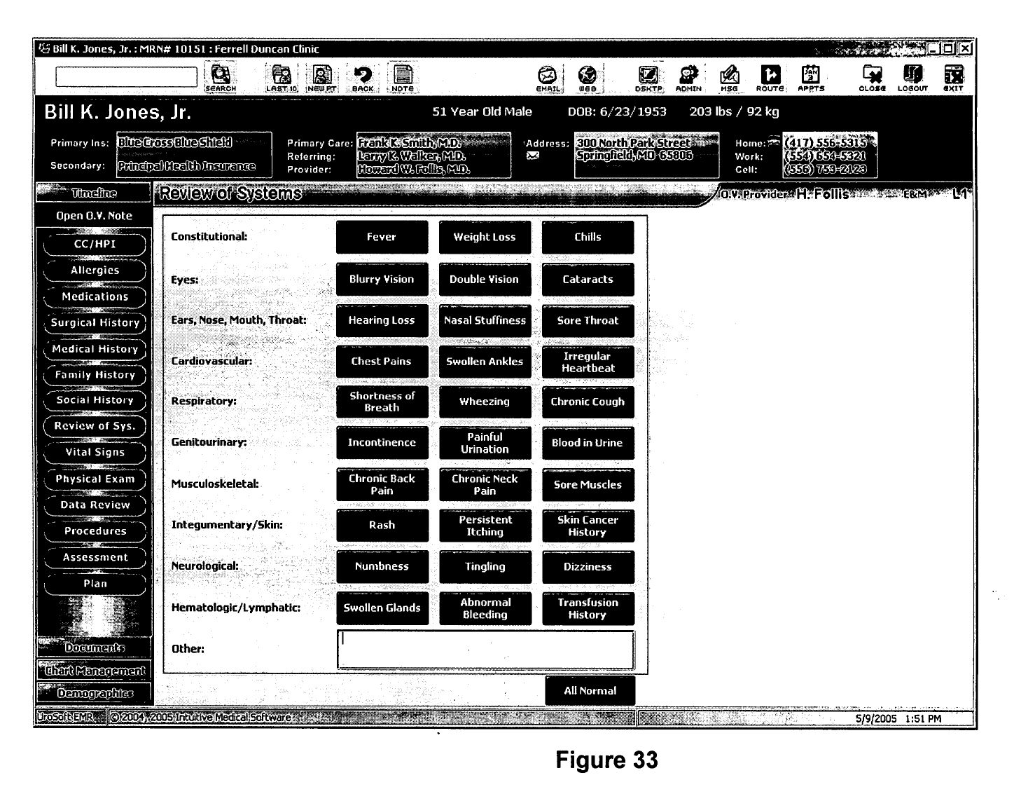

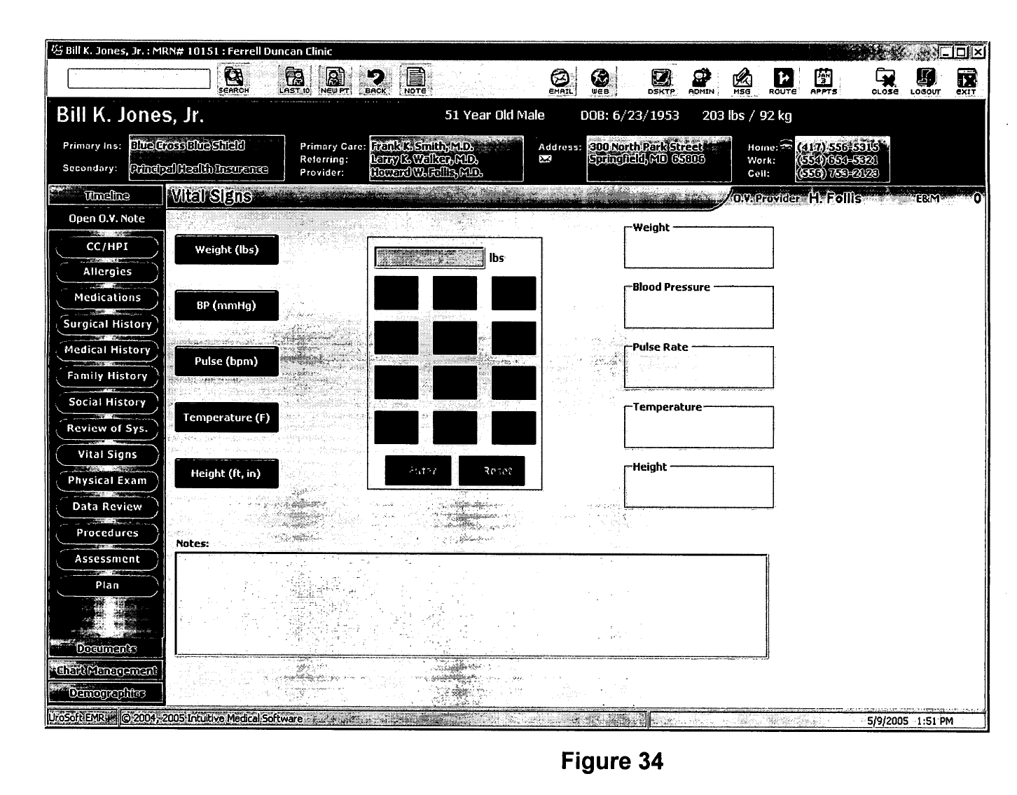

User selection of the Allergies, Medications, Surgical History, Medical History, Family History, and Social History buttons within the Open O.V. Note section is effective to display the screens described in connection with FIGS. 10-26 as described above. User selection of the Review of Systems button within the Open O.V. Note section is effective to display the user interface screen of FIG. 33. The FIG. 33 screen is configured to interact with the user to obtain the user's observations about a review of various ones of the patient's systems. User selection of the Vital Signs button within the Open O.V. Note section is effective to display the user interface screen of FIG. 34. The FIG. 34 screen is configured to interact with the user to obtain the patient's vital signs. The example of FIG. 34 depicts a screen for entering the patient's weight. However, other screens can also be used to enter the patient's blood pressure, pulse, temperature, height, or other pertinent vital signs.

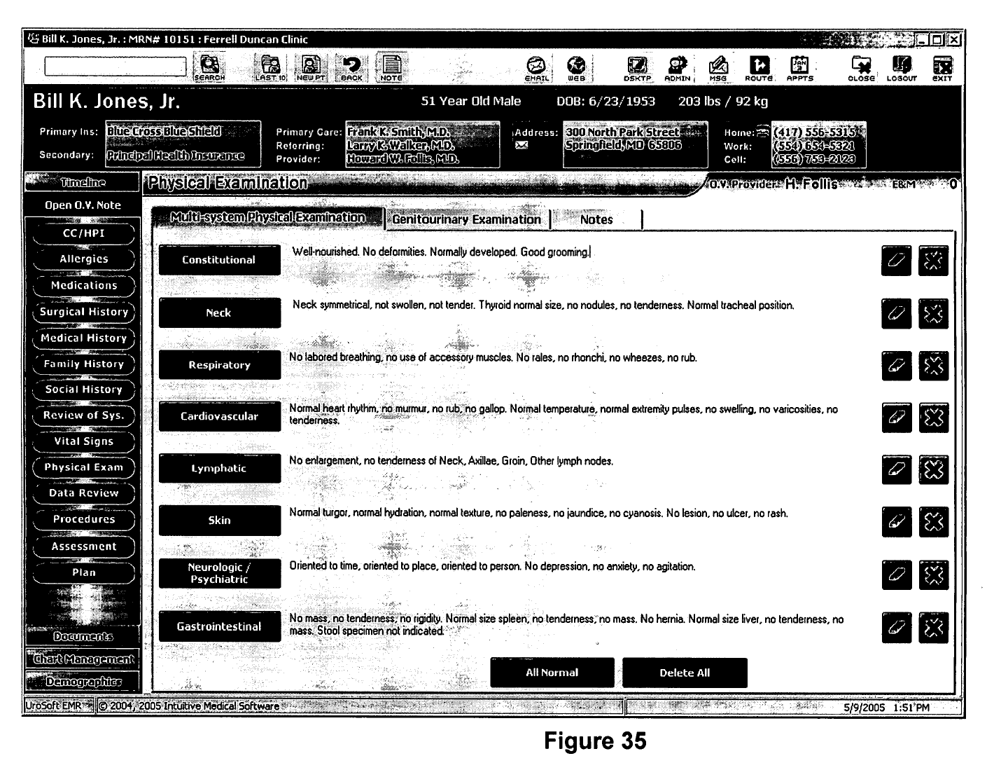

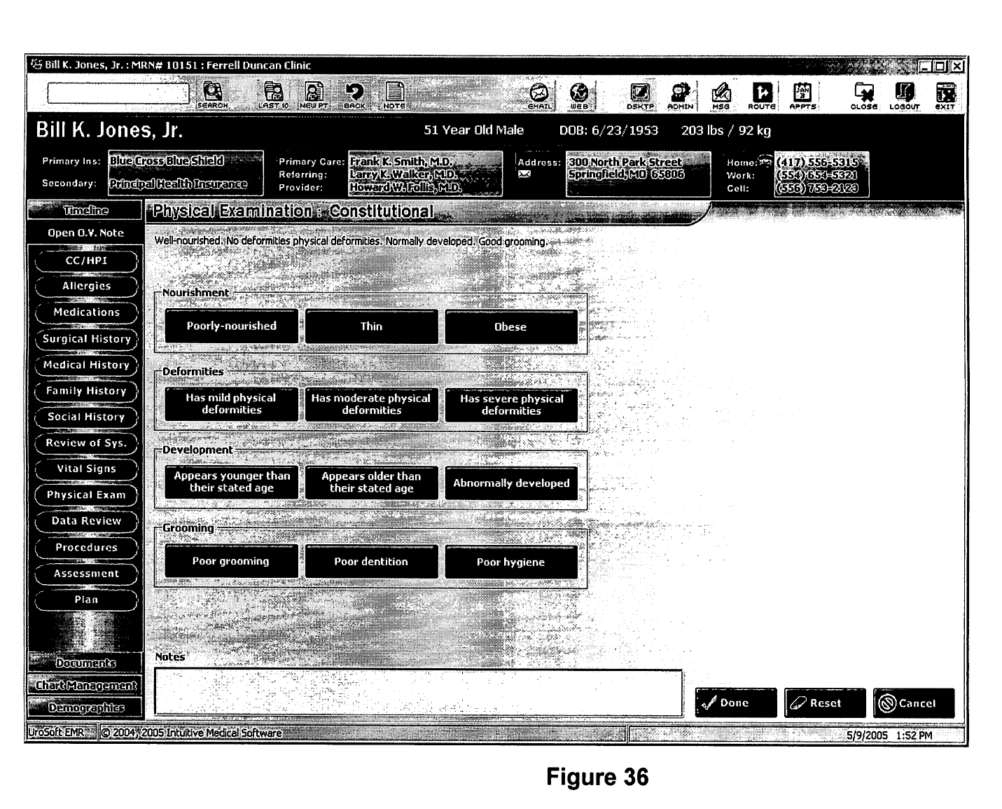

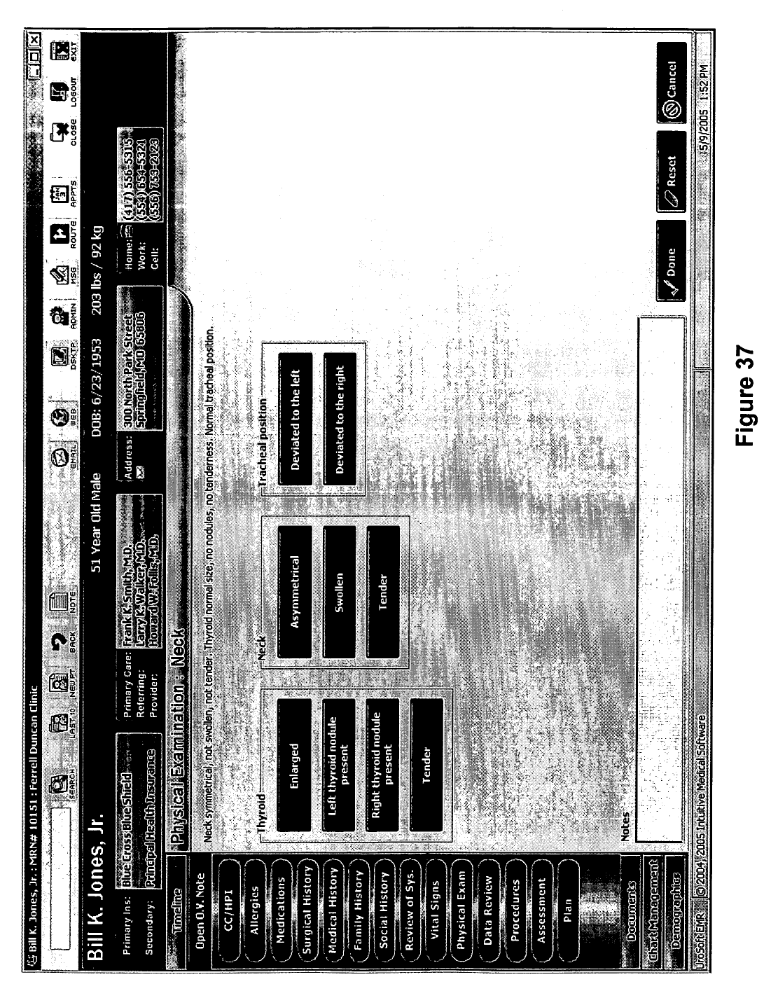

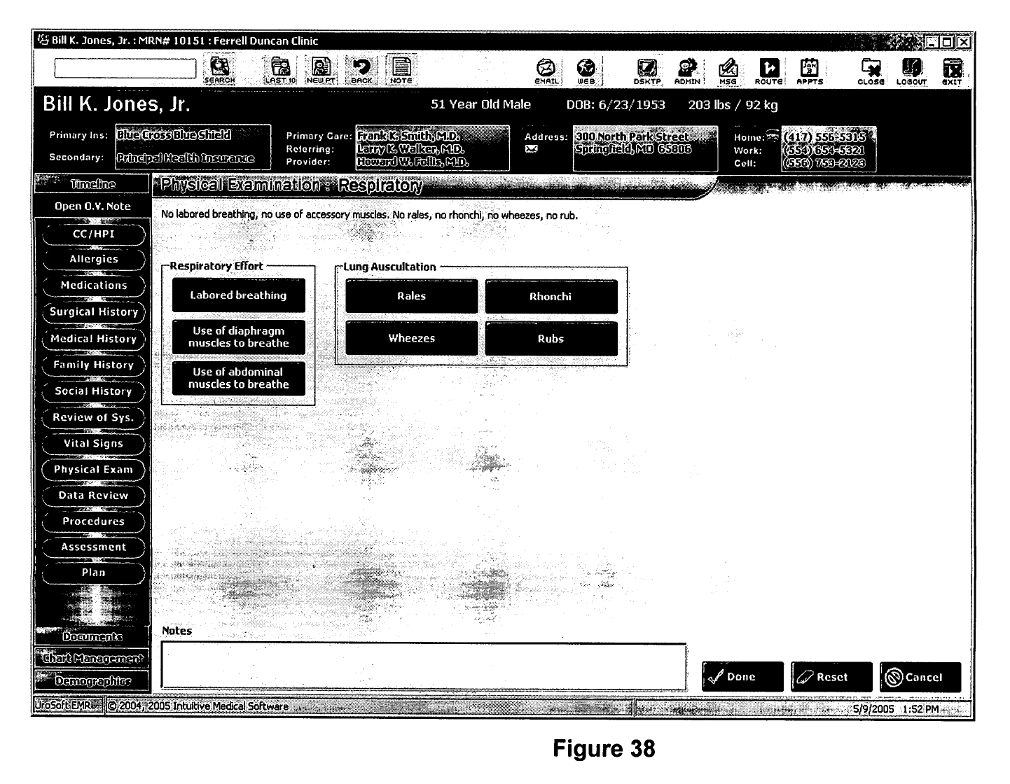

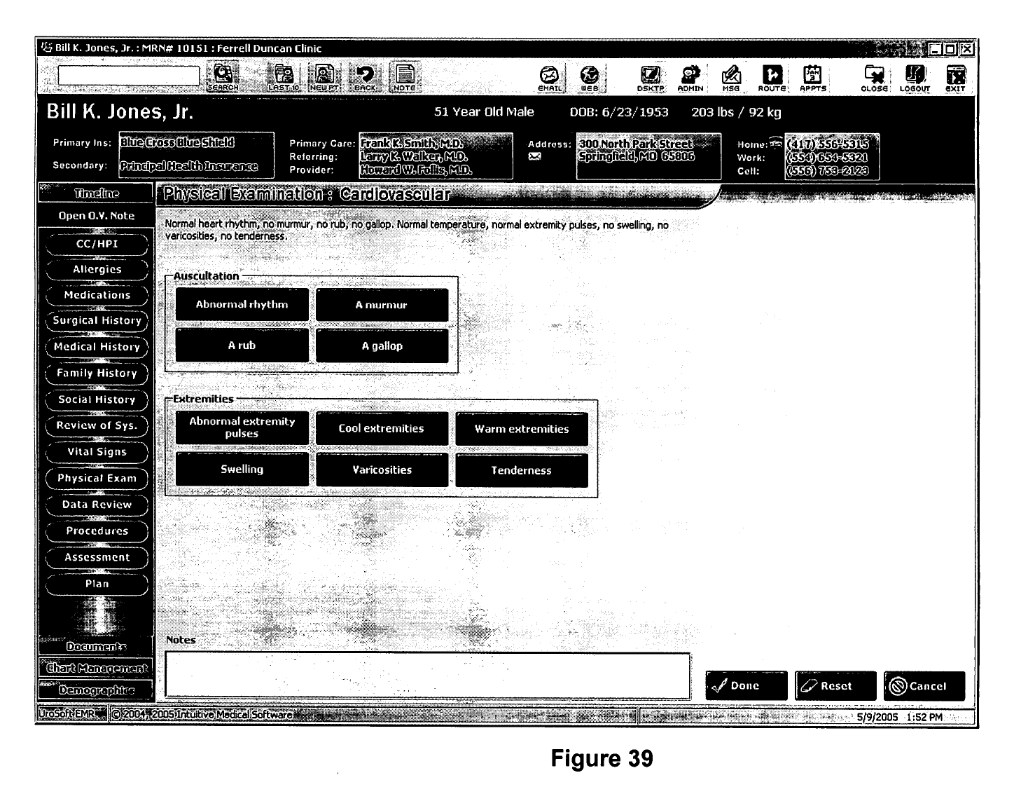

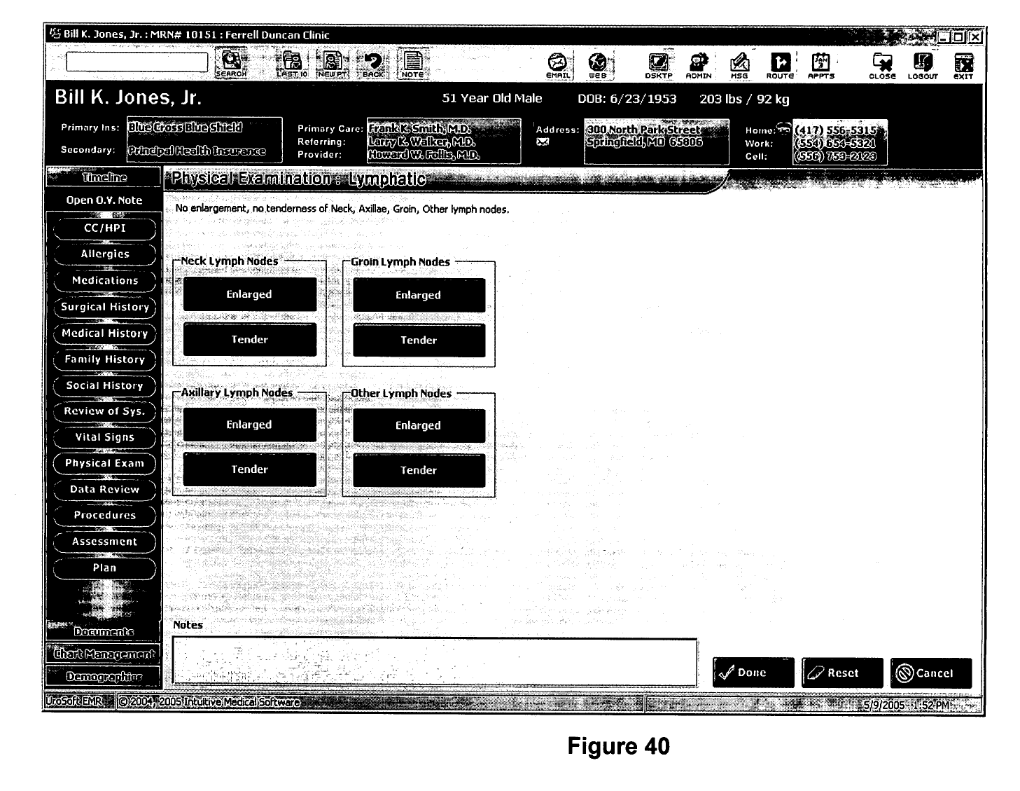

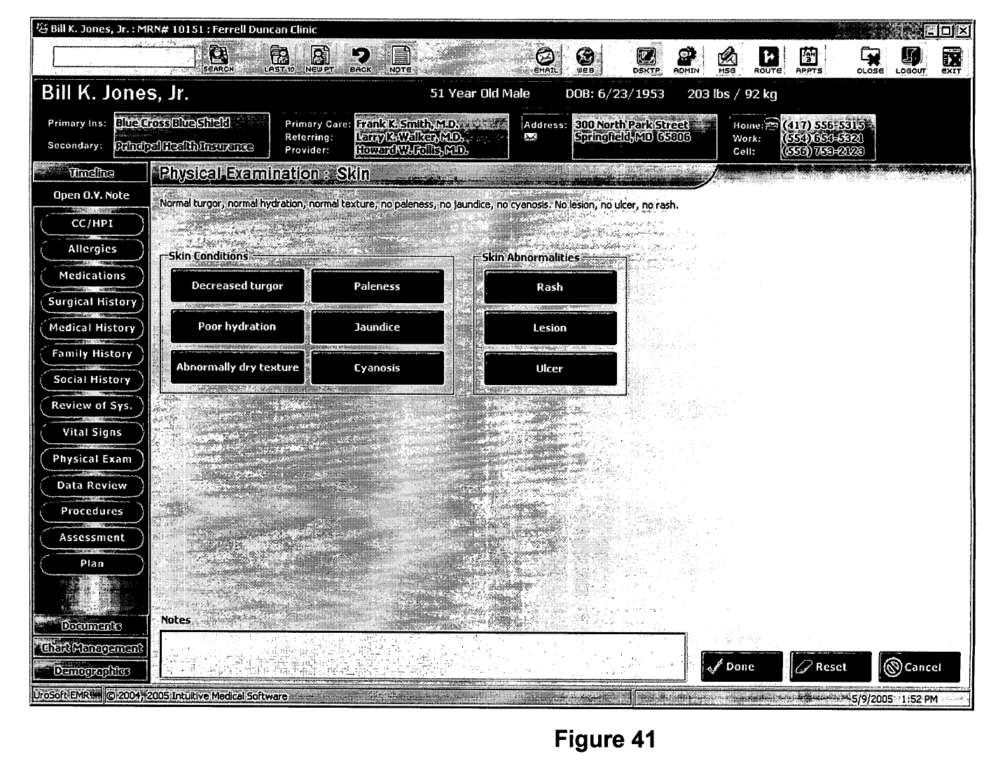

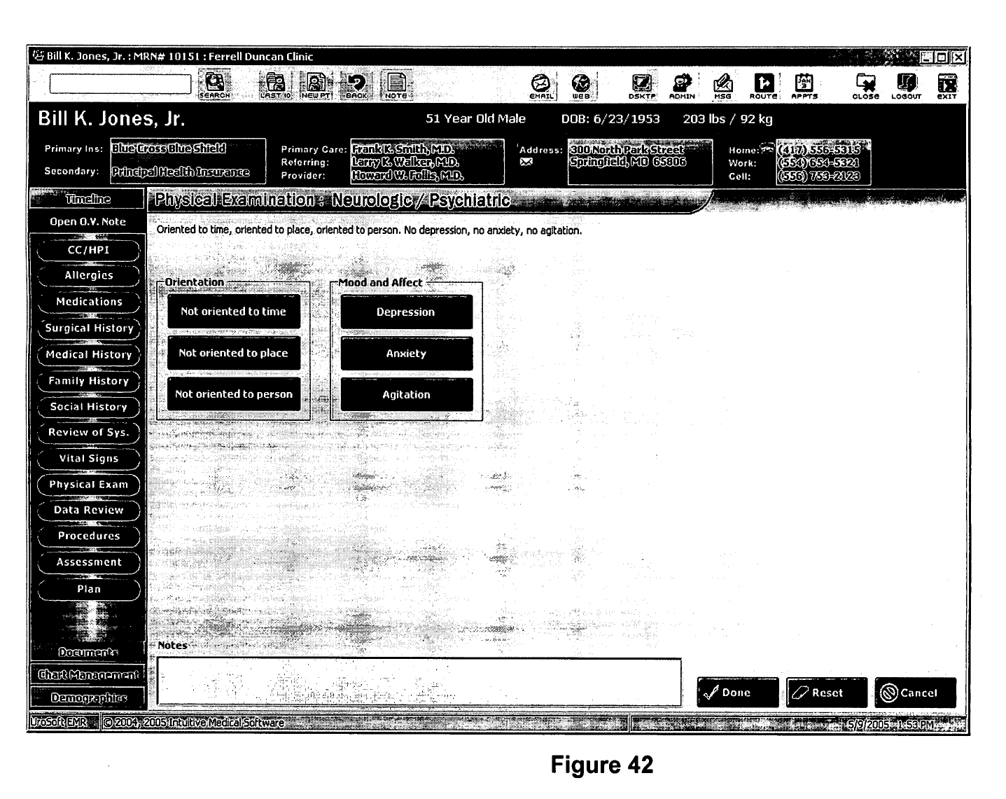

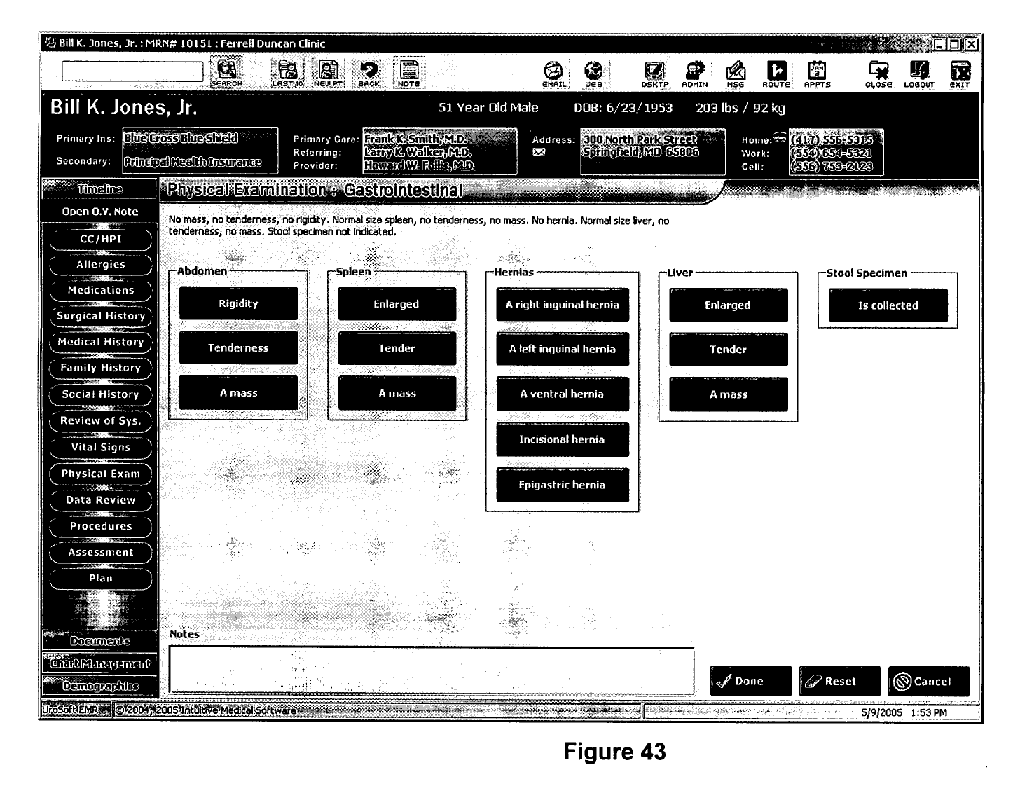

User selection of the Physical Exam button within the Open O.V. Note section is effective to display the user interface screens of FIGS. 35-54. The FIG. 35 screen is configured to interact with the user to obtain the user's observations about a review of various ones of the patient's systems, as defined by the active “Multi-System Physical Examination” folder tab. The screen of FIG. 35 is configured to present the user with a menu of selectable options for entering multi-system physical examination observations, broken down by the type or area of physical exam. Upon user selection of the “Constitutional” button shown in FIG. 35, the screen of FIG. 36 is called up, through which the user can enter pertinent constitutional physical exam observations. Upon user selection of the “Neck” button shown in FIG. 35, the screen of FIG. 37 is called up, through which the user can enter pertinent neck physical exam observations. Upon user selection of the “Respiratory” button shown in FIG. 35, the screen of FIG. 38 is called up, through which the user can enter pertinent respiratory physical exam observations. Upon user selection of the “Cardiovascular” button shown in FIG. 35, the screen of FIG. 39 is called up, through which the user can enter pertinent cardiovascular physical exam observations. Upon user selection of the “Lymphatic” button shown in FIG. 35, the screen of FIG. 40 is called up, through which the user can enter pertinent lymphatic physical exam observations. Upon user selection of the “Skin” button shown in FIG. 35, the screen of FIG. 41 is called up, through which the user can enter pertinent skin physical exam observations. Upon user selection of the “Neurologic/Psychiatric” button shown in FIG. 35, the screen of FIG. 42 is called up, through which the user can enter pertinent neurologic/psychiatric physical exam observations. Upon user selection of the “Gastrointestinal” button shown in FIG. 35, the screen of FIG. 43 is called up, through which the user can enter pertinent gastrointestinal physical exam observations.

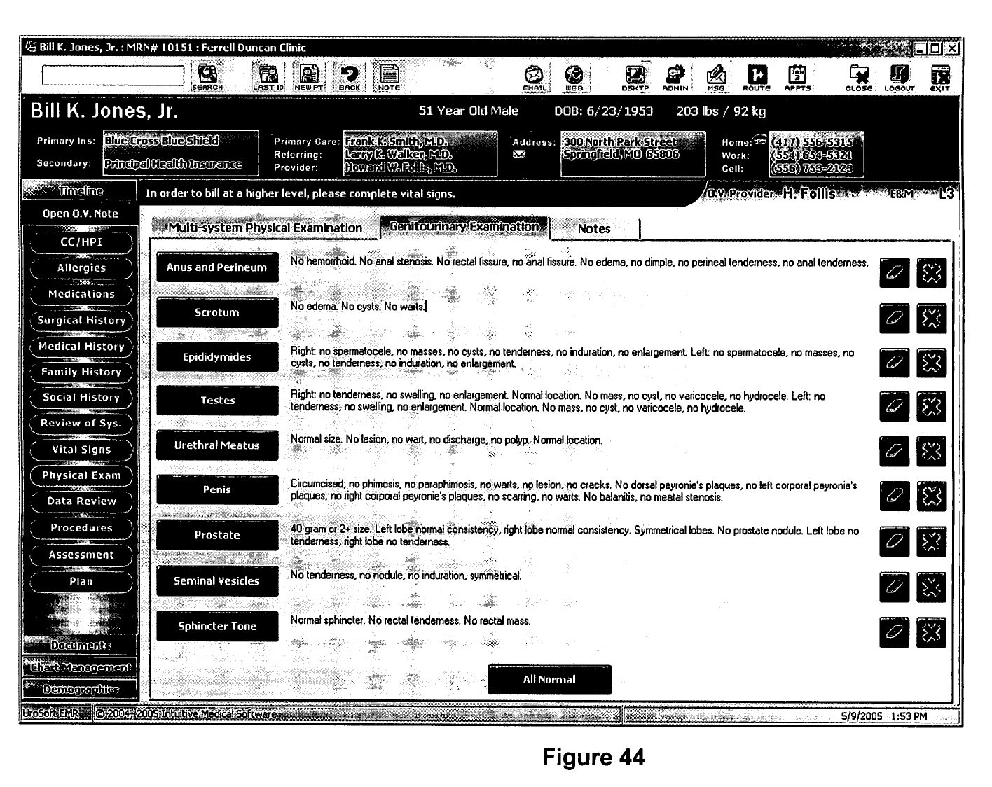

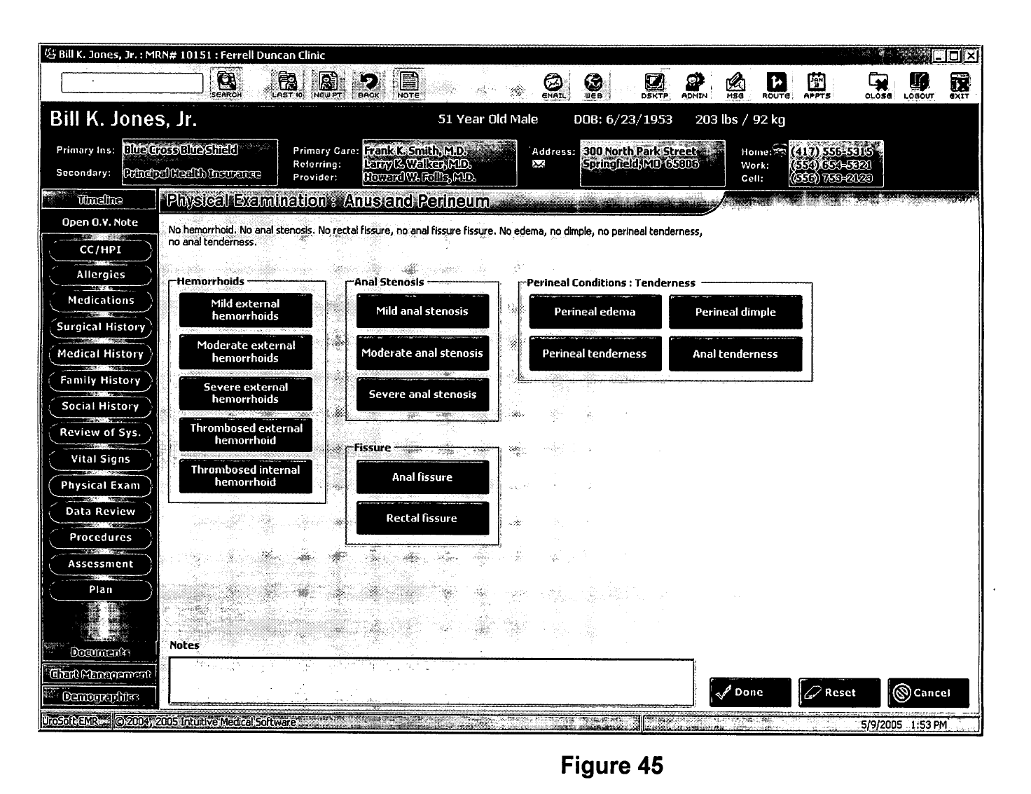

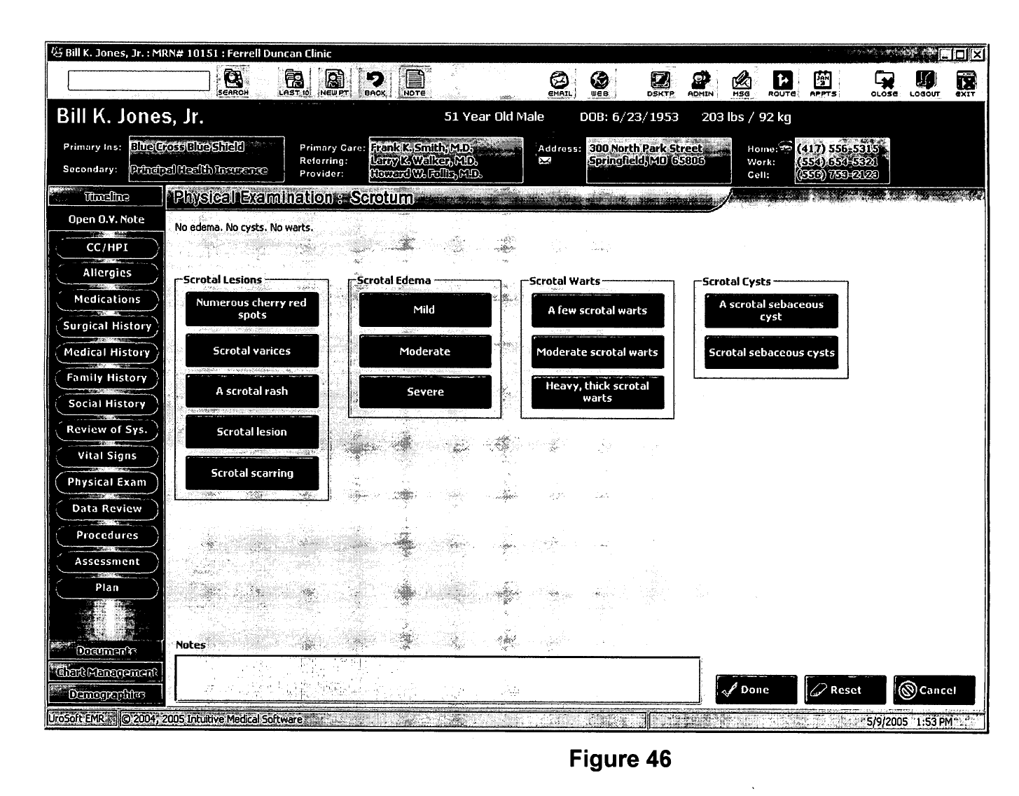

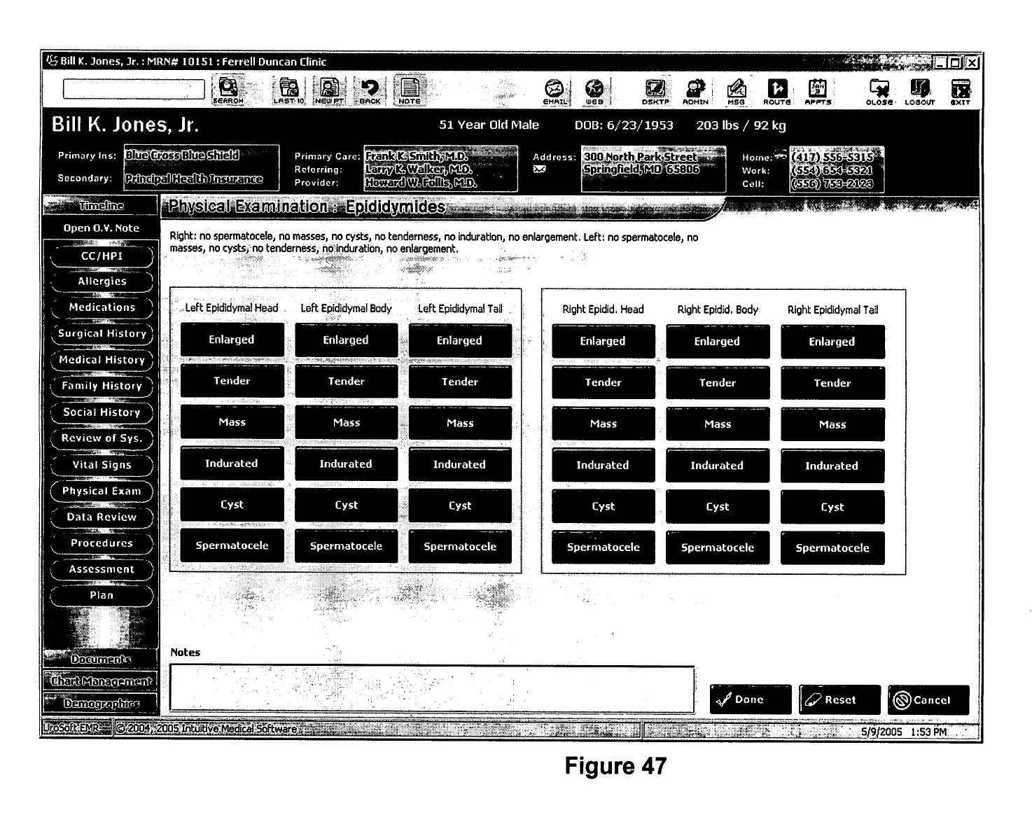

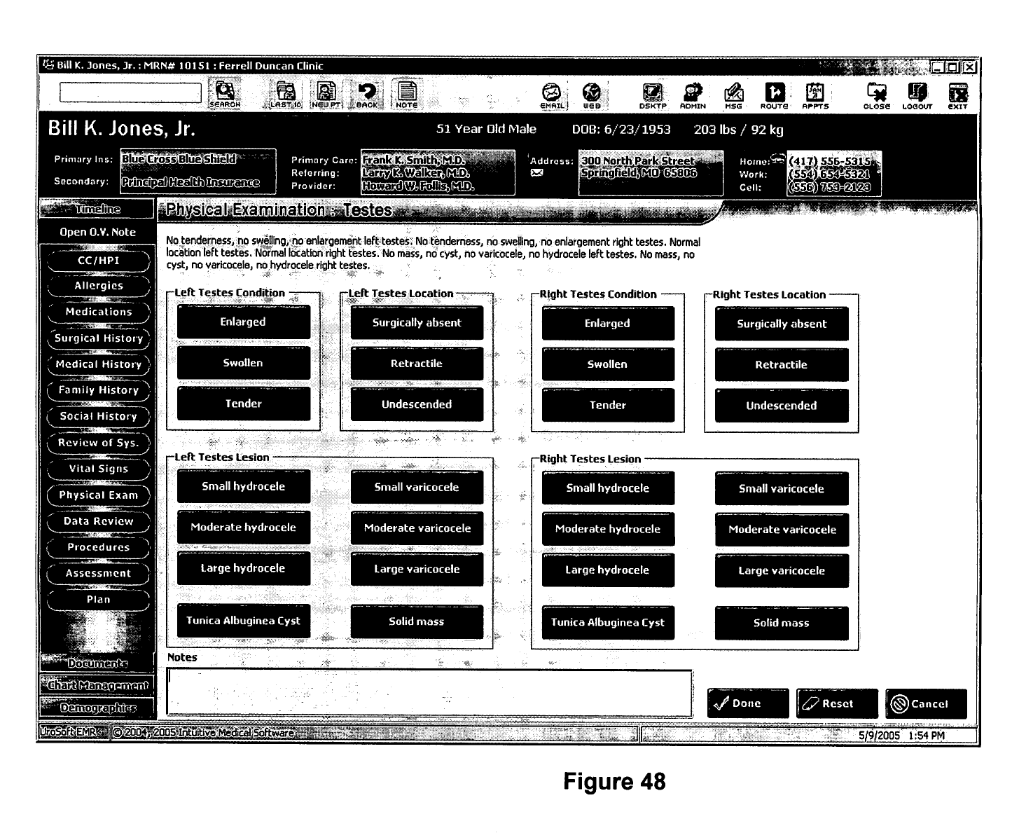

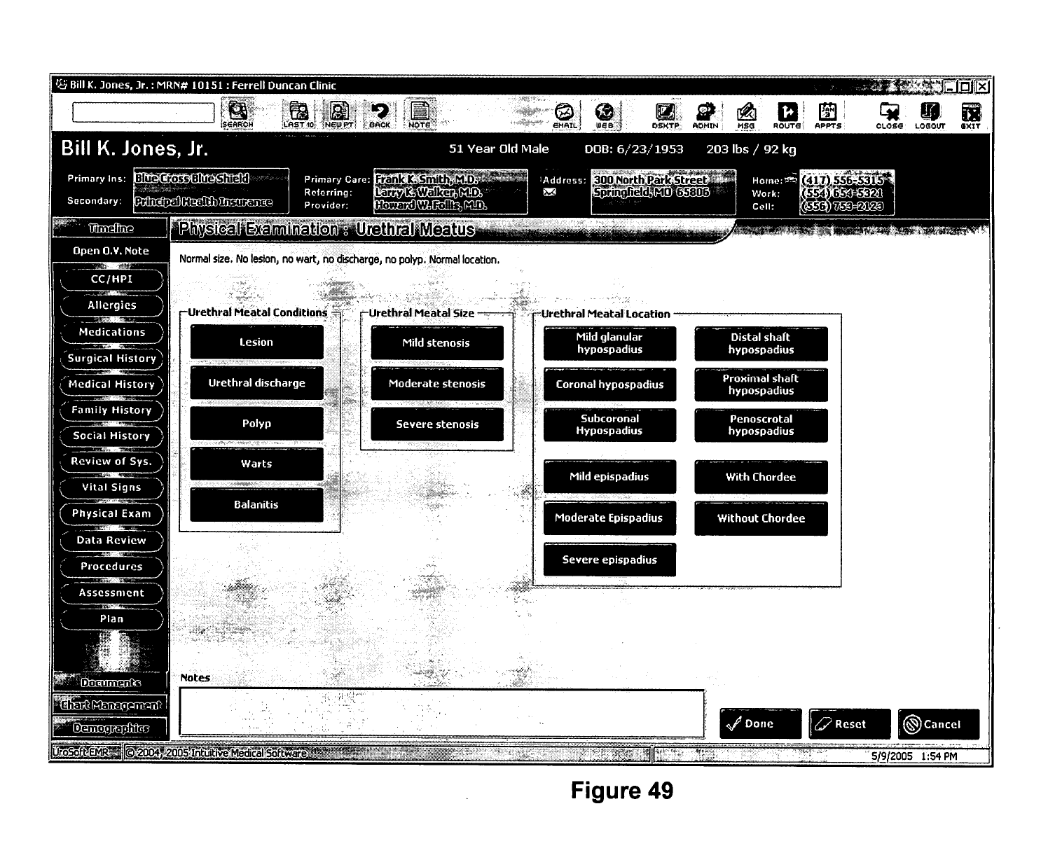

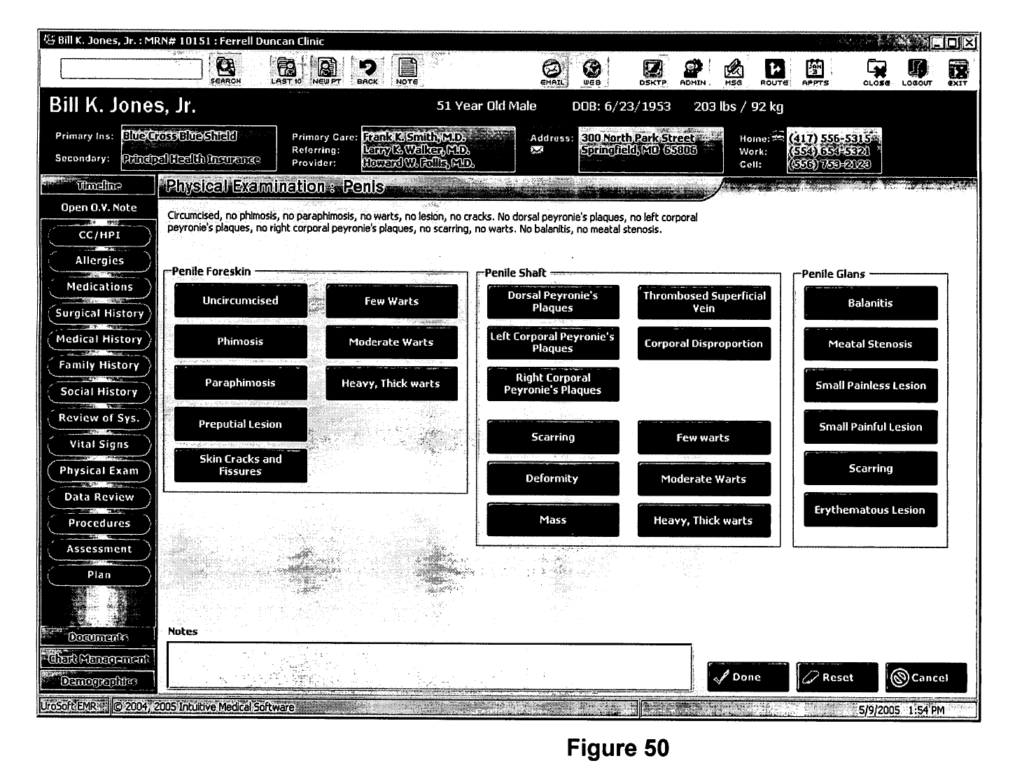

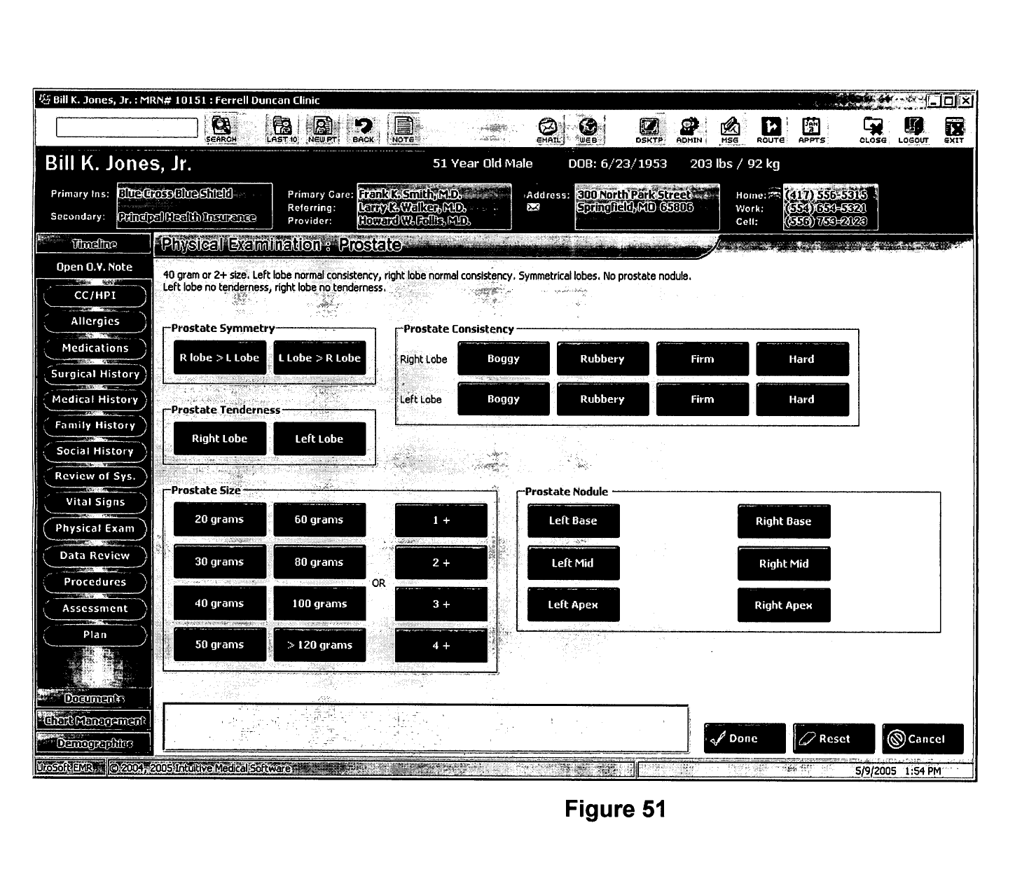

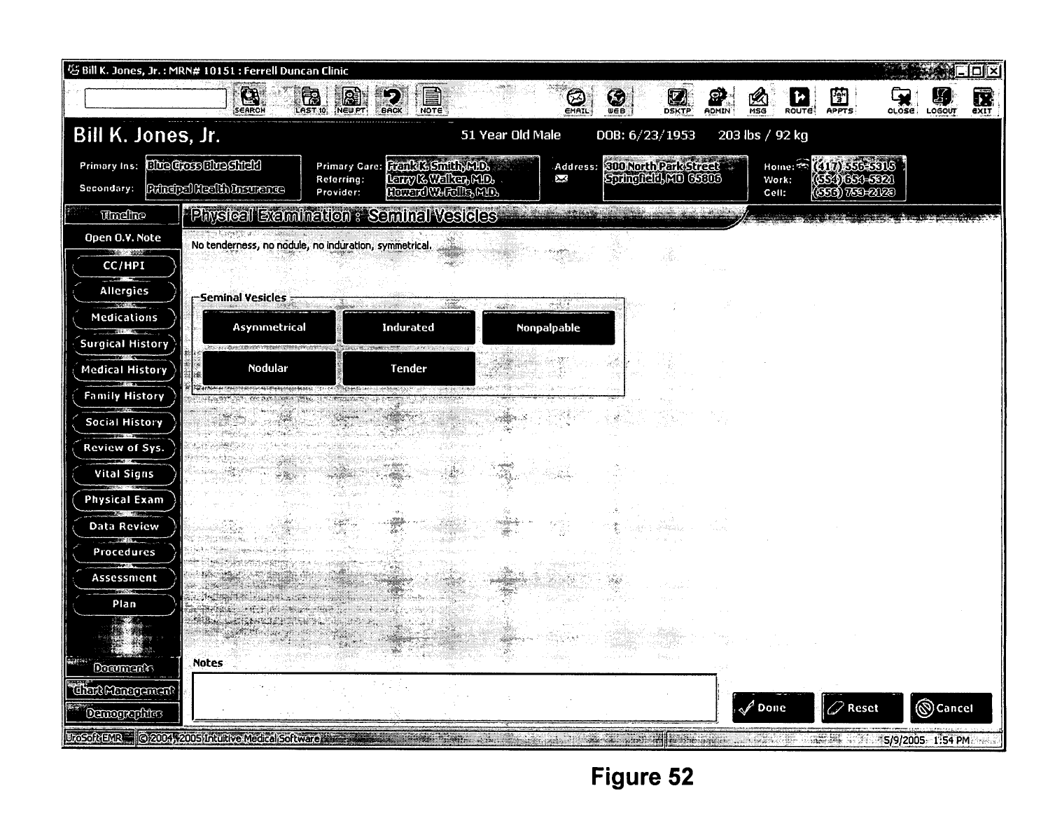

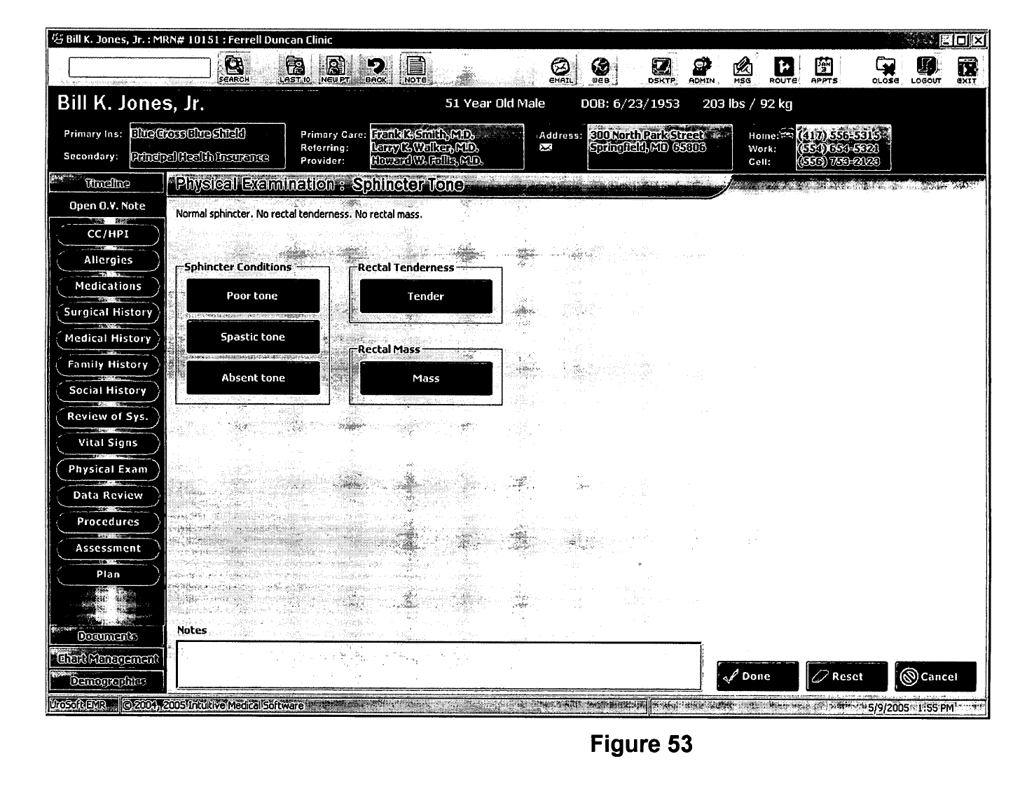

The FIG. 44 screen is configured to interact with the user to obtain the user's observations about a genitourinary examination conducted on the patient, as defined by the active “Genitourinary Examination” folder tab. The screen of FIG. 44 is configured to present the user with a menu of selectable options for entering genitourinary examination observations, broken down by the type or area of exam. Upon user selection of the “Anus and Perineum” button shown in FIG. 44, the screen of FIG. 45 is called up, through which the user can enter pertinent anus/perineum exam observations. Upon user selection of the “Scrotum” button shown in FIG. 44, the screen of FIG. 46 is called up, through which the user can enter pertinent scrotum exam observations. Upon user selection of the “Epididymides” button shown in FIG. 44, the screen of FIG. 47 is called up, through which the user can enter pertinent epididymides exam observations. Upon user selection of the “Testes” button shown in FIG. 44, the screen of FIG. 48 is called up, through which the user can enter pertinent testes exam observations. Upon user selection of the “Urethral Meatus” button shown in FIG. 44, the screen of FIG. 49 is called up, through which the user can enter pertinent urethral meatus exam observations. Upon user selection of the “Penis” button shown in FIG. 44, the screen of FIG. 50 is called up, through which the user can enter pertinent penis exam observations. Upon user selection of the “Prostate” button shown in FIG. 44, the screen of FIG. 51 is called up, through which the user can enter pertinent prostate exam observations. Upon user selection of the “Seminal Vesicles” button shown in FIG. 44, the screen of FIG. 52 is called up, through which the user can enter pertinent seminal vesicles exam observations. Upon user selection of the “Sphincter Tone” button shown in FIG. 44, the screen of FIG. 53 is called up, through which the user can enter pertinent sphincter tone exam observations.

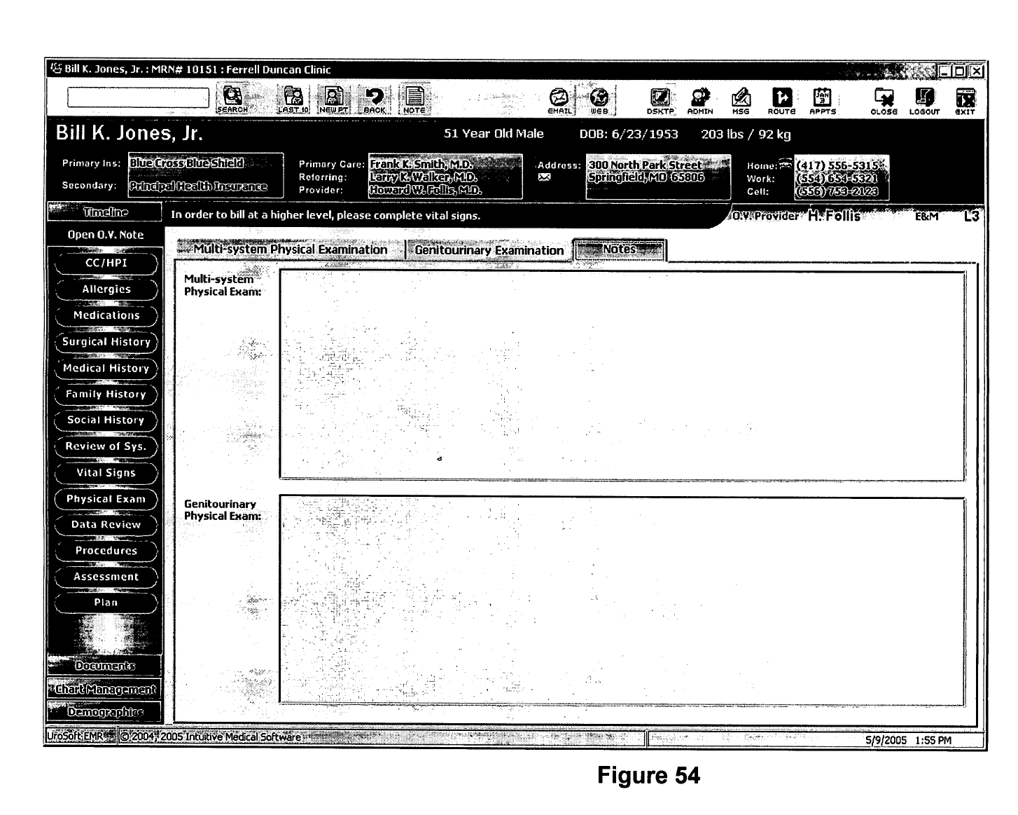

The FIG. 54 screen allows the user to enter notes (as defined by the active “Notes” folder tab) about either or both of a multi-system physical exam and a genitourinary physical exam conducted on the patient.

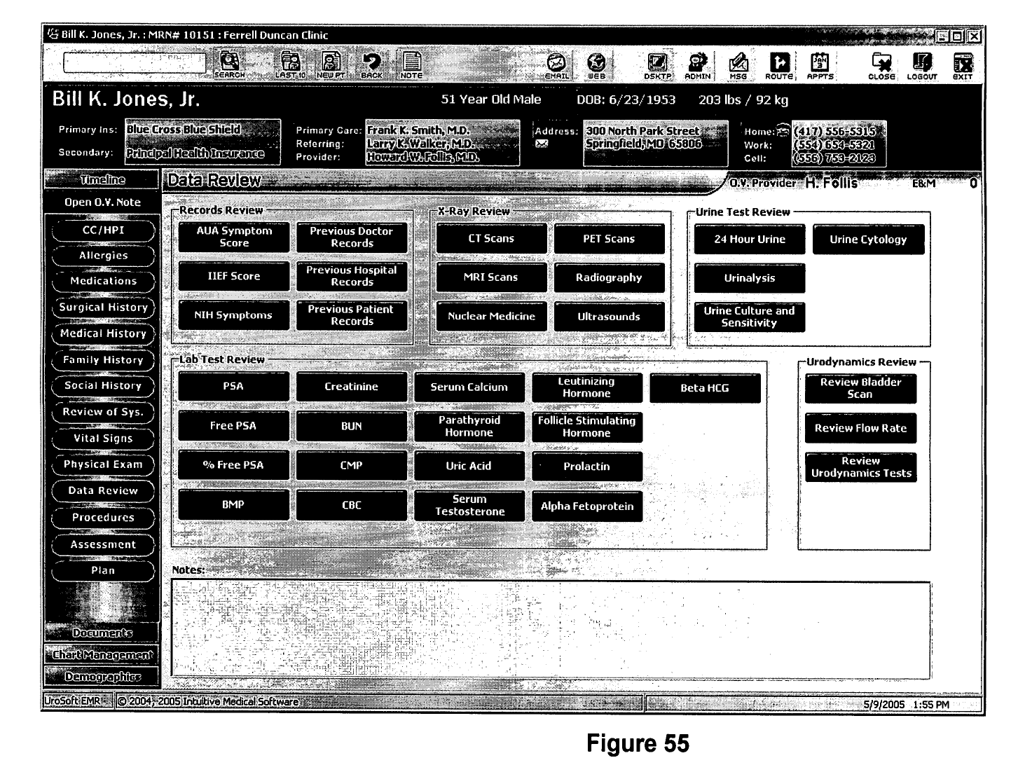

User selection of the Data Review button within the Open O.V. Note section is effective to display the user interface screen of FIG. 55. The FIG. 55 screen is configured to interact with the user to record and document patient medical data that is reviewed by the physician during the course of an OV. This data review information represents work done by the physician which should be documented in the OV note in order for that physician to receive reimbursement for his/her services.

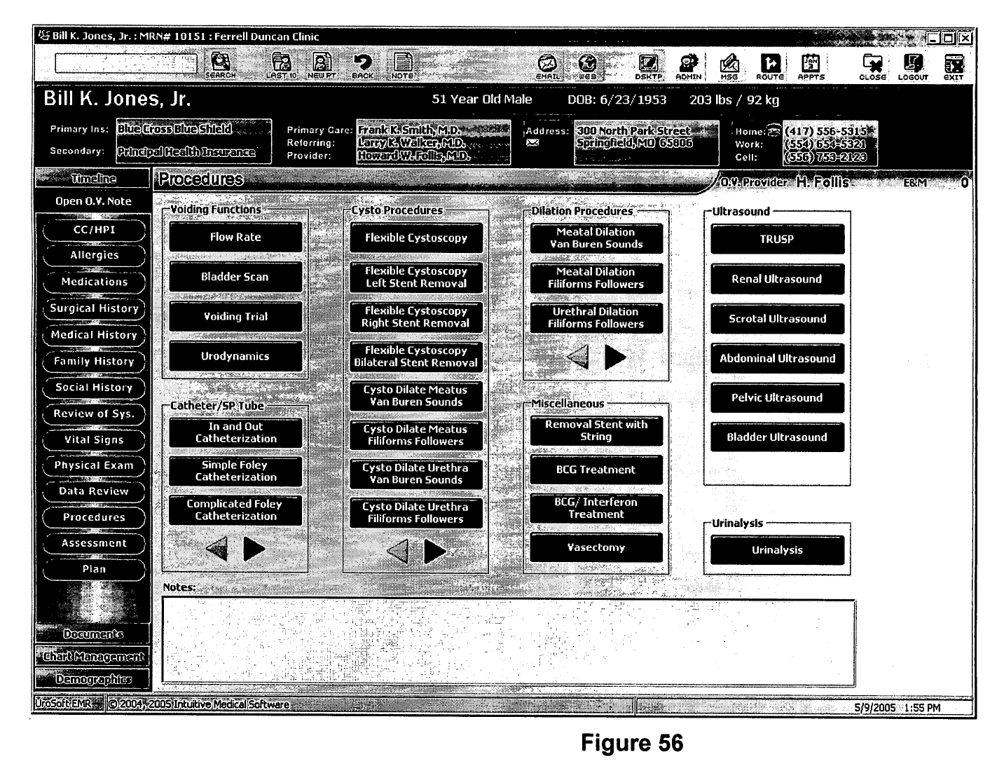

User selection of the Procedures button within the Open O.V. Note section is effective to display the user interface screen of FIG. 56. The FIG. 56 screen is configured to interact with the user to record and document office procedures that are performed on the patient in the normal course of medical practice.

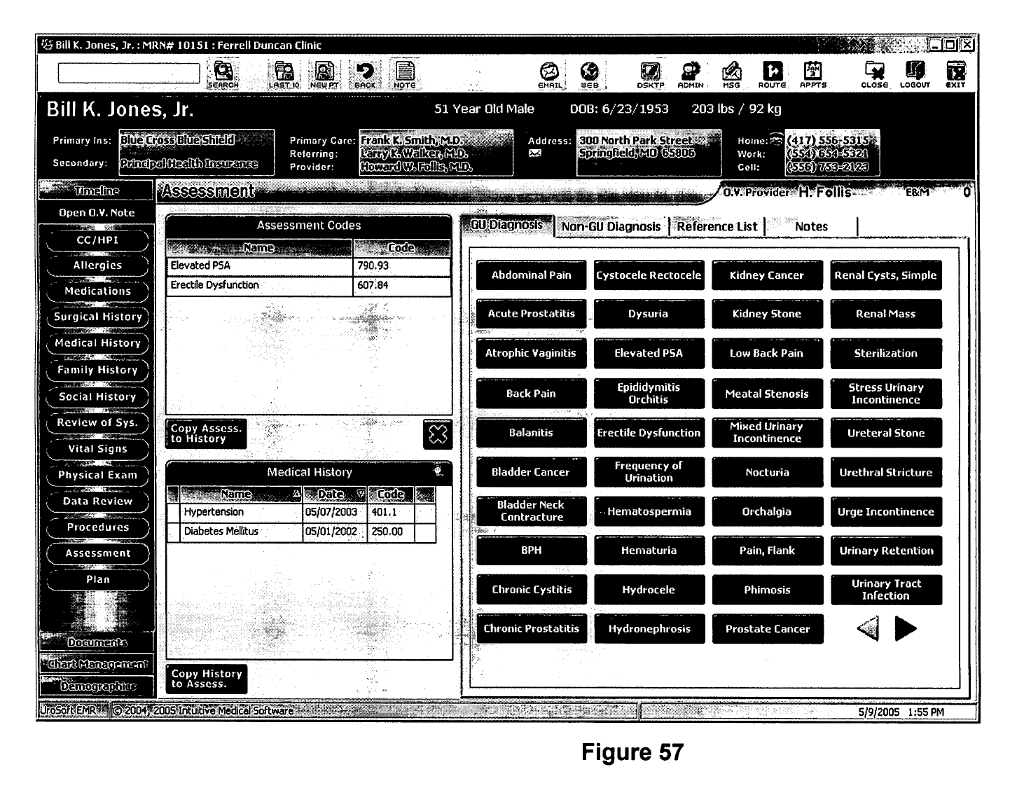

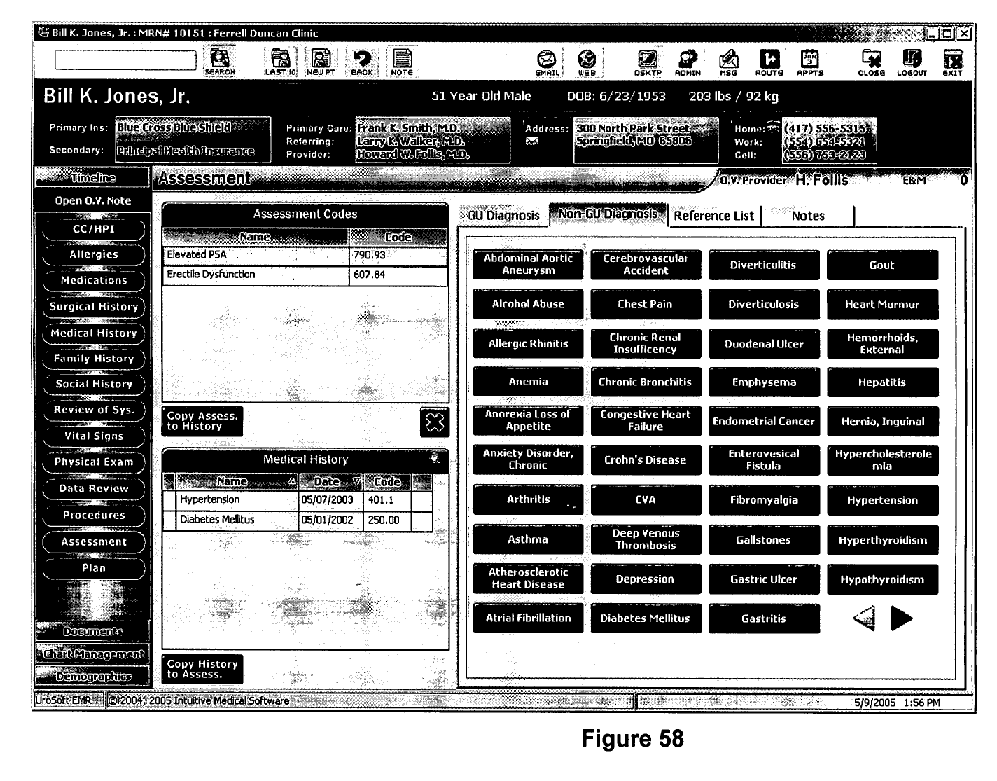

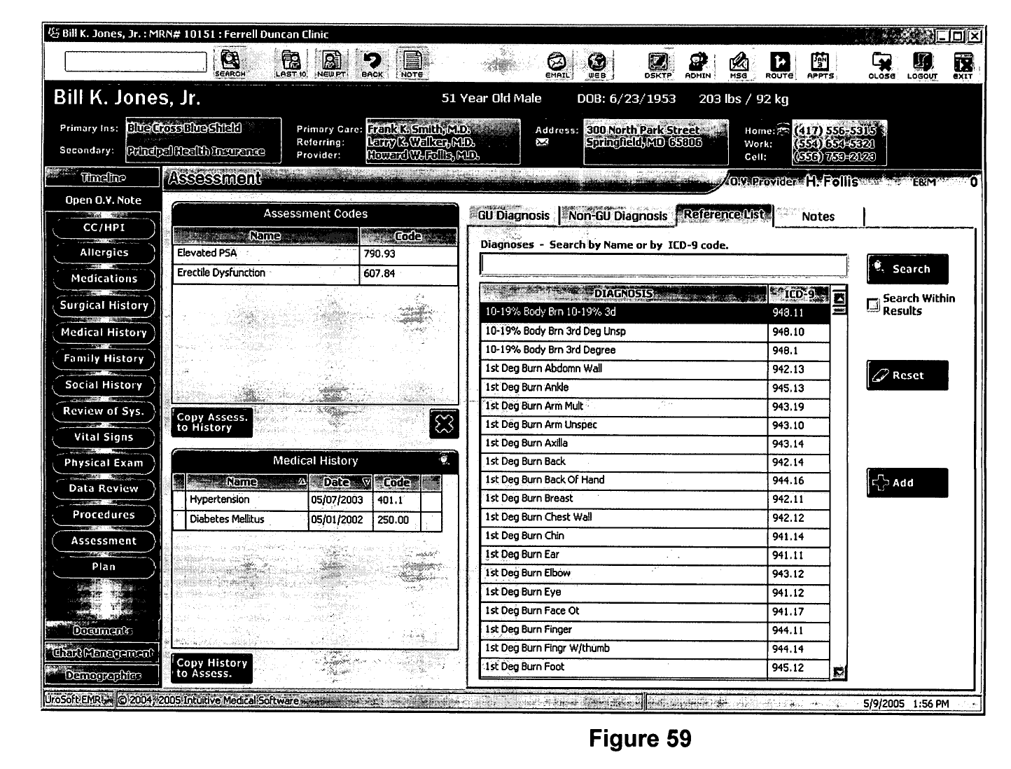

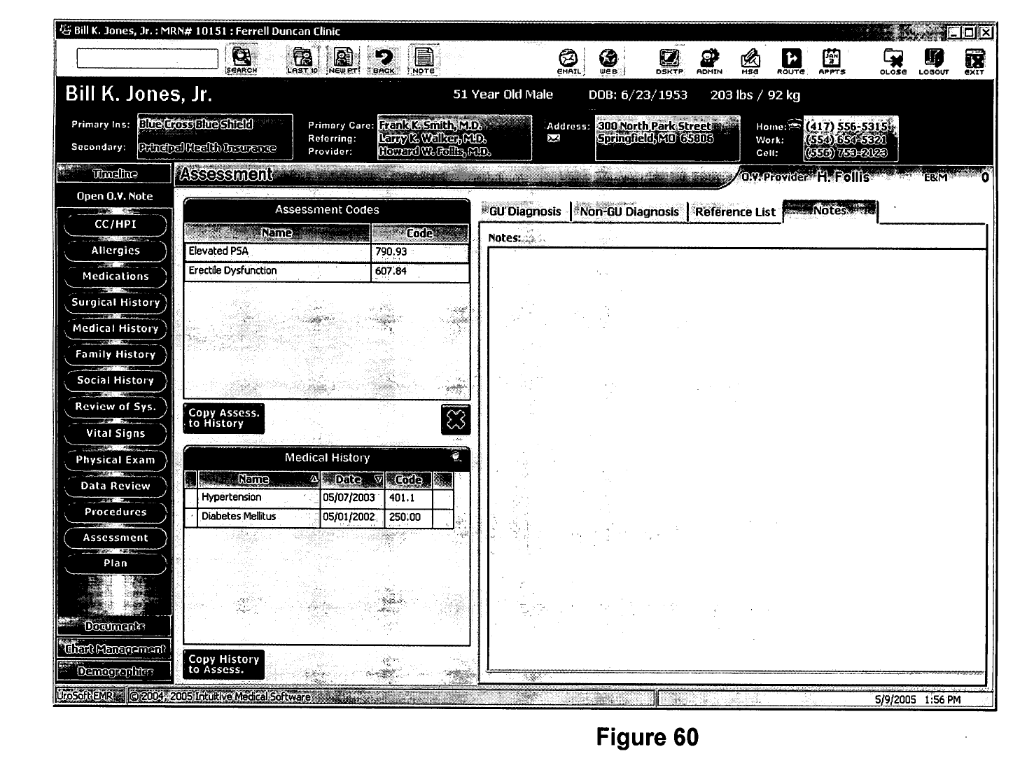

User selection of the Assessment button within the Open O.V. Note section is effective to display the user interface screens of FIGS. 57-60. The FIG. 57 screen, which is displayed if the “GU Diagnosis” tab is active, is configured to interact with the user to obtain assessments and associated ICD-9 assessment codes for GU patient diagnoses. The FIG. 58 screen, which is displayed if the “Non-GU Diagnosis” tab is active, is configured to interact with the user to obtain assessments and associated ICD-9 assessment codes for non-GU patient diagnoses. The FIG. 59 screen, which is displayed if the “Reference List” tab is active, is configured to interact with the user to obtain assessments and associated ICD-9 assessment codes from a reference list of possible ICD-9 codes. The FIG. 60 screen, which is displayed if the “Notes” tab is active, is configured to allow the user to enter notes about the user's assessments. The screens of FIGS. 57-60 are similar in nature to the screens of FIGS. 20-23. Included within the screens of FIGS. 57-60 are tables that (1) identify the selected assessments for the patient (and the ICD-9 assessment codes associated therewith), and (2) summarize the patient's medical history, including the diagnosed medical condition, the date of the diagnosis, and the assessment code associated therewith.

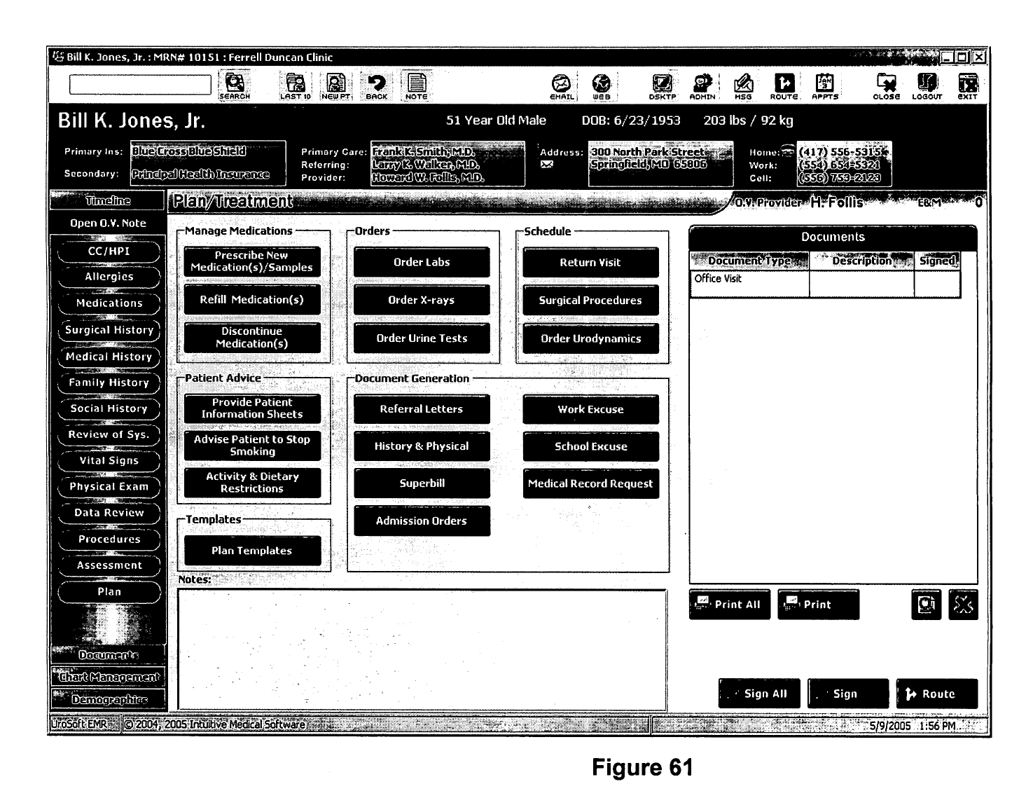

User selection of the Plan button within the Open O.V. Note section is effective to display the user interface screen of FIG. 61. The FIG. 61 screen is configured to interact with the user to obtain input from the user about actions to be taken in connection with the patient's medications, labs/imaging/tests to be run on the patient, scheduling future visits by the patient, advice given to the patient, documents to be generated in response to the patient visits, and the like.

While the exemplary screens of FIGS. 27-61 illustrate how OV data can be added to the patient's EMR, it should be noted that different screens can also be used to obtain such data. Furthermore, additional screens could be used to probe for more detailed information about the patient's OV. The exact details of such interface screens can be chosen by a practitioner of the present invention based on the needs and wants of a particular medical practice, as would be understood by those having ordinary skill in the art.

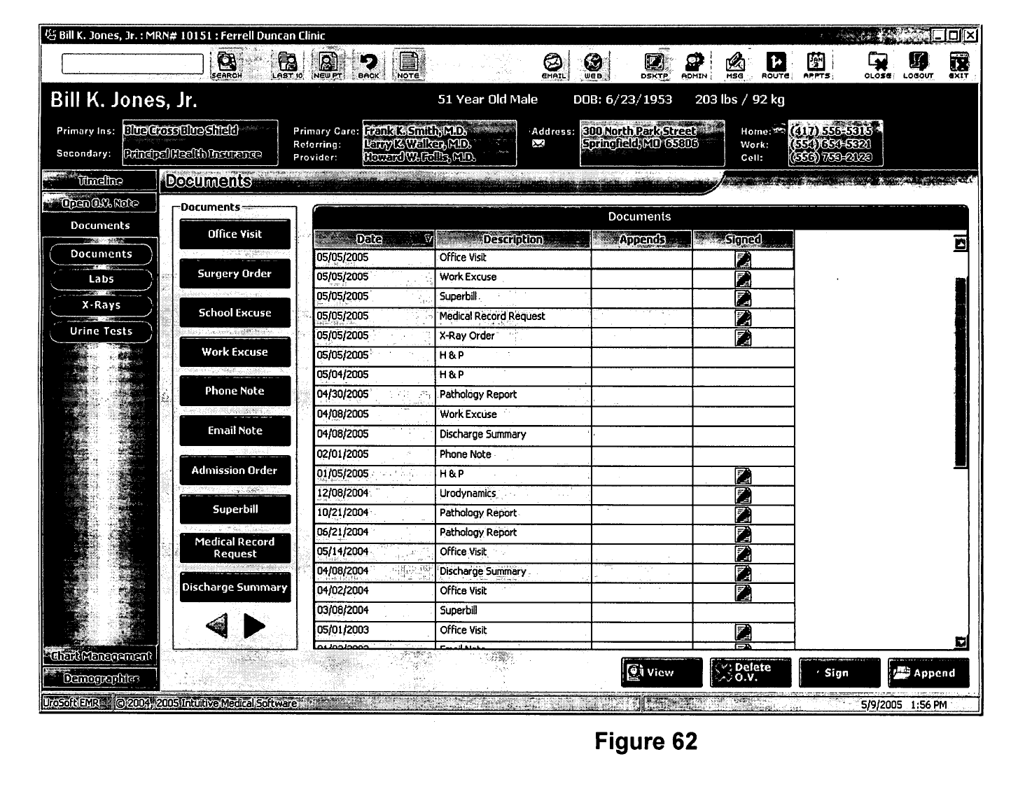

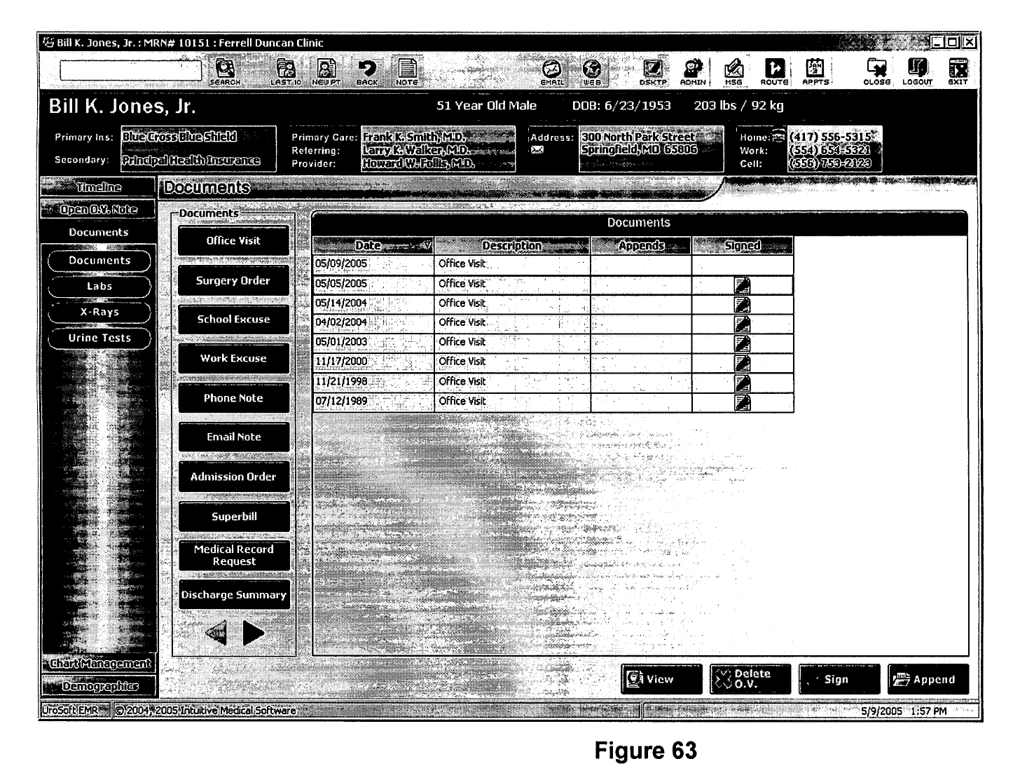

It is desirable to also provide users with the ability view the patient's EMR documents in a non-timeline manner. To do so, the user can select the “Documents” button 276 shown in FIG. 2. FIG. 62 depicts an exemplary user interface screen that lists, in a table, all of the documents in a patient's EMR that would normally be displayed in the document section 274 of the timeline 210. Each document listed in the table is preferably user-selectable to cause that document to be displayed. Via user selection the buttons to the left of the table (the “Office Visit” button, the “Surgery Order” button, and so on down to the “Discharge Summary” button), the user can restrict the table of FIG. 62 to list only the documents corresponding to the type of document identified on the selected button. For example, FIG. 63 depicts the table after the selection of the “Office Visit” button. To view documents related to labs, the user can select the “lab” button on the left hand side of FIGS. 62-66.

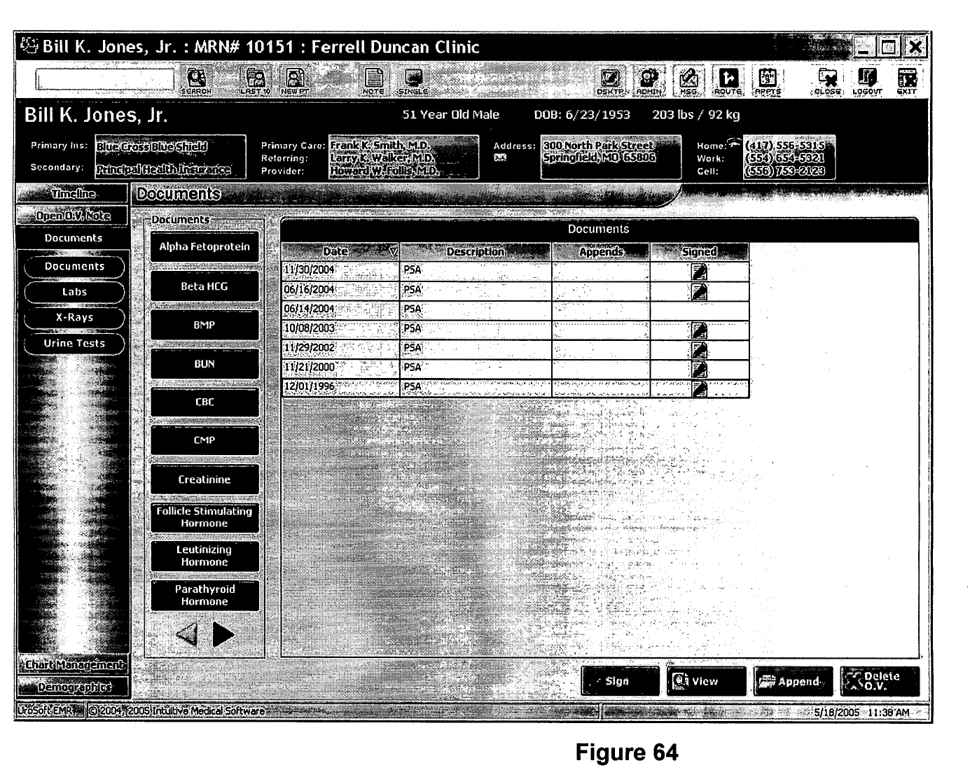

FIG. 64 depicts an exemplary user interface screen that lists, in a table, all of the documents in a patient's EMR that would normally be displayed in the PSA/labs section 280 of the timeline 210 when the labs tab is active. User selection of a document listed in the table is preferably effective to cause that document to be displayed. Via user selection the buttons to the left of the table (the “Alpha Fetoprotein” button, the “Beta HCG” button, and so on down to the “Parathyroid Hormone” button), the user can restrict the table of FIG. 64 to list only the documents corresponding to the type of lab test identified on the selected button.

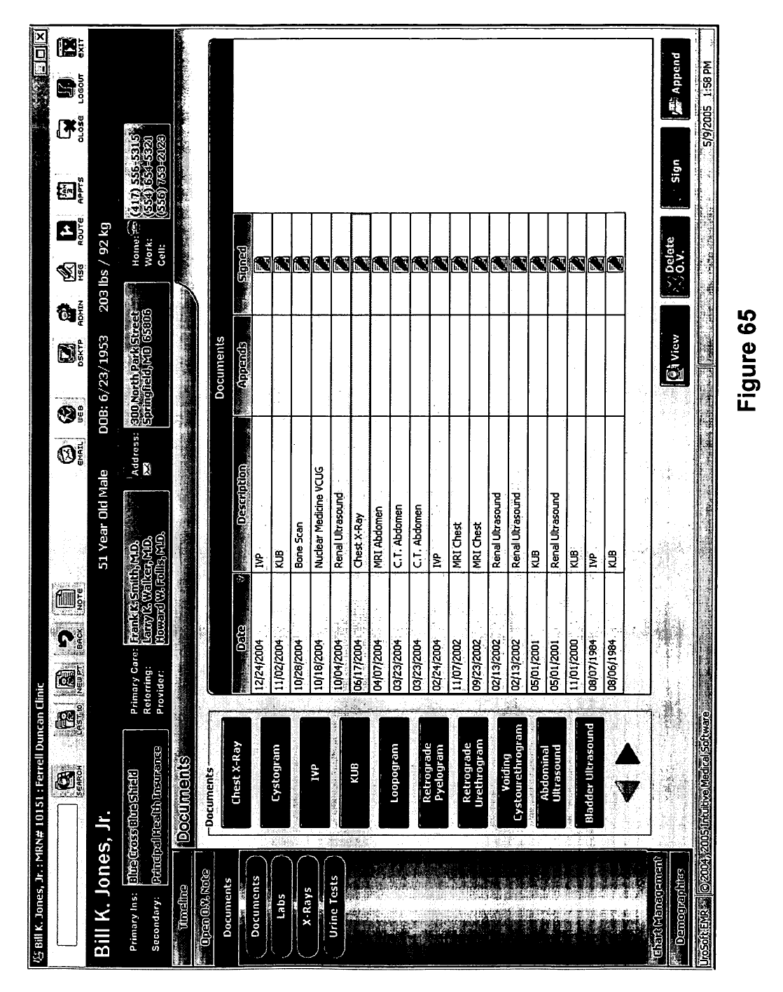

FIG. 65 depicts an exemplary user interface screen that lists, in a table, all of the documents in a patient's EMR that would normally be displayed in the medical imaging section 278 of the timeline 210. User selection of a document listed in the table is preferably effective to cause that document to be displayed. Furthermore, via user selection of the buttons to the left of the table (the “Chest X-Ray” button, the “Cystogram” button, and so on down to the “Bladder Ultrasound” button), the user can restrict the table of FIG. 65 to list only the documents corresponding to the type of document identified on the selected button.

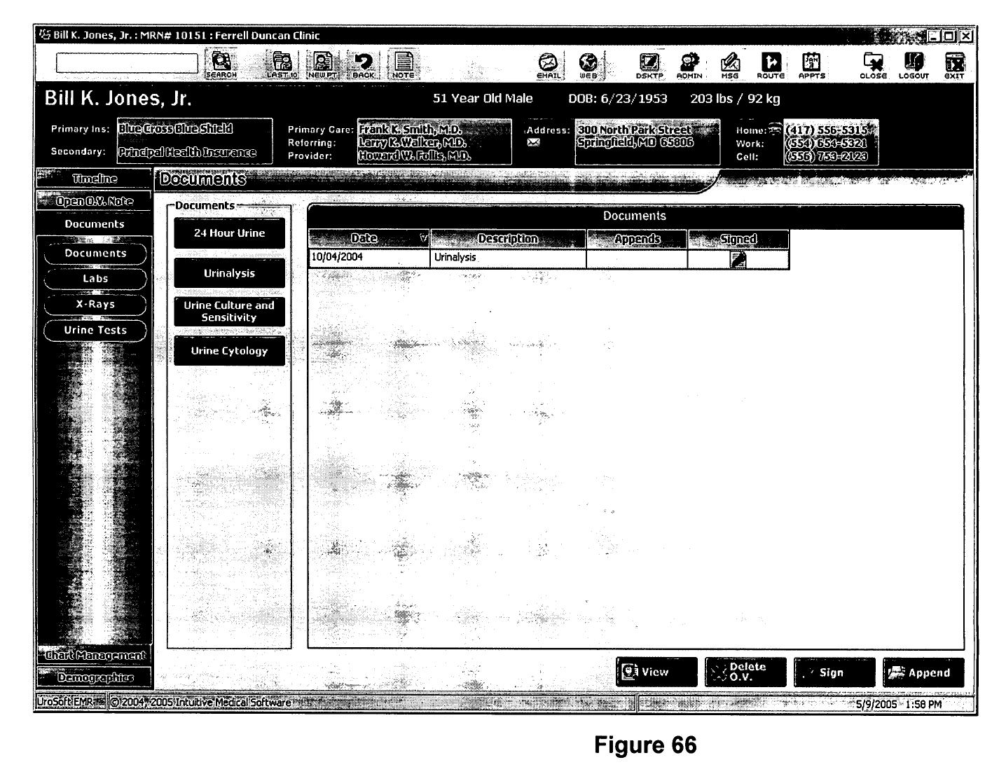

FIG. 66 depicts an exemplary user interface screen that lists, in a table, all of the documents in a patient's EMR that correspond to urine tests for the patient. User selection of a document listed in the table is preferably effective to cause that document to be displayed. Furthermore, via user selection of the buttons to the left of the table (the “24 Hour Urine” button, and so on down to the “Urine Cytology” button), the user can restrict the table of FIG. 66 to list only the documents corresponding to the type of document identified on the selected button.

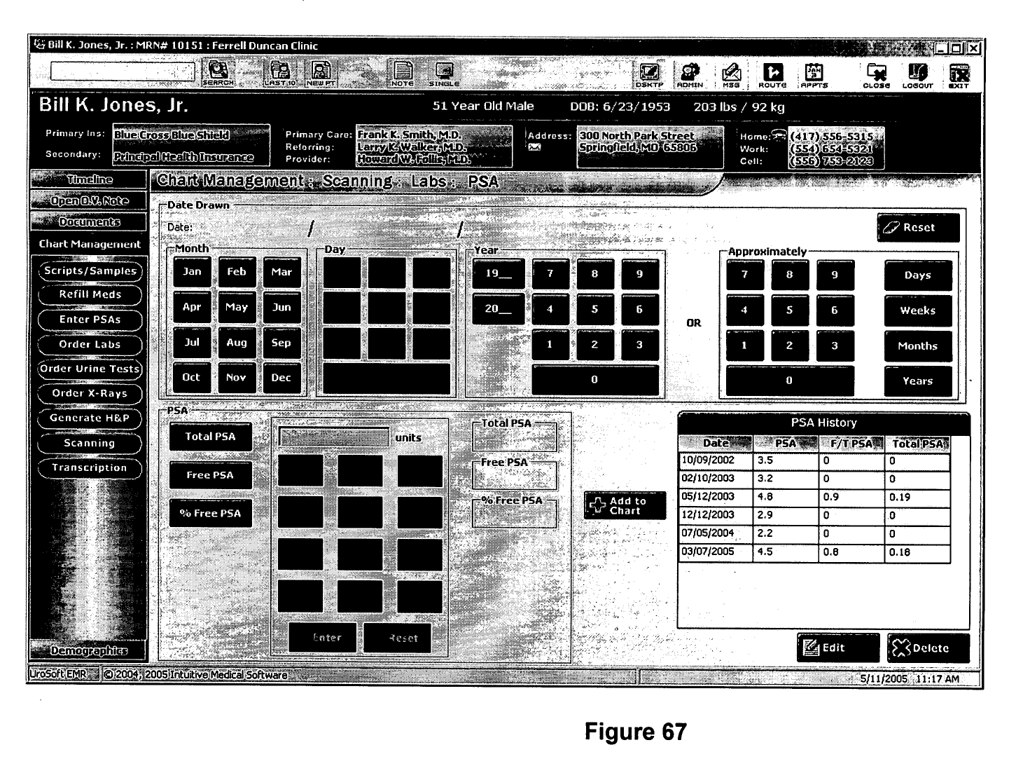

User selection of the “Chart Management” button 278 shown in FIG. 2 allows the user to manage the patient's chart, which preferably includes tasks such as entering discrete patient data, scanning documents into the patient's EMR, generating lab or imaging orders, etc. FIGS. 67-76 illustrate exemplary user interface screens for chart management in connection with a patient's EMR, which can be displayed following user selection of button 278. To manage the patient's chart in connection with writing prescriptions for the patient or refilling the patient's prescription, the user can select the “Scripts/Samples” and “Refill Meds” buttons shown on the left side of FIGS. 67-76. User selection of the “Scripts/Samples” and “Refill Meds” buttons is effective to display the user interface screens of FIGS. 14 and 15, respectively.

If the user wishes to add PSA results to the patient's EMR, the user can select the “Enter PSAs” button to call up the user interface screen of FIG. 67. From the screen shown in FIG. 67, the user can enter pertinent data about a patient's PSA results, including the applicable date (exact or approximate), and the PSA results data in any of a plurality of conventionally-used PSA formats. FIG. 67 may also include a data table that describes the patient's PSA history.

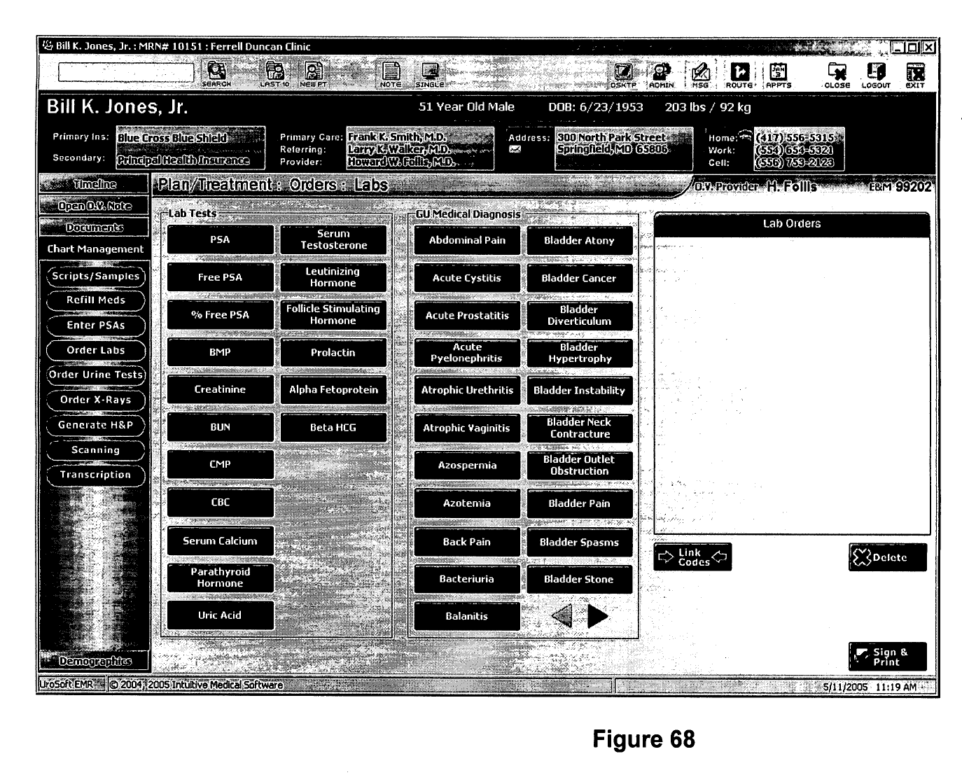

If the user wishes to order any lab tests for a diagnosed GU condition, the user can select the “Order Labs” button to call up the user interface screen of FIG. 68. From the screen shown in FIG. 68, the user can identify the lab test to be ordered and the GU medical diagnosis associated therewith. Upon user selection of the appropriate type of lab test and GU medical diagnosis, the “Sign and Print” button can be selected to generate a print out of a fax for transmission to the appropriate laboratory to order the test. It should be noted that an electronic message requesting the lab can also be created.

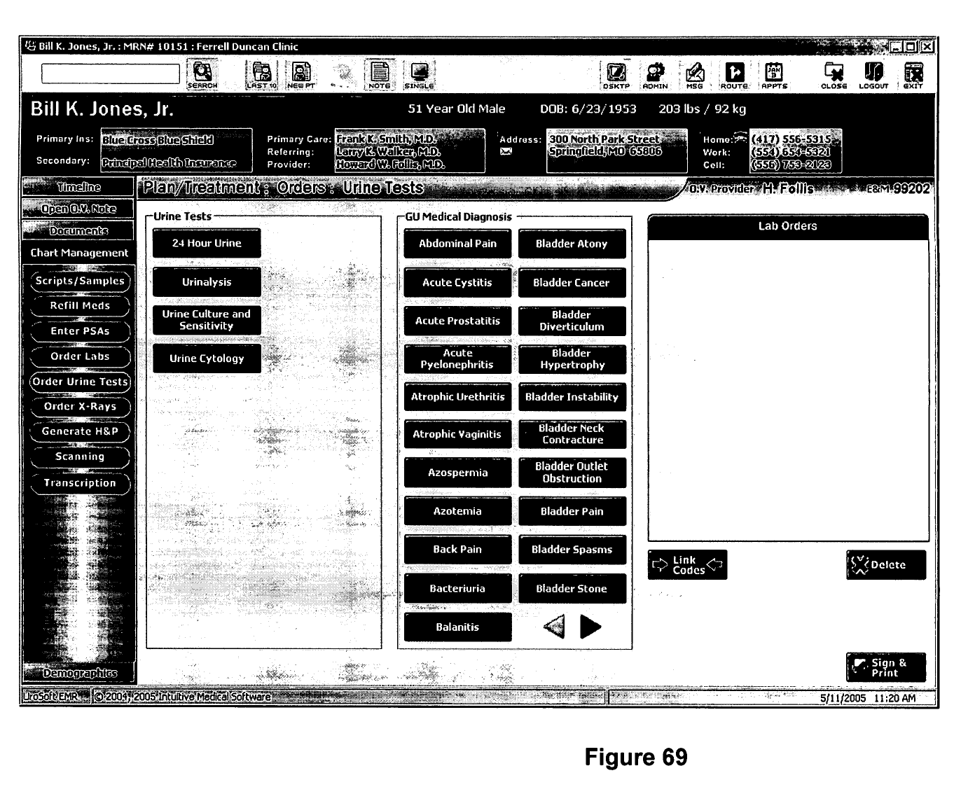

If the user wishes to order any urine tests for a diagnosed GU condition, the user can select the “Order Urine Tests” button to call up the user interface screen of FIG. 69. From the screen shown in FIG. 69, the user can identify the type of urine test to be ordered and the GU medical diagnosis associated therewith. Upon user selection of the appropriate type of urine test and GU medical diagnosis, the “Sign and Print” button can be selected to generate a print out of a fax for transmission to the appropriate laboratory to order the test. It should be noted that an electronic message requesting the urine test can also be created.

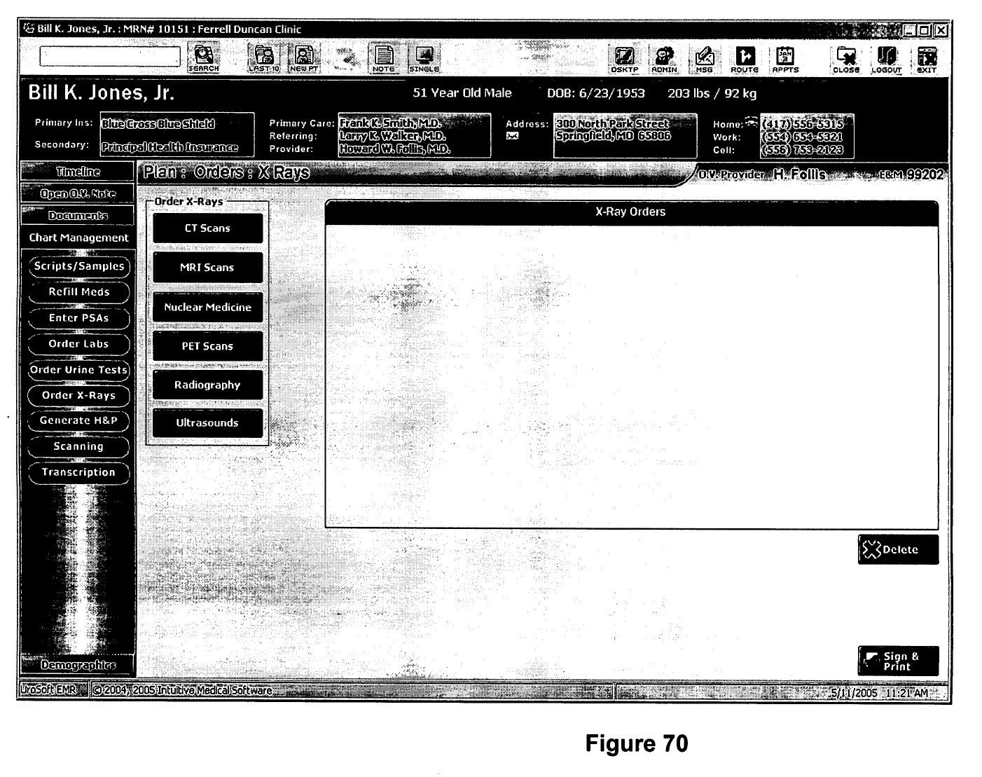

If the user wishes to order any imaging for the patient, the user can select the “Order X-Rays” button to call up the user interface screen of FIG. 70. From the screen shown in FIG. 70, the user can identify the type of type of imaging to be ordered (e.g., CT scans, MRI scans, nuclear medicine imaging, PET scans, radiography, ultrasounds, etc.). Upon user selection of the appropriate type of medical image, the “Sign and Print” button can be selected to generate a print out of a fax for transmission to actually order the imaging. It should be noted that an electronic message requesting the imaging can also be created.

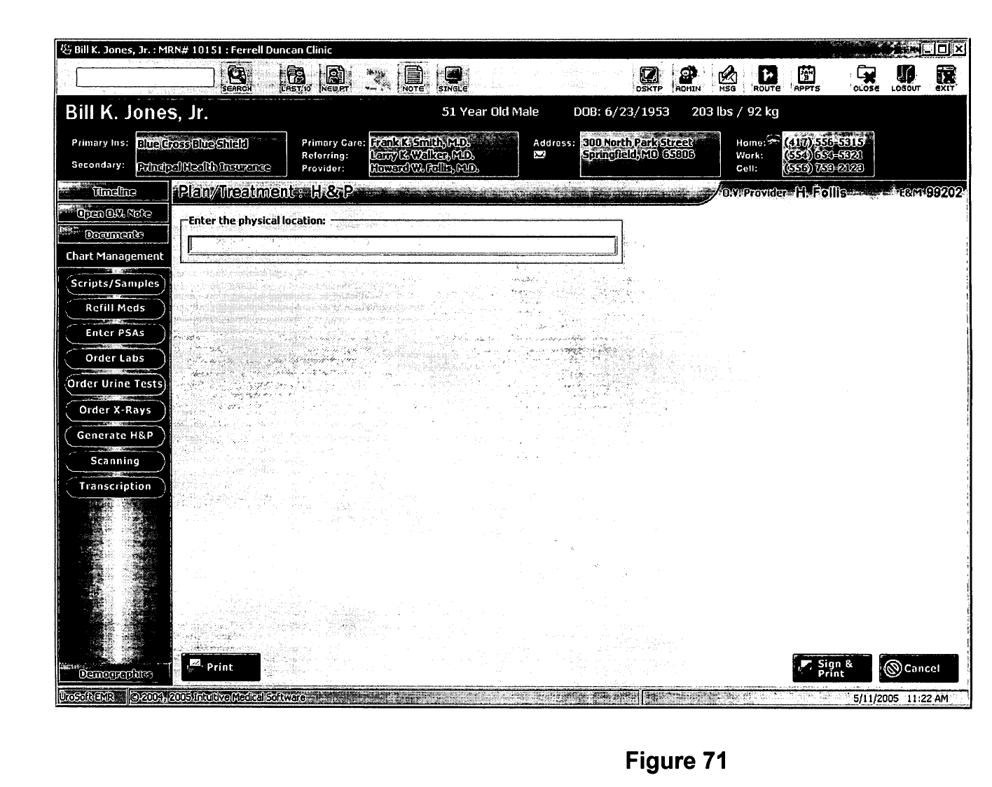

If the user wishes to generate a history and physical (H&P) for the patient (which generally comprises a standardized report of the patient's complaints and a written summary in a standardized format of the physical examination, diagnostic tests, and treatment plan for the patient), the user can select the “Generate H&P” button to call up the user interface screen of FIG. 71. From the screen shown in FIG. 71, the user can enter the physical location (e.g., hospital) corresponding to where the patient is located and where an H&P is required. Upon user selection of the appropriate location, the “Sign and Print” button can be selected to generate a print out of a fax for transmission to that location to actually order the H&P. It should be noted that an electronic message requesting the H&P can also be created.

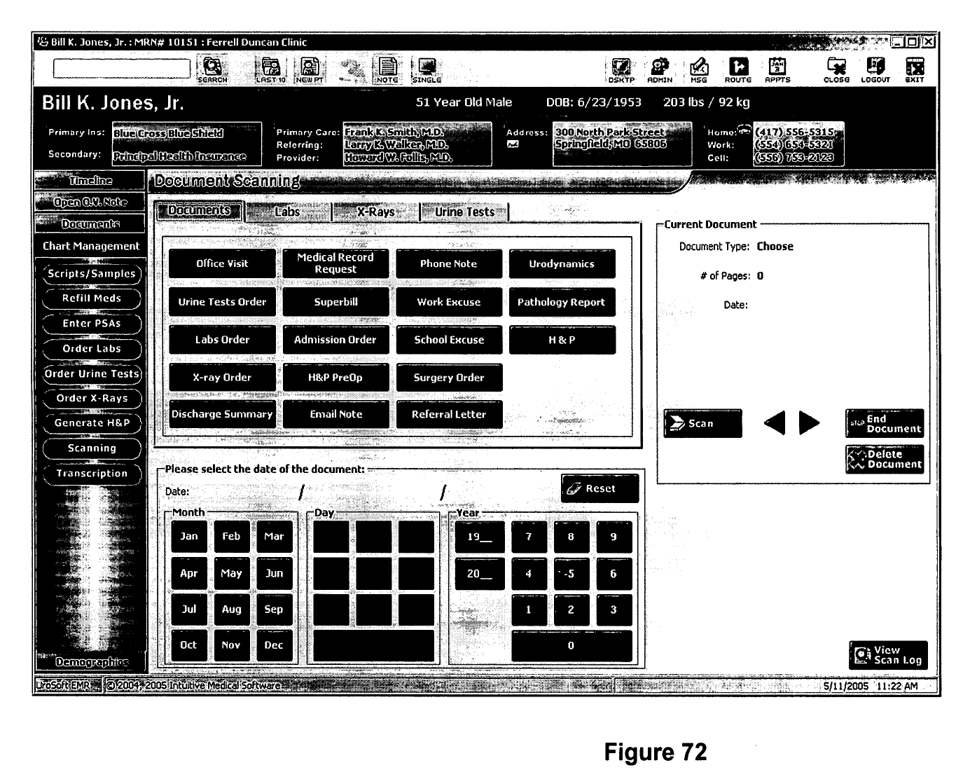

If the user wishes to add scanned documents/lab results/imaging/urine test results to the patient's EMR, the user can select the “Scanning” button to call up the user interface screens of FIGS. 72-75. The user interface screen of FIG. 72 is displayed when the “Documents” folder tab is active. Using a scanning device associated with the user's computer or hand-held computing device, an electronic file corresponding to a scan of a document can be obtained. Via the interface shown in FIG. 72, the user can tag the electronic files corresponding to the scanned documents with appropriate descriptors (which define the sections of the timeline into which scanned documents are added and the summary description that will appear on the icons added to the timeline) and with applicable dates (which define where the scanned document items will be added to the timeline chronologically).

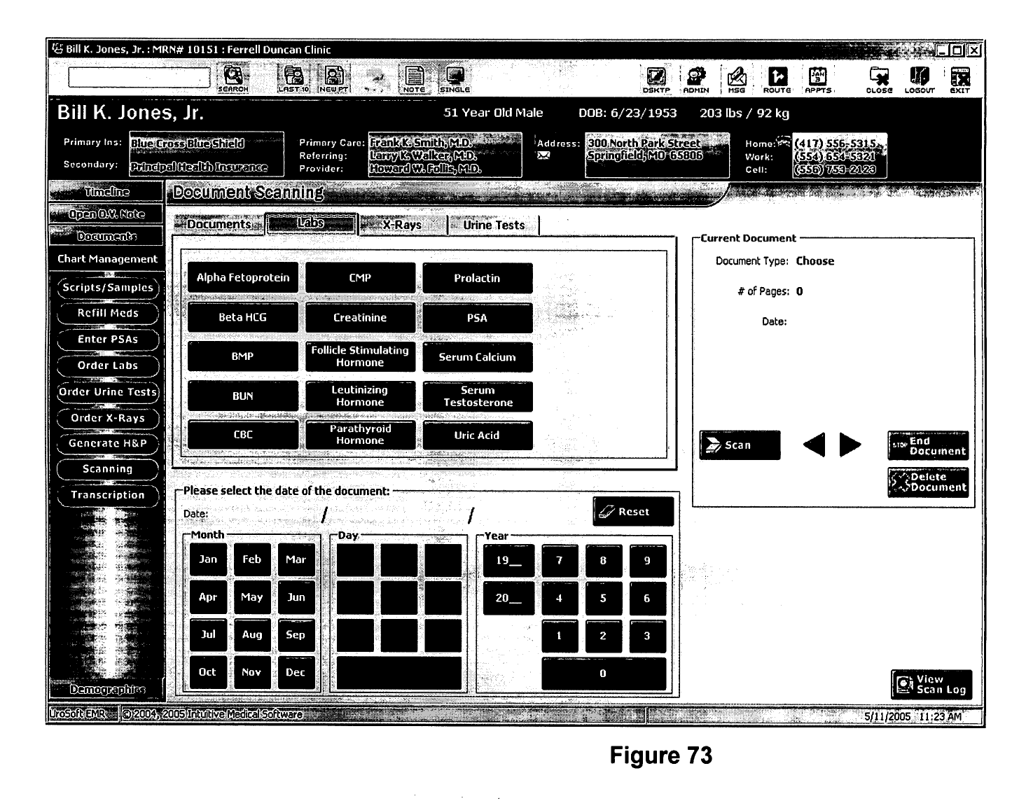

The user interface screen of FIG. 73 is displayed when the “Labs” folder tab is active. Using a scanning device associated with the user's computer or hand-held computing device, an electronic file corresponding to a scan of lab result paperwork can be obtained. Via the interface shown in FIG. 73, the user can tag the electronic files corresponding to the lab results with appropriate descriptors (which define the summary description that will appear on the icons added to the timeline) and with applicable dates (which define where the scanned lab result items will be added to the timeline chronologically).

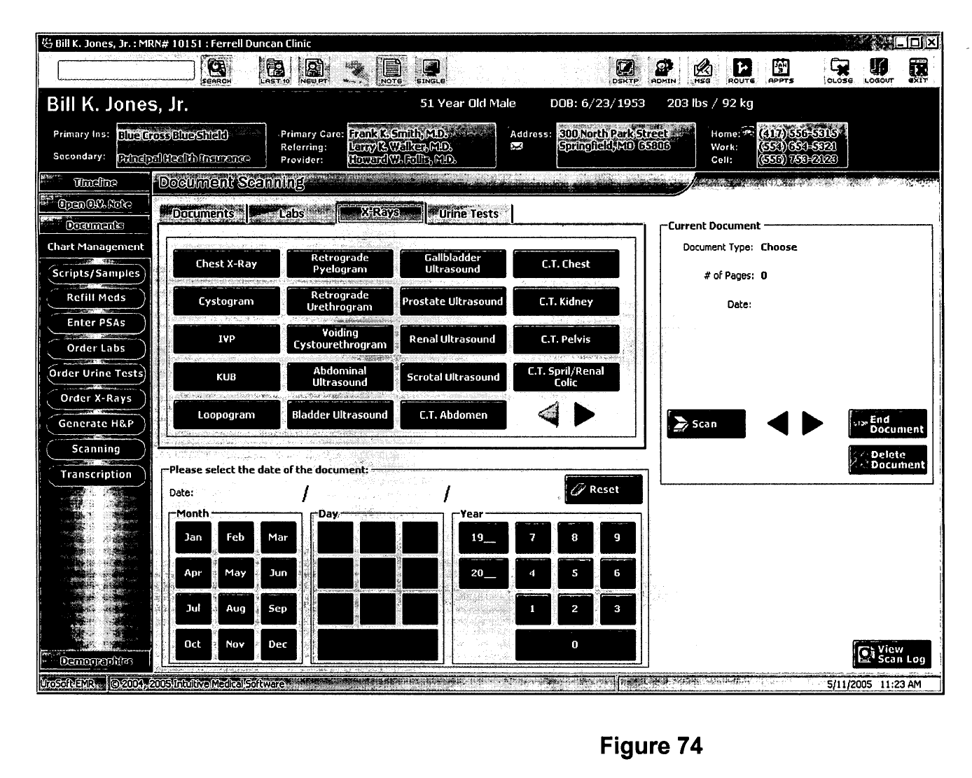

The user interface screen of FIG. 74 is displayed when the “X-rays” (or imaging) folder tab is active. Using a scanning device associated with the user's computer or hand-held computing device, an electronic file corresponding to a medical image report for the patient can be added to the patient's EMR. Via the interface shown in FIG. 74, the user can tag the electronic files corresponding to the medical image reports with appropriate descriptors, such as Chest X-Rays, Abdominal Ultrasound. C.T. Pelvis, etc. (which define the summary description that will appear on the icons added to the timeline) and with applicable dates (which define where the scanned imaging items will be added to the timeline chronologically).

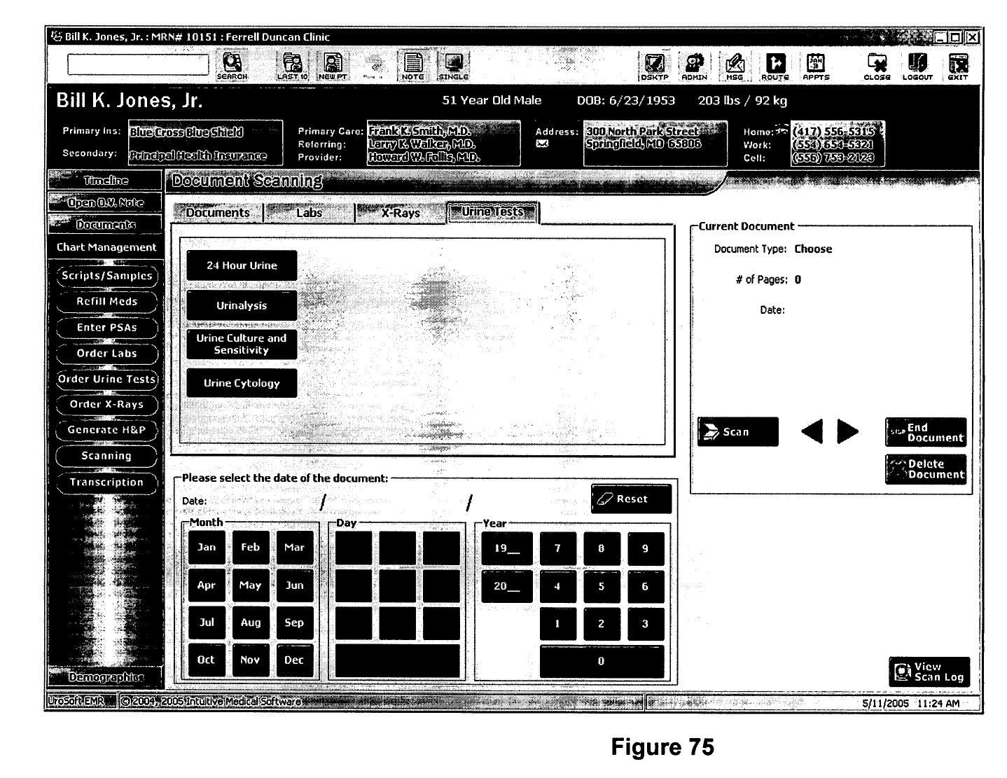

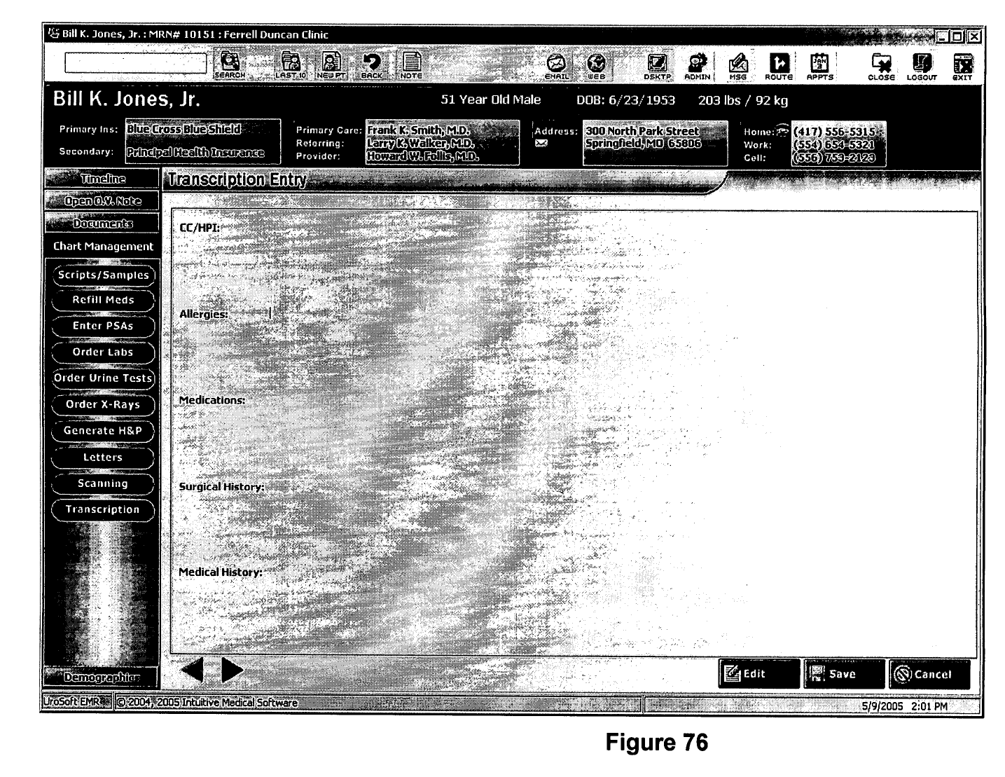

The user interface screen of FIG. 75 is displayed when the “Urine Tests” folder tab is active. Using a scanning device associated with the user's computer or hand-held computing device, an electronic file corresponding to a scan of urine test result paperwork can be obtained. Via the interface shown in FIG. 75, the user can tag the electronic files corresponding to the urine test results with appropriate descriptors (which define the summary description that will appear on the icons added to the timeline) and with applicable dates (which define where the scanned urine test items will be added to the timeline chronologically).

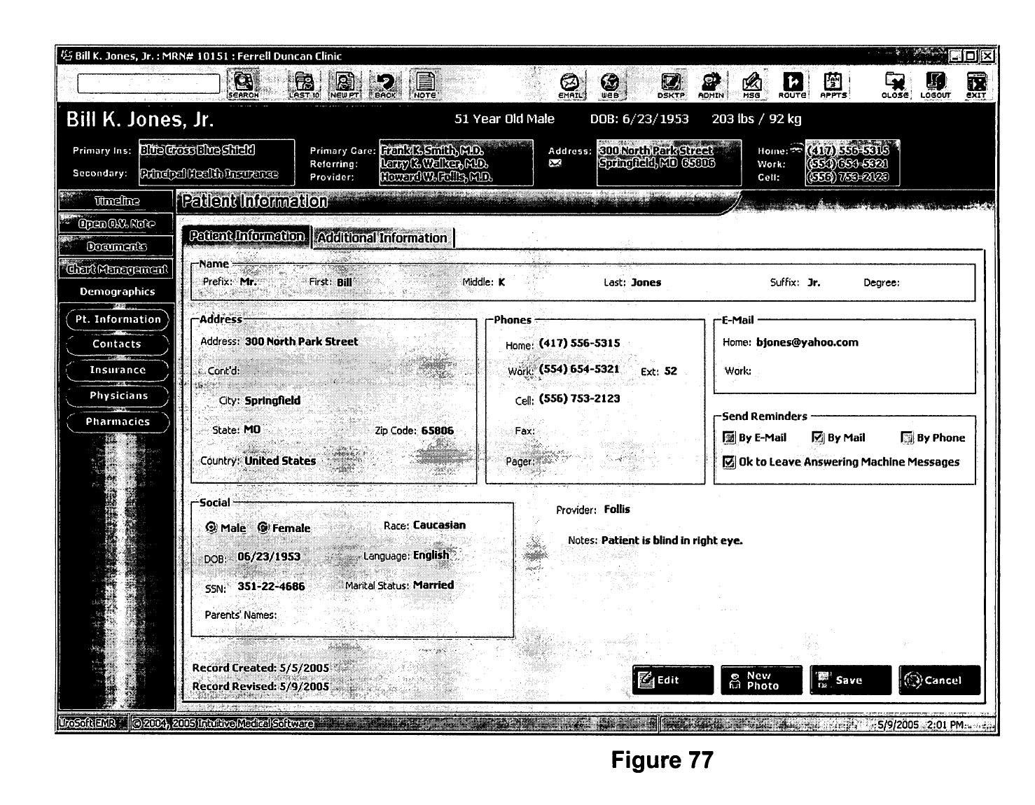

If the user wishes to add transcription information to the patient's EMR, the user can select the “Transcription” button to call up the user interface screen of FIG. 76. The screen of FIG. 76 is configured to allow a transcriptionist to type free text into the patient's EMR. This free text can be a transcription of dictation from a physician into a microcassette recorder or the like about a patient.

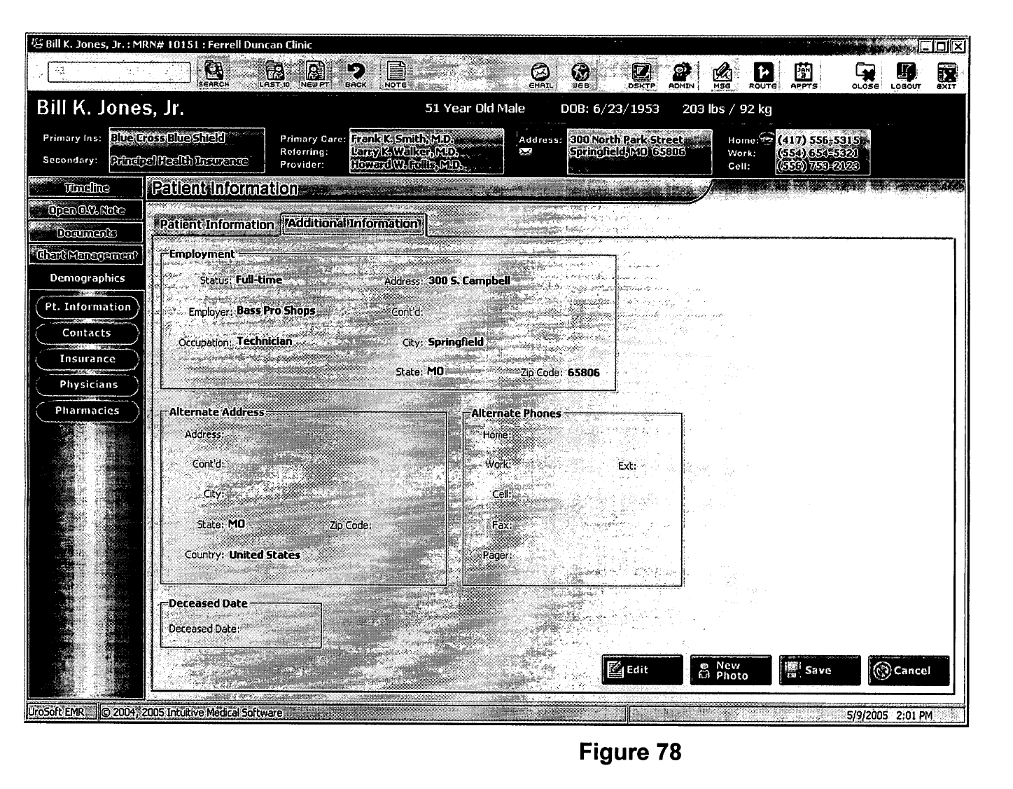

User selection of the “Demographics” button 280 shown in FIG. 2 allows the user to edit the patient's demographics information. FIGS. 77 and 78 illustrate exemplary user interface screens for controlling the patient demographic information stored with a patient's EMR, which can be displayed following user selection of button 280. Additional demographic information that can be added or edited upon selection of button 280 includes contact information for the patient, insurance information for the patient, physician information for the patient, and pharmacy information for the patient.

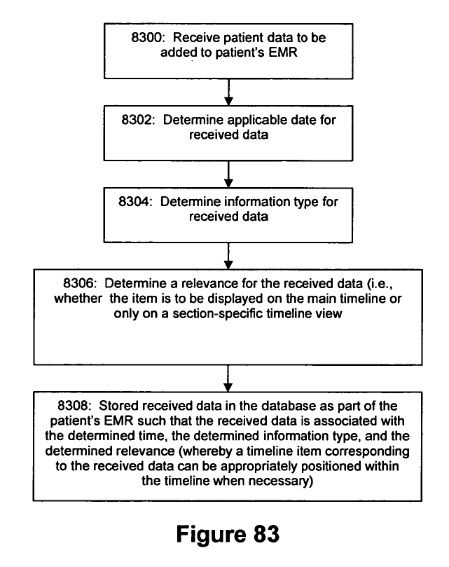

Thus, as described herein in connection with FIGS. 10-78, any data added to the patient's EMR preferably follows the flow shown in FIG. 83. At step 8300, patient data is received. This data can be received from the user in the manner described in connection with FIGS. 10-78 or in some other manner (e.g., accessing another data file that includes patient data of interest therein). At step 8302, an applicable date for the received data is determined. This is the date that will control how that received patient data (or items corresponding to that received patient data) is positioned within the timeline. This date can be either a user-specified value or an automatic “timestamp” value that is assigned by a computer clock, depending upon the desires of a practitioner of the present invention. Also it should be noted that the “date” is preferably to the month/day/year level of detail; although it should be noted that the date can be expressed in greater detail (e.g., including a time of day) or lesser detail (e.g., month/year). At step 8304, an information type for the received data is determined such that the received patient data (or items corresponding to that received patient data) can be placed into an appropriate section of the timeline. This information type can be defined by the user either directly (through user input of an information type for the received patient data) or indirectly (wherein the information type is assigned based on a determination of the screen through which the patient data was received (e.g., determining that the information type for received data is “Medications” if the data was received as part of user input into a Medications interface screen such as that shown in FIG. 15).

Next, at step 8306, a determination is then made as to whether the item will be displayed on the main timeline 210 of FIGS. 2 and 7 or whether the item should only be displayed on one of the section-specific timeline views shown in FIGS. 3-6 and 8-9. Preferably, this determination is made automatically by the software code on the basis of the received data's predetermined relevance to the nature of the medical practice associated with the user and/or the available space constraints for the timeline section applicable to that data.

Lastly, at step 8308, the received data is added to the database where it becomes part of the patient's EMR and wherein the stored data is tagged with the determined date, determined information type/section, and determined relevance so that it can be properly positioned within the timeline when needed.

While the present invention has been described above in relation to its preferred embodiment, various modifications may be made thereto that fall within the invention's scope, as would be recognized by those of ordinary skill in the art. For example, while the examples given herein are in the context of a urology practice, the present invention can also be used in connection with other types of medical practices. Such modifications to the invention will be recognizable upon review of the teachings herein by those of ordinary skill in the art. As such, the full scope of the present invention is to be defined solely by the appended claims and their legal equivalents.

What is claimed is:

1. A computer-readable medium for displaying and providing access to a stored patient electronic medical record (EMR), the computer-readable medium comprising:
a code segment executable by a processor for providing a user interface screen for display to a user, the user interface screen comprising a graphically-displayed timeline, the timeline comprising a first axis for time and a second axis that is substantially perpendicular to the first axis, the second axis being divided into a plurality of sections in parallel with each other, each section corresponding to a different type of patient information, each section comprising a display of patient data corresponding to that section's type of patient information, wherein the displayed patient data in each section is located on the timeline at a position such that the patient data is chronologically-ordered.

2. The computer-readable medium of claim 1 wherein the sections comprise at least two selected from the group consisting of a documents section, a past surgical history section, an imaging section, a prostate specific antigen (PSA) section, a lab results section, a medications section, and a past medical history section.

3. The computer-readable medium of claim 2 further comprising a code segment executable by a processor for defining the first axis such that it exhibits a uniform linear time scale.

4. The computer-readable medium of claim 3 further comprising a code segment executable by a processor for defining a time period encompassed by the displayed timeline in response to user input.

5. The computer-readable medium of claim 4 further comprising a code segment executable by a processor for displaying a user-adjustable duration window scroller tool on the timeline, wherein the scroller tool is configured for adjustment by the user to a position on a time scale that defines the time period for the displayed timeline.

6. The computer-readable medium of claim 3 further comprising:
a code segment executable by a processor for displaying a plurality of selectable items in the timeline, each selectable item being displayed within a timeline section according to the type of patient information corresponding thereto and at a position along the first axis corresponding to an applicable date therefor, each selectable item corresponding to stored patient data and comprising a graphical icon that is configured to display a summary that is indicative of the patient data corresponding thereto; and
a code segment executable by a processor for displaying the stored patient data corresponding to a selectable item in response to user selection of that selectable item.

7. The computer-readable medium of claim 6 further comprising:
a code segment executable by a processor for creating a selectable item for inclusion in the timeline from a file obtained from a scanner, the file comprising the patient data that is displayed upon user selection of the selectable item corresponding thereto.

8. The computer-readable medium of claim 7 wherein the file comprises a document related to the patient.

9. The computer-readable medium of claim 6 further comprising:
a code segment executable by a processor for adding patient data to the stored patient EMR in response to user input;
a code segment executable by a processor for determining a relevance of the added patient data to a user's practice, wherein a selectable item corresponding to added patient data having a first relevance will be displayed on the timeline when the timeline is in a first state, and wherein a selectable item corresponding to added patient data having a second relevance will be displayed on the timeline only when the timeline is a second state;
a code segment executable by a processor for displaying selectable items on the timeline according to a state of the timeline.

10. The computer-readable medium of claim 9 wherein the first state of the timeline corresponds to a multi-section view of the timeline and wherein the second state of the timeline corresponds to an exploded view of a selected timeline section.

11. The computer-readable medium of claim 1 wherein the sections comprise at least three selected from the group consisting of a documents section, a past surgical history section, an imaging section, a prostate specific antigen (PSA) section, a lab results section, a medications section, and a past medical history section.

12. The computer-readable medium of claim 1 wherein the sections comprise at least four selected from the group consisting of a documents section, a past surgical history section, an imaging section, a prostate specific antigen (PSA) section, a lab results section, a medications section, and a past medical history section.

13. The computer-readable medium of claim 1 wherein the sections comprise at least five selected from the group consisting of a documents section, a past surgical history section, an imaging section, a prostate specific antigen (PSA) section, a lab results section, a medications section, and a past medical history section.

14. The computer-readable medium of claim 1 wherein the sections comprise a documents section, a past surgical history section, an imaging section, a prostate specific antigen (PSA) section, a lab results section, a medications section, and a past medical history section.

15. A method for displaying a patient electronic medical record (EMR), the method comprising:
graphically displaying a timeline, the timeline comprising a first axis for time and a second axis perpendicular to the first axis, the second axis comprising a plurality of sections, each section being associated with a different type of patient data; and
displaying a plurality of patient data items on the timeline, the patient data items comprising data from a patient's EMR, each item having an associated date and an associated patient data type; and
wherein the data item displaying step comprises: (1 ) along the first axis, chronologically placing each item at a position within the timeline in accordance with that item's associated date, and (2) along the second axis, placing each item within the second axis section that corresponds to that item's associated patient data type.

16. The method of claim 15 wherein a plurality of the displayed data items are associated with additional data from the patient's EMR, the method further comprising:
responsive to user selection of one of the plurality of displayed data items, displaying the additional data from the patient's EMR that is associated with the selected item.

17. The method of claim 16 wherein the first axis defines a duration of time, the method further comprising:
adjusting the duration of time defined by the first axis in response to user input.

18. The method of claim 17 wherein the duration of time is fixed, with the start and end dates being adjustable.

19. The method of claim 16 wherein the additional data comprises a medical image within the patient's EMR.

20. The method of claim 16 wherein the additional data comprises an electronic copy of a scanned document within the patient's EMR.

21. The method of claim 16 wherein the displayed items comprise a plurality of selectable graphical icons, the method further comprising:
displaying information on each graphical icon that summarizes the additional data that can be accessed upon user selection of that icon.

22. The method of claim 21 wherein one of the sections comprises a past surgical history section.

23. The method of claim 21 wherein one of the sections comprises a medications section.

24. The method of claim 21 wherein one of the sections comprises a past medical history section.

25. The method of claim 21 wherein one of the sections comprises an imaging section.

26. The method of claim 21 wherein one of the sections comprises a documents section.

27. The method of claim 21 wherein one of the sections comprises a lab results section.

28. The method of claim 21 wherein one of the sections comprises a PSA results section.

29. The method of claim 28 further comprising:
displaying a graph in the PSA results section, the graph comprising chronologically ordered PSA results for the patient.

30. The method of claim 21 wherein the sections comprise at least three selected from the group consisting of a past surgical history section, a medications section, a past medical history section, an imaging section, a documents section, a lab results section, and a PSA results section.

31. The method of claim 30 wherein the first axis defines a uniform linear time scale.

32. The method of claim 31 further comprising:
displaying a plurality of patient ages that correspond to the duration of time encompassed by the first axis.

33. The method of claim 31 further comprising removing at least one of the sections from the timeline in response to user input.

34. The method of claim 33 wherein the removing step comprises removing all but one of the sections from the timeline in response to user input.

35. The method of claim 34 further comprising:
displaying within the remaining section of the timeline, at least one additional graphical icon that was not displayed within the timeline when the timeline including a plurality of second axis sections, the at least one additional graphical icon being user-selectable to display additional data from the patient's EMR corresponding to that icon.

36. The method of claim 21 further comprising:
limiting the icons that are displayed within the timeline on the basis of a relevance for the patient data corresponding thereto relative to a medical practice associated with the user.

37. The method of claim 36 further comprising:
responsive to user input, removing at least one section from the timeline and displaying at least one additional icon within at least one remaining section of the timeline.

38. The method of claim 21 further comprising:
receiving data to be added to the patient's EMR;
determining a date for association with the received data;
determining a patient data type for association with the received data; and
storing the received data as part of the patient's EMR together with the determined date and determined patient data type such that a graphical icon associated with that data can be appropriately positioned within the timeline when that patient's EMR is displayed via the timeline.

39. The method of claim 38 further comprising:
scanning a document relating to medical care for the patient, thereby creating an electronic copy of that document, the electronic copy comprising the received data.

40. A patient electronic medical record (EMR) system, the system comprising:
a database in which patient data comprising a plurality of patient EMRs are stored; and
a server in communication with the database and with at least one user device via a network such that the at least one user device can access a software program executed by the server, the software program being configured provide a user interface screen for display on the at least one user device, the user interface screen comprising a graphically-displayed timeline, the timeline comprising a first axis for time and a second axis that is substantially perpendicular to the first axis, the second axis being divided into a plurality of sections in parallel with each other, each section corresponding to a different type of patient information, each section comprising a display of patient data corresponding to that section's type of patient information, wherein the displayed patient data in each section is located on the timeline at a position such that the patient data is chronologically-ordered.

41. The system of claim 40 wherein the sections comprise at least two selected from the group consisting of a documents section, a past surgical history section, an imaging section, a prostate specific antigen (PSA) section, a lab results section, a medications section, and a past medical history section.

42. The system of claim 41 wherein the first axis exhibits a uniform linear time scale.

43. The system of claim 42 wherein the displayed timeline encompasses a user-defined time period.

44. The system of claim 43 wherein the software is further configured to (1) display a plurality of selectable items in the timeline, each selectable item being displayed within a timeline section according to the type of patient information corresponding thereto and at a position along the first axis corresponding to an applicable date therefor, each selectable item corresponding to patient data stored in the database and comprising a graphical icon that is configured to display a summary that is indicative of the patient data corresponding thereto, and (2) display the stored patient data corresponding to a selectable item in response to user selection of that selectable item.

45. The system of claim 44 wherein the patient data comprises a scanned document.

46. The system of claim 44 wherein the software is further configured to limit what is displayed on an initial state of the timeline to only selectable items that correspond to patient data of having a predetermined relevance to a medical practice associated with the user.

47. The system of claim 40 wherein the at least one user device comprises a PC or a hand-held computing device.

48. The system of claim 40 wherein the sections comprise at least three selected from the group consisting of a documents section, a past surgical history section, an imaging section, a prostate specific antigen (PSA) section, a lab results section, a medications section, and a past medical history section.

49. The system of claim 40 wherein the sections comprise a documents section, a past surgical history section, an imaging section, a prostate specific antigen (PSA) section, a lab results section, a medications section, and a past medical history section.
